(19) United States
(12) Patent Application Publication
(10) Pub. No.: US 2024/0183003 A1
(43) Pub. Date: Jun. 6, 2024

(54) IN-SITU GENERATION OF THIOSULPHATE LIXIVIANT SYSTEMS AND METHODS FOR PRECIOUS METAL LEACHING AND RECOVERY

(71) Applicant: Seabridge Gold Inc., Toronto (CA)

(72) Inventors: Mariam MELASHVILI, Peterborough (CA); Theodore James SMOLIK, Blaine, WA (US); David DREISINGER, Delta (CA)

(21) Appl. No.: 18/286,493

(22) PCT Filed: Apr. 12, 2022
(86) PCT No.: PCT/CA2022/050567

§ 371 Date: Oct. 11, 2023

Related U.S. Application Data
(60) Provisional application No. 63/174,409, filed on Apr. 13, 2021.

(51) Int. Cl. C22B 11/00; B03D 1/02; C22B 1/24; C22B 3/12; C22B 3/44

(52) U.S. Cl. CPC C22B 11/04; C22B 1/24; C22B 3/12; C22B 3/44; B03D 1/02; B03D 2203/025

(57) ABSTRACT

A method of extracting precious metal values from a starting material using thiosulphate as a lixiviant. The precious metal values can be recovered from solution using a reductant. The reductant may be a naturally occurring ore including as a component pyrite, chalcopyrite, marcasite and/or pyrrhotite, or can be ferrous sulphate. Sodium hydrosulphide can be added as a scavenging precipitant after the reductant to regenerate thiosulphate. The thiosulphate can be recycled to leach additional precious metal values.

### CROSS-REFERENCE TO RELATED APPLICATIONS

This application claims priority to, and the benefit of, U.S. provisional patent application No. 63/174,409 filed 13 Apr. 2021, the entirety of which is incorporated by reference herein for all purposes.

### TECHNICAL FIELD

Some embodiments of the present invention relate to apparatus, systems and methods that can be used to recover metal values including precious metals such as gold and silver from ore using a leaching process. Some embodiments relate to apparatus, systems and methods that can be used to recover the leached metals.

### BACKGROUND

A flotation process is one method that can be used to help recover precious metals such as gold and silver from mined ores. The flotation process concentrates gold from the ore, and the resulting products can be subjected to further processing for further gold recovery treatment.

Flotation can recover only a portion of the precious metal from the ore, e.g. about 60-65% of gold in some example situations. The remaining portion of the precious metal remains in the tailings. Methods of recovering precious metals from sulphide-based tailings after flotation that have been carried out include leaching processes such as cyanide leaching or thiosulphate leaching.

While cyanide leaching has historically been the method used to recover precious metals from flotation tailings because of the high thermodynamic stability of the gold-cyanide complex, cyanidation does not work well for recovery from all types of ores or flotation tailing. For example, certain ores containing a high level of carbon are not effectively leached using cyanidation because the precious metal-cyanide complex adsorbs in the carbon, thereby reducing metal recovery. Such ores are often described as preg-robbing ores. Cyanide may also be consumed via reaction with sulphur and copper compounds in certain ores. The use of cyanide also poses environmental risks. Thus, thiosulphate leaching may be preferable to cyanide leaching in certain circumstances.

Thiosulphate is thermodynamically unstable in water, and is partially oxidized during leaching to form polythionates such as tetrathionate and trithionate, as well as sulphate. Sulphate is stable and its formation cannot be easily reversed, while thiosulphate and trithionate are metastable in the presence of oxygen in aqueous solutions. Tetrathionate is unstable. Tetrathionate undergoes hydrolysis under strongly alkaline conditions (e.g. pH greater than about 11) to yield thiosulphate.

The use of thiosulphate leaching can also complicate downstream processes used to recover precious metals after leaching. For example, typical carbon in pulp (CIP) or carbon in leach (CIL) processes cannot be used to recover the precious metal because the resulting thiosulphate complex, e.g. a gold thiosulphate complex, does not load into carbon. Ion exchange resins present an alternative mechanism for recovering the precious metals after lixiviation in such circumstances, but thiosulphate oxidation products such as tetrathionate and trithionate load strongly onto anion exchange resins, thereby reducing the loading of the precious metal on the anion exchange resin.

In the case of sulphidic refractory ores or concentrates containing precious metals such as gold, recovery of the metal generally entails oxidation of the sulphides and liberation of the gold that is trapped within the sulphide matrix. An oxidation product of sulphides oxidized under mild conditions is the thiosulphate anion.

There is a general desire for alternative methods of recovering metals from ore that do not require the use of cyanide or that allow the more efficient use of thiosulphate leaching. There is further a need for methods of recovering metals after thiosulphate leaching.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one aspect, a method for extracting precious metal values from a starting material is provided. A sulphide generator is provided, an aqueous slurry of the starting material and the sulphide generator is formed, thiosulphate is generated from the thiosulphide generator and an oxidant and a basic compound are supplied to form a reaction mixture, and the thiosulphate is used to complex the precious metal values to form a leached solution. In some aspects, the starting material can be a sulphidic mined ore or a flotation concentrate by-product and tailing products. In some aspects, the precious metal values are gold and/or silver.

In one aspect, a method of recovering precious metal values from a solution prepared using thiosulphate as a lixiviant is provided. In some aspects, a first reductant is added to the leached solution. The first reductant can be ferrous sulphate or a copper concentrate. The first reductant can be a naturally occurring ore containing pyrite, chalcopyrite, and/or pyrrhotite or a combination thereof. In some aspects, after the addition of the first reductant for a reaction period, sodium hydrosulphide can be added as a scavenging precipitant to complete precipitation of the metal values from solution and regenerate thiosulphate for use in further leaching reactions.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an example embodiment of a flowsheet for the recovery of precious metal values from ore.

FIG. 2 shows an example embodiment of a flowsheet for the leaching of metal values from a starting material using thiosulphate.

FIG. 3 shows an example embodiment of a flowsheet for the recovering of metal values from a leached solution using a reductant.

FIG. 4 shows an example embodiment of a flowsheet for the leaching of metal values from a starting material using thiosulphate and the corresponding recovery of metal values from the leached solution using a reductant.

FIG. 5 shows gold extraction and thiosulphate (S₂O₃) production over time for experimental example T1.

FIG. 6 shows the pH and oxidation-reduction potential (ORP) over time for experimental example T1.

FIG. 7 shows the concentration of carbonates over time for experimental example T1.

FIG. 8 shows the kinetics of gold extraction, thiosulphate concentration and oxidation-reduction potential (ORP) for experimental example T2.

FIG. 9 shows the kinetics of gold extraction, thiosulphate concentration and oxidation-reduction potential (ORP) for experimental example T9.

FIG. 10 shows the NaOH dosage and oxidation-reduction potential (ORP) values for experimental examples T4 and T5.

FIG. 11 shows the NaOH dosages and ORP values in experimental examples T4 and T6.

FIG. 12 shows the carbonate and pH (calculated) changes with time for experimental examples T4 and T6.

FIG. 13 shows the gold extraction and thiosulphate concentrations in example T6.

FIG. 14 shows the NaOH dosages and ORP values in example T6.

FIG. 15 shows the gold concentration in solution and the oxidation-reduction potential (ORP) for experimental examples T3-1 and T3-2.

FIG. 16 shows the gold extraction and thiosulphate concentrations in experimental examples T10 and T11.

FIG. 17 shows the gold extraction profile from experimental example processed using four reactors positioned in series.

FIG. 18 shows the gold extraction and thiosulphate generation at various carbonate dosages.

FIG. 19 shows thiosulphate formation with time at various concentrations of sodium carbonate.

FIG. 20 shows pH variation with time at various concentrations of sodium carbonate.

FIG. 21 shows carbonate profiles for experimental examples NaTS1-5.

FIG. 22 shows the kinetics of gold extraction and thiosulphate formation in experimental example NaTS1.

FIG. 23 shows the changes in pH over time in experimental examples NaTS1, NaTS7 and NaTS9.

FIG. 24 shows the cumulative caustic dosage over time for experimental examples NaTS1, NaTS7 and NaTS9.

FIG. 25 shows the kinetic data for experimental example CaTS1.

FIG. 26 shows the gold concentrations in leach and precipitation solutions for two cycles in one example.

FIG. 27 shows the copper leach and precipitation during recycling.

FIG. 28 shows gold leaching and thiosulphate profiles with time on Mitchell and Deep Kerr material in one example.

FIG. 29 shows gold leaching and thiosulphate profiles with time on Mitchell in one example.

FIG. 30 shows gold leaching and thiosulphate profiles with time on Iron Cap in one example.

FIG. 31 shows gold leaching and in-situ thiosulphate profiles with time on Mitchell and Deep Kerr in one example.

FIG. 32 shows gold leaching and in-situ thiosulphate profiles with time on Mitchell at various pH in one example.

FIG. 33 shows gold leaching and in-situ thiosulphate profiles with time on Mitchell at various pH in one example.

FIG. 34 shows gold leaching and in-situ thiosulphate profiles with time on Mitchell in one example.

FIG. 35 shows gold leaching with in-situ thiosulphate at 91° C.

FIG. 36 shows in-situ thiosulphate profiles at 91° C.

FIG. 37 shows extraction with in-situ thiosulphate and recycled leach solution at 91° C.

FIG. 38 shows thiosulphate and pH profiles for leaching tests on Iron Cap samples.

FIG. 39 shows the trithionate profile during leaching for tests on Iron Cap.

FIG. 40 shows the gold and copper recovery on concentrate.

FIG. 41 shows gold and copper recovery by concentrate without any addition of NaSH.

FIG. 42 shows gold extraction profiles and thiosulphate decomposition during leaching with added thiosulphate.

FIG. 43 shows gold extraction with in-situ formed thiosulphate.

FIG. 44 shows the effect of temperature on gold leaching and in-situ thiosulphate generation.

FIG. 45 shows gold extraction reproducibility and copper dissolution in thiosulphate.

FIG. 46 shows gold and copper recovery from synthetic and leach thiosulphate solutions.

FIG. 47 shows the gold and copper recovery from synthetic and leach thiosulphate solutions.

FIG. 48 shows stability diagrams; iron and copper in carbonate(1M) and thiosulphate (0.1M) solutions at 60° C.

FIG. 49 shows thiosulphate and trithionate concentration profiles during leaching and precipitation.

FIG. 50 shows pH values over time for exemplary tests using ferrous sulphate as a reductant to precipitate precious metal values.

FIG. 51 shows ORP over time for exemplary tests using ferrous sulphate as a reductant to precipitate precious metal values.

FIG. 52 shows thiosulphate concentration over time for exemplary tests using ferrous sulphate as a reductant to precipitate precious metal values.

FIG. 53 shows gold concentration in solution over time for exemplary tests using ferrous sulphate as a reductant to precipitate precious metal values.

FIG. 54 shows silver concentration over time for exemplary tests using ferrous sulphate as a reductant to precipitate precious metal values.

FIG. 55 shows copper concentration over time for exemplary tests using ferrous sulphate as a reductant to precipitate precious metal values.

FIG. 56 shows concentrations of gold, silver, copper and thiosulphate as a function of time without addition of pyrite at 25° C.

FIG. 57 shows concentrations of gold, silver, copper and thiosulphate as a function of time with addition of 1 g/L pyrite at 25° C.

FIG. 58 shows concentrations of gold, silver, copper and thiosulphate as a function of time with addition of 10 g/L pyrite at 25° C.

FIG. 59 shows concentrations of gold, silver, copper and thiosulphate as a function of time with addition of 20 g/L pyrite at 25° C.

FIG. 60 shows slurry redox potential with addition of different amounts of pyrite as a function of time at 25° C.

FIG. 61 shows concentrations of gold, silver, copper and thiosulphate as a function of time with addition of 10 g/L pyrite-containing ore sample at 25° C.

FIG. 62 shows concentrations of gold, silver, copper and thiosulphate as a function of time with addition of 30 g/L pyrite-containing ore sample at 25° C.

FIG. 63 shows concentrations of gold, silver, copper and thiosulphate as a function of time with addition of 50 g/L pyrite-containing ore sample at 25° C.

FIG. 64 shows slurry redox potential with the addition of different amounts of pyrite-containing ore sample as a function of time at 25° C.

FIG. 65 shows concentrations of gold, silver, copper and thiosulphate as a function of time with addition of 10 g/L pyrite-containing ore sample at 70° C.

FIG. 66 shows concentrations of gold, silver, copper and thiosulphate as a function of time with addition of 30 g/L pyrite-containing ore sample at 70° C.

FIG. 67 shows concentrations of gold, silver, copper and thiosulphate as a function of time with addition of 50 g/L pyrite-containing ore sample at 70° C.

FIG. 68 shows slurry redox potential with the addition of different amounts of pyrite-containing ore sample as a function of time at 70° C.

FIG. 69 shows concentrations of gold, silver, copper and thiosulphate as a function of time with addition of 10 g/L pyrite-containing ore sample and 0.11 g/L NaHS at 70° C.

FIG. 70 shows concentrations of gold, silver, copper and thiosulphate as a function of time with addition of 30 g/L pyrite-containing ore sample and 0.072 g/L NaHS at 70° C.

FIG. 71 shows concentrations of gold, silver, copper and thiosulphate as a function of time with addition of 30 g/L pyrite-containing ore sample and 0.069 g/L NaHS at 70° C.

FIG. 72 shows slurry redox potential with the addition of different amounts of pyrite-containing ore sample and NaHS as a function of time at 70° C.

FIG. 73 shows concentrations of gold, silver, copper and thiosulphate as a function of time without addition of pyrite-containing ore sample at 70° C.

FIG. 74 shows concentrations of gold, silver, copper and thiosulphate as a function of time with addition of 10 g/L pyrite-containing ore sample at 70° C.

FIG. 75 shows concentrations of gold, silver, copper and thiosulphate as a function of time with addition of 30 g/L pyrite-containing ore sample at 70° C.

FIG. 76 shows concentrations of gold, silver, copper and thiosulphate as a function of time with addition of 50 g/L pyrite-containing ore sample at 70° C.

FIG. 77 shows slurry redox potential with the addition of different amounts of pyrite-containing ore sample as a function of time at 70° C.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The inventors have now discovered that the use of thiosulphate generated in-situ from alkaline oxidation of pyrite has been effective in leaching gold from ore samples and flotation by-products including tailing products. Based on the results described herein, it can be predicted that thiosulphate generated in-situ from oxidation of pyrite and other similar minerals can be used to leach precious metals from ore and/or tailing products. Further, the metal values including the precious metals and copper can be recovered from the leached solution e.g. via control of pH, oxidation-reduction potential (ORP) and/or addition of a reductant to the leached solution.

As used herein, the term “precious metals” includes gold, silver, platinum, palladium, rhodium, iridium, ruthenium, osmium and the like. In some embodiments, the precious metal is gold. In some embodiments, the precious metal is silver. In some embodiments, the precious metal includes both gold and silver. See for example the M.Sc. thesis of J. Deutsch, University of British Columbia, 2012, which is incorporated by reference herein in its entirety which describes the use of thiosulphate as a lixiviant for silver.

The leaching of gold by thiosulphate generated in-situ can be described by the following reaction (1). During leaching, thiosulphate decomposes, primarily to tetrathionate and trithionate, as described by reactions (2) and (3).

4Au+8Na₂S₂O₃+O₂+2H₂O→4Na₃Au(S₂O₃)₂+4NaOH (1)

4Na₂S₂O₃+O₂+2H₂O=2Na₂S₄O₆+4NaOH (2)

2Na₂S₂O₃+2O₂→Na₂S₃O₆+Na₂SO₄ (3)

Thiosulphate can be produced by oxidizing sulphides, including sulphides present in mineral starting materials. The supply of a basic compound and oxygen can lead to oxidation of the sulphides and also the generation of sulphate. By controlling parameters such as the pH and oxidation-reduction-potential (ORP) of the reaction mixture within specific ranges by adjusting the rate of addition of the basic compound and the oxygen, the reaction can be controlled to generate thiosulphate while simultaneously driving partial oxidation of the mineral starting material to improve the recovery of precious metal values.

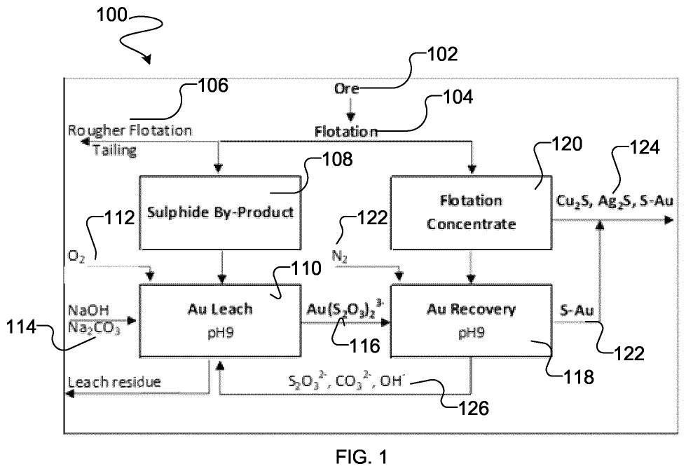

FIG. 1 shows a flowsheet illustrating an example embodiment of a method 100 for the recovery of precious metals (gold in the illustrated embodiment) from ore (a sulphide-containing ore in the illustrated embodiment) using thiosulphate. At 102, a starting material such as ore is supplied. In the illustrated embodiment, the ore is a sulphide-containing ore although any of the starting materials described in this disclosure could be supplied at 102 in alternative embodiments.

At 104, the ore is subjected to a flotation process. At 106, lower quality flotation tailing referred to as rougher flotation tailing is removed to waste. At 108, sulphide-containing tailings of higher grade are removed and passed to a thiosulphate leach process as described herein at 110, with an oxidant 112 such as oxygen (O₂) and a base 114 being supplied to the process as needed to maintain appropriate reaction conditions. The recovered metal values complexed with thiosulphate 116 are passed to a metal recovery step 118, and are optionally combined with a portion of the recovered flotation concentrate 120 at this step. Step 118 is conducted under a non-oxidizing atmosphere, for example by being supplied with an inert gas 122 such as nitrogen (N₂) or argon (Ar) gas, or through use of a vacuum deaeration system. Precipitated metal values 122 from step 118 are collected together with precipitated metal values from flotation concentrate 120. If desired, the solution remaining after step 122 can be recycled to the thiosulphate leach step 110, thereby recycling thiosulphate and base back into the thiosulphate leach step 110.

In some embodiments, the precious metals are recovered using a thiosulphate leaching process in the nature of that described for thiosulphate leach step 110 from a starting material such as ore or flotation tailings, separately from the other steps of method 100. Any starting material that contains the precious metals and one or more contaminants can be used in various embodiments of the thiosulphate leaching process, including for example concentrates, ores, tailings, heaps or waste which contains a high enough level of precious metal to justify further processing.

In some embodiments, the starting material is an ore, concentrate or tailing containing a sulphidic mineral, such as pyrite, pyrrhotite, arsenopyrite, marcasite, chalcopyrite, chalcocite, covellite, tetrahedrite, and the like. In some embodiments, the starting material is a flotation by-product or tailing product, including a sulphide flotation tailing product or a copper flotation product, or other sulphide-containing by-product. In some embodiments, the starting material is in a heap. In some embodiments, the starting material is a pyrite flotation scavenger concentrate. In some embodiments the starting material is a mixed pyritic and carbonaceous flotation concentrate. In some embodiments, the tailing products are tailing products remaining after treatment with cyanide or thiosulphate leaching processes (including e.g. carbon-in-pulp or carbon-in-leach processes). In some embodiments, the starting material is a carbonaceous ore. In some embodiments, the starting material is a carbonaceous ore containing sulphides. In some embodiments, the starting material is a carbonaceous ore containing sulphides in a heap. In embodiments in which the starting material is a carbonaceous ore, an exogenous source of thiosulphate can be provided at the stage of conducting thiosulphate leaching of the starting material.

In some embodiments, the starting material is a sulphide-containing material that contains at least 1% or at least 5% by weight of sulphide. In some embodiments, the starting material contains between about 1% and about 60% by weight or more of sulphide, including any value therebetween e.g. 2, 3, 4, 5, 6, 7, 8, 9, 10, 12, 14, 16, 18, 20, 25, 30, 35, 40, 45, 50 or 55% by weight or more of sulphide. In some embodiments, the starting material contains between about 15% and about 60% of sulphide. In some embodiments, certain reaction parameters may be adjusted based on the amount and/or reactivity of the sulphide present in the starting material. For example, starting materials with a lower proportion of sulphide present may be treated at higher temperatures during the thiosulphate leaching step. Similarly, the reactivity of the sulphide present in the starting material may vary so that more aggressive process conditions may be required to carry out the thiosulphate leaching step where the sulphide present in the starting material has a lower degree of reactivity.

In some embodiments, the starting material contains sulphur as elemental sulphur (S₀) or brimstone that can be oxidized to produce thiosulphate during the leaching step. In some embodiments, the starting material contains iron. In some embodiments, the starting material contains copper. In some embodiments in which the starting material contains copper, the copper is present in an amount of at least 0.05% or 0.1% by weight.

In some embodiments, the starting material is subjected to any desired type of pre-processing to partially recover and/or to enhance the recovery of the precious metals from the starting material. For example, the starting material may be subjected to flotation, pressure oxidation, grinding (wet or dry), or the like. In some embodiments, the starting material is subjected to flotation. In some embodiments, the starting material is subjected to size reduction so that particles of the starting material have an average particle size in the range of between about 5 and 100 μm, including any value therebetween e.g. 10, 15, 20, 25, 30, 35, 40, 45, 50, 55, 60, 65, 70, 75, 80, 85, 90 or 95 μm.

In some embodiments, the starting material is combined into an aqueous solution to form a slurry that is incorporated into the reaction mixture. In some embodiments, the pulp density of the starting material in the reaction mixture is between about 10% w/v and about 60% w/v, including any value therebetween, e.g. 15, 20, 25, 30, 35, 40, 45, 50 or 55% w/v.

In some embodiments, the leaching process is conducted at a temperature in the range of about 25° C. to about 95° C., including any temperature therebetween, e.g. 30, 35, 40, 45, 50, 55, 60, 65, 70, 75, 80, 85 or 90° C. In some such embodiments, the leaching process is conducted at atmospheric pressure. In some embodiments, the leaching process is conducted as a pressure leaching process at a pressure of e.g. greater than 1.0 atm to 10 atm of oxygen overpressure including any value therebetween e.g. 1.5, 2, 3, 4, 5, 6, 7, 8 or 9 atm of oxygen overpressure, and in such cases higher temperatures could be used so that the process is conducted at a temperature in the range of about 25° C. to about 120° C., including any temperature therebetween e.g. 30, 40, 50, 60, 70, 80, 90, 100, or 110° C.

In some embodiments, the thiosulphate leaching process is carried out at a pH in the range of about 7.5 to about 11, including any value therebetween, e.g. 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8 or 10.9. In some embodiments, the thiosulphate leaching process is carried out at a pH in the range of about 9.0 to about 9.5.

In some embodiments, a basic compound is added to the reaction mixture to provide and/or maintain a desired pH level. In some embodiments, sodium carbonate (Na₂CO₃), sodium bicarbonate (Na₂HCO₃), potassium carbonate (K₂CO₃), potassium bicarbonate (KHCO₃), lithium carbonate (Li₂CO₃), lithium bicarbonate (LiHCO₃), magnesium carbonate (MgCO₃), magnesium bicarbonate (Mg(HCO₃)₂), a naturally occurring carbonate mineral (such as calcite, dolomite, aragonite, or the like), or the like is added to the reaction mixture as the basic compound. In some embodiments, other carbonate salts or sources of carbonate are added to the reaction mixture as the basic compound. In some embodiments, a strong base such as sodium hydroxide (NaOH), potassium hydroxide (KOH), calcium hydroxide (Ca(OH)₂), lithium hydroxide (LiOH), or the like is added to the reaction mixture as the basic compound. In some embodiments, a combination of carbonate and strong base are added to the reaction mixture as the basic compound. In some embodiments, the basic compound is titrated into the reaction mixture over time, so that the pH is maintained at approximately a desired value for the reaction period of the leaching process. It will be apparent to those skilled in the art that equivalent bases having different counterions can be used in alternative embodiments.

In some embodiments in which the base is sodium carbonate, the amount of carbonate that is added to the reaction mixture in the form of sodium carbonate is in the range of about 5 kg/t to about 200 kg/t, including any value therebetween, e.g. 10, 15, 20, 25, 30, 35, 40, 45, 50, 60, 70, 80, 90, 100, 110, 120, 130, 140, 150, 160, 170, 180 or 190 kg/t. In some embodiments in which the source of carbonate is a source other than sodium carbonate, the foregoing values are adjusted so that an equivalent amount of the compound is added to the reaction mixture. The person skilled in the art can determine the amount of basic compound, including carbonate, to be added based on factors such as the anticipated acidity produced by sulphide in the starting material and the solubility of the basic compound being added (e.g. the solubility of the specific carbonate salt type being added to the reaction mixture).

In some embodiments, the reaction conditions during the thiosulphate leaching step are controlled so that the rate of thiosulphate generation yields and maintains a concentration of thiosulphate in the reaction mixture of at least about 2-3 g/L. Higher amounts of thiosulphate will work in alternative embodiments, and the maximum amount of thiosulphate present is generally determined by the maximum amount of thiosulphate that can be generated under the reaction conditions. In some embodiments, the concentration of thiosulphate in the reaction mixture is between about 2 g/L to about 30 g/L or higher, including any intervening value e.g. about 3, 4, 5, 6, 7, 8, 9, 10, 15, 20 or 25 g/L or higher.

In some embodiments, copper is added to the reaction mixture, e.g. as copper sulphate or in any other suitable form, so that the concentration of copper in the reaction mixture is at least about 10 ppm to about 50 ppm, including any value therebetween, e.g. 15, 20, 25, 30, 35, 40 or 45 ppm.

In some embodiments, the leaching process is conducted without the addition of any ammonia (NH₄⁺).

In some embodiments, the reaction mixture is maintained at a desired oxidation-reduction-potential (ORP). In some embodiments, the reaction mixture is maintained at an ORP of at least about −80 to about 100 mV (as measured using an Ag—AgCl reference electrode), including any value therebetween, e.g. −75, −70, −65, −60, −55, −50, −45, −40, −35, −30, −25, −20, −10, −5, 5, 10, 15, 20, 25, 30, 35, 40, 45, 50, 55, 60, 65, 70, 75, 80, 85, 90 or 95 mV. In some embodiments in which the thiosulphate dissolves a relatively larger amount of copper, a higher ORP may be desirable.

In some embodiments, the desired ORP is achieved and/or maintained by supplying an oxidant to the reaction mixture. In some embodiments, the desired ORP is achieved by sparging the reaction mixture with oxygen. In some embodiments, the desired ORP is achieved and/or maintained by sparging the reaction mixture with oxygen at a flow rate of approximately 0.1 L/min and/or by adjusting the supply of oxygen based on the measured ORP of the reaction mixture. In some embodiments, the desired ORP is achieved by supplying an oxidant such as oxygen in proportion to the mass throughput of the starting material. In some embodiments, the oxidant is supplied at a rate of between about 0.35 and 0.55 tonnes per tonne of sulphur to be oxidized to thiosulphate, including any value therebetween e.g. 0.36, 0.38, 0.40, 0.42, 0.44, 0.46, 0.48, 0.50, 0.52 or 0.54 tonnes of oxidant per tonne of sulphur to be oxidized to thiosulphate.

For example, the oxidation of iron sulphide to yield sodium thiosulphate can be summarized according to reaction (4) below so that it can be determined theoretically that 1.75 moles of oxygen should be supplied per 2 moles of sulphur in the starting material (in this example, pyrite) to be oxidized to thiosulphate or 0.875 moles oxygen/mole sulphur. Using molecular weights, this would be 0.44 t of oxygen per t of sulphur oxidized to thiosulphate. The selection of the amount of oxidant to be added should balance the need to oxidize sulphur compounds to generate thiosulphate, while maintaining the ORP of the reaction mixture at a value that promotes extraction of the precious metal values with the generated thiosulphate.

FeS₂+1.75O₂+2NaOH+½H₂O=Fe(OH)₃+Na₂S₂O₃ (4)

In some embodiments, the reaction mixture is stirred or otherwise mixed on a continuous or largely continuous basis, to provide good mixing of the reaction mixture. Good mixing of the reaction mixture can help to maintain good oxygen distribution and/or stable pulp ORP throughout the reaction mixture. In some embodiments, the mixture is a slurry and the slurry has between about 10% and about 50% by weight of solids content (including any value therebetween, e.g. 15%, 20%, 25%, 30%, 35%, 40% or 45%), with the remaining proportion of the reaction mixture being a liquid.

In some embodiments, leaching is conducted for a leaching period of between 4 and 36 hours, including any value therebetween, e.g. 5, 6, 7, 8, 9, 10, 11, 12, 13, 14, 15, 16, 17, 18, 19, 20, 21, 22, 23, 24, 25, 26, 27, 28, 29, 30, 32 or 34 hours.

In some embodiments, precious metals and optionally other metals such as copper are recovered from the leached solution in any suitable manner, e.g. by direct precipitation, precipitation using a suitable reductant, ion exchange chromatography, or in any other desired manner. In some embodiments, other metal values such as copper are recovered from the leached solution in any suitable manner, e.g. by direct precipitation, precipitation using a reductant, or in any other desired manner. In some embodiments, reduction of metal values, including precious metal values, from the leached solution using a reductant (also referred to herein as the first reductant) is used to precipitate the metal values into a solid form for recovery. In some embodiments, the reductant used is copper, a copper concentrate (which may originate from any source of copper, including in some embodiments as a chalcopyrite/pyrite concentrate, marcasite or pyrrhotite or the like, or mixtures thereof), any concentrate containing aluminum, zinc or iron (e.g. as metallic iron), or any other suitable reductant. In some embodiments, copper or any suitable source of copper such as a copper concentrate may be used as a reductant to precipitate gold or silver from the thiosulphate reaction mixture. In some embodiments, the reductant is pyrite, chalcopyrite, pyrrhotite and/or marcasite. In some embodiments, the reductant is ferrous sulphate (FeSO₄). In some embodiments, aluminum or zinc may be used as a reductant to precipitate gold, silver and/or copper from the thiosulphate reaction mixture.

Without being bound by theory, the possible chemistry demonstrating the precipitation of gold using ferrous sulphate as the reductant is given in Equation (5) below:

2Na₃Au(S₂O₃)₂+2FeSO₄+3Na₂CO₃+3H₂O=2Au+2Fe(OH)₃+4Na₂S₂O₃+3CO₂+2Na₂SO₄ (5)

Gold is reduced to elemental gold and iron (II) is oxidized to form ferric hydroxide containing iron (III).

In some embodiments, the reductant may be size reduced in any suitable manner to increase its surface area prior to being added to the leached solution to precipitate metal values. In some embodiments, the reductant may have an average particle size in the range of between about 5 and 500 μm, including any value therebetween e.g. 10, 25, 50, 75, 100, 150, 200, 250, 300, 350, 400 or 450 μm.

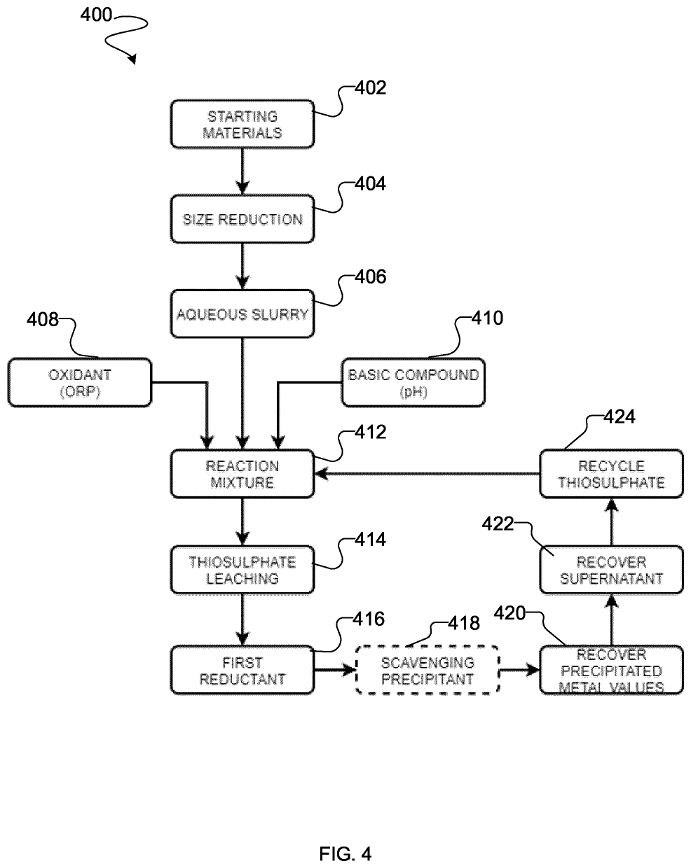

In some embodiments, direct precipitation is conducted by adding sodium hydrosulphide (NaSH) as a reductant to the leached solution, optionally in combination with one or more other precipitation methods. For example, precipitation may be conducted with a first reductant as described above, wherein the first reductant is not NaSH, and then a small amount of NaSH may be added as a scavenging precipitant to further increase the percentage of metal values precipitated out of the leached solution and/or to regenerate thiosulphate for recycling to the leaching reaction mixture. In some embodiments, the addition of NaSH to the leached solution to precipitate metal values is minimized because this may necessitate further treatment before the supernatant can be recycled back to the thiosulphate leach step (e.g. oxidation may be required) to recover thiosulphate and/or because NaSH may form hydrogen sulphide gas if acidified so that reaction conditions should be controlled to avoid this and/or any generated hydrogen sulphide gas should be stripped to prevent release to atmosphere or the like. The addition of NaSH may help to regenerate thiosulphate, which may be beneficial in embodiments in which the leached solution is recycled back to the leaching reaction mixture subsequent to precipitation of the metal values, e.g. as illustrated in FIG. 4.

In some embodiments, direct precipitation is conducted by adjusting the ORP of the leached solution to a value favouring precipitation of the precious metal and/or other metal values. For example, reducing the ORP below a certain threshold or increasing the ORP above a certain threshold may result in destruction of the thiosulphate in solution, which would favour precipitation of metal values. In some embodiments, direct precipitation is conducted by adjusting the pH of the leached solution to a value favouring precipitation of the precious metal and/or other metal values. For example decreasing the pH of the leached solution below a certain threshold or above a certain threshold may result in destruction of the thiosulphate in solution, which would favour precipitation of the metal values. In some embodiments, both pH and ORP may be adjusted to values that result in destruction of the thiosulphate in solution to precipitate the metal values.

In some embodiments, the ORP of the leached solution is reduced by exposing the leached solution to a non-oxidizing atmosphere. In some embodiments, the non-oxidizing atmosphere is proved by sparging the leached solution with an inert gas such as nitrogen (N₂) or argon (Ar). In some embodiments, the non-oxidizing atmosphere is provided by using a vacuum deaeration system to remove oxygen from the leached solution.

In some embodiments, the pH of the leached solution is reduced by adding any desired acid to reduce pH levels, e.g. H₂SO₄, HCl, or the like. In some embodiments, the pH of the leached solution is increased by adding any desired basic compound to increase pH, e.g. lime or calcium hydroxide.

In some embodiments, precipitation of leached precious metal values or other metal values is carried out on a flotation concentrate, e.g. a chalcopyrite/pyrite, pyrite, pyrrhotite or marcasite concentrate or other iron-containing concentrate, optionally including with an accompanying decrease in the pH and/or ORP of the leached solution. Without being bound by theory, it is believed that under non-oxidizing or reductive conditions, chalcopyrite partially converts to covellite by the displacement of iron from the chalcopyrite lattice with copper from solution. Similarly, the chalcopyrite reduces gold on the surface of the mineral.

In some embodiments, such precipitation step carried out on the leached solution is conducted at a temperature in the range of about 20° C. to about 100° C., including any temperature or subrange therebetween, e.g. about 25, 30, 35, 40, 45, 50, 55, 60, 65, 70, 75, 80, 85, 90 or 95° C.

In some embodiments, such precipitation step carried out on the leached solution is conducted at an oRP of about −200 to about −800 mV, including any value or subrange therebetween, e.g. about −250, −300, −350, −400, −450, −500, −550, −600, −650, −700 or −750 mV.

In some embodiments, such precipitation step carried out on the leached solution is conducted at a pH of about 8.0 to about 10.5, including any value or subrange therebetween, e.g. about 8.5, 9.0, 9.5 or 10.0.

In some embodiments, such precipitation step carried out on the leached solution is carried out while the concentration of thiosulphate is maintained in a range of between about 2,000 to about 21,000 ppm, including any value or subrange therebetween, e.g. about 2,500, 3,000, 3,500, 4,000, 4,500, 5,000, 5,500, 6,000, 7,000, 8,000, 9,000, 10,000, 11,000, 12,000, 13,000, 14,000, 15,000, 16,000, 17,000, 18,000, 19,000 or 20,000 ppm.

In some embodiments, such precipitation step carried out on the leached solution is carried out at atmospheric pressure. In some embodiments, such precipitation step carried out on the leached solution is carried out in a pressurized environment, i.e. a pressure above atmospheric pressure, e.g. at a pressure of between about 5 and about 50 psig, including any value or subrange therebetween, e.g. 10, 15, 20, 25, 30, 35, 40 or 45 psig.

In some embodiments, the conditions selected for precipitating the metal values are selected to avoid or minimize any corrosion of the equipment in which the precipitation step is conducted.

In some embodiments, the metal values are precipitated without the addition of any ammonia.

In some embodiments, the co-precipitate of iron and gold can be recovered via filtration and/or processed further as a concentrate.

In some embodiments, the supernatant remaining after precipitation of the metal values from the leached solution as described above is recovered and recycled back to the thiosulphate leach step. For example, in some embodiments the supernatant remaining after precipitation of the metal values is recovered by filtration to remove solids and then passed back to the reaction mixture formed at the thiosulphate leaching step to thereby recycle thiosulphate within the process. In some embodiments, treatment of the supernatant, e.g. by oxidation, to increase its thiosulphate concentration and/or to decrease the amount of any undesired compounds present is carried out prior to recycling the supernatant back to the thiosulphate leaching step.

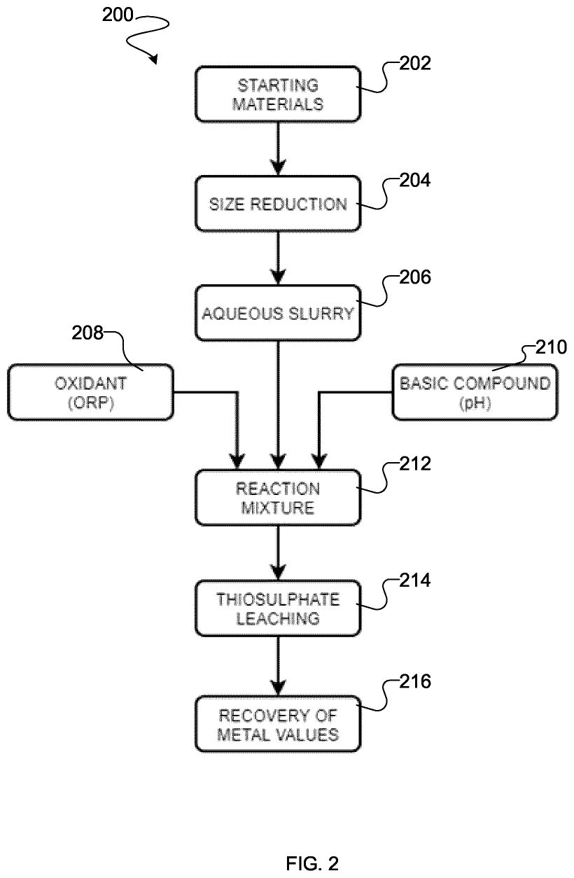

With reference to FIG. 2, an example embodiment of a process 200 for the recovery of metal values from a starting material is illustrated. At 202, suitable starting materials such as those described above are supplied. At 204, the starting materials are subjected to a size reduction step as described above. At 206, an aqueous slurry is formed incorporating the size-reduced starting materials. At 208 oxidant is supplied and at 210 a basic compound is supplied or the pH is otherwise increased to a desired level to form a reaction mixture, illustrated at 212. At 214, the thiosulphate in the reaction mixture is used to leach metal values present in the starting materials to solubilize the metal values to form a leached solution as described above. At 216, the metal values including precious metal values are recovered from the leached solution in any suitable manner, for example as described above.

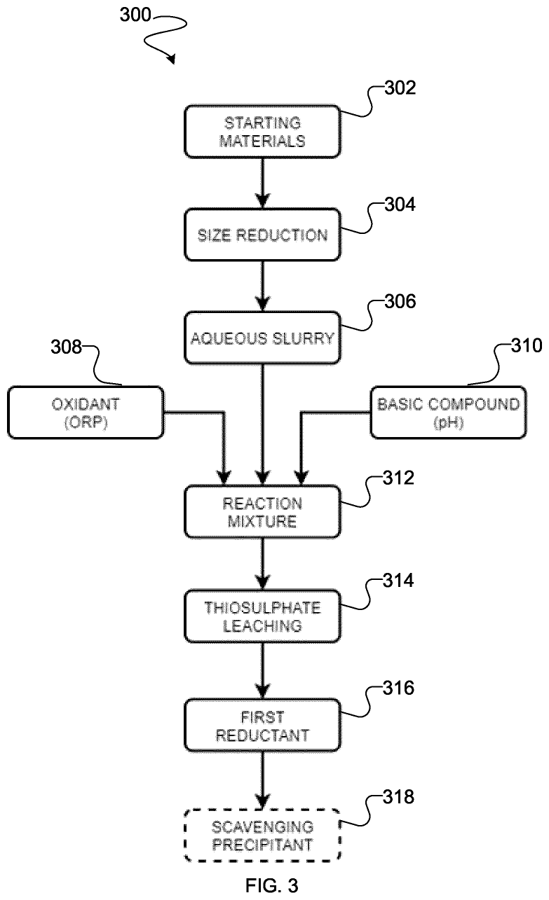

With reference to FIG. 3, a more specific embodiment of process 200 is illustrated as process 300, in which equivalent steps are illustrated with reference numerals incremented by 100, including the supply of starting materials at 302, size reduction at 304, formation of an aqueous slurry at 306, addition of an oxidant at 308 and a basic compound at 310 to form a reaction mixture at 312 and allowing thiosulphate to leach the metal values at 314 to form a leached solution as described above. At 316 to recover metal values from the leached solution, a suitable reductant such as those described above is added to precipitate the metal values including precious metal values. In some embodiments, step 316 is conducted under a non-oxidizing atmosphere as described above. Optionally in some embodiments at 318, a further precipitation agent such as NaSH may be added as a scavenging precipitant after the first reductant has been added, to further enhance the precipitation of the metal values out of solution.

With reference to FIG. 4, a further more specific embodiment of process 200 is illustrated as process 400, in which equivalent steps are illustrated with reference numerals incremented by 200, including the supply of starting materials at 402, size reduction at 404, formation of an aqueous slurry at 406, addition of an oxidant at 408 and a basic compound at 410 to form a reaction mixture at 412 and allowing thiosulphate to leach the metal values at 414 to form a leached solution as described above. At 416 to recover metal values from the leached solution, a suitable first reductant such as those described above is added to precipitate the metal values including precious metal values. In some embodiments, the reductant used at step 416 is not NaSH. In some embodiments, step 416 is conducted under a non-oxidizing atmosphere as described above. Optionally in some embodiments at 418, a further precipitation agent such as NaSH may be added as a scavenging precipitant after the first reductant has been added, to further enhance the precipitation of the metal values out of solution and/or to regenerate thiosulphate. In process 400, the supernatant remaining after the metal values in solution have been precipitated is recovered at 420, for example via filtration to separate the supernatant from the solids, and at 422 thiosulphate remaining in the supernatant is recycled for further use in process 400, for example by addition to the reaction mixture at 412.

### EXAMPLES

Further embodiments are described with reference to the following examples, which are intended to be illustrative and not limiting in scope.

The following examples confirm that thiosulphate can be generated successfully for gold leaching from gold-bearing sulphide ores, and further that gold can be recovered from the resultant liquid solution. Variables tested include temperature, carbonate concentration, and caustic concentration (or concentration of basic compound), pH and oxidation-reduction potential (ORP).

The studies described herein demonstrate the leaching of gold (e.g. achieving 52-56% extraction) with in-situ generated thiosulphate at a pH<10.5 controlled by additions of sodium carbonate and caustic, with 0.1 L/min oxygen addition and a reaction temperature of 93° C. The first set of studies described below used pH 9.3, 0.1 L/min oxygen flow and a temperature of 75° C. It was found to be important to maintain a desired pH and provide adequate oxygen distribution in the slurry. To maintain consistent pH, sodium carbonate was added. The carbonic acid system results in a displacement of equilibrium between H⁺ and OH⁻ ions establishing a specific pH which itself influences the speciation of oxy-sulphur species. Maintaining the pH at 9.3 using carbonate alone can be difficult because the rate of pH change is very fast. A single test was run using carbonate alone maintaining pH at 8.5. The leach solution mainly contained bicarbonate. It generated ˜4-5 g/L S₂O₃ and achieved ˜58% gold extraction. When pH was maintained at 9.3 with added caustic, the gold extraction improved to 72% and generated ˜16 g/L thiosulphate. Both these tests were done using a well mixed reactor. Without being bound by theory, good mixing affects oxygen distribution (reaction with sulphides) and establishes the stable pulp ORP conditions. The remaining tests were done using a smaller reactor(s) and different impellers. From this current test program, it was found that the proper ORP (>−30 mV vs. Ag/AgCl) determines not only the leaching kinetics but also the stability of leached gold in the thiosulphate solution and demonstrated the successful leaching of gold from these sulphide flotation products.

### Example 1.0—Tested Flotation Products

A flotation product (Reground P₈₀=13.5 μm) was tested. The sample contained 1.34 g/t Au, 5.5 g/t Ag, 0.15% Cu and 23.4% S²⁻. The gold extraction from this sample by cyanidation was 64.0% within 6 hours and 71.5% after 24 hours. At 33% solids, the final cyanide leach solution contained 0.52 mg/L Au and the residual gold in solids was ˜0.44 g/t. The objective of leach program was to extract the gold with thiosulphate generated from sulphides in solids and stabilized with a carbonate buffered solution in a manner that approaches or exceeds the results that could be obtained from cyanidation leaching of the same product.

### Example 1.1—Conduct of Batch Tests

Experiments were conducted in an overhead agitated vessel. Two different reactors were used. The leaching temperature was maintained using a temperature-controlled heating mantle when using larger reactor (1 L) and a water bath with the smaller (0.5 L) reactor. During leaching, kinetic samples were taken at time intervals and analysed for gold in solution by a solvent extraction method followed by atomic absorption (AA) analysis. The thiosalts were measured by ion chromatography (IC). The carbonates were measured by acid titration method. The solids were filtered, washed, dried and shipped to external labs for assay.

Results of 11 batch tests are presented in Table 1 below.

TABLE 1
Summary of results of 11 batch tests conducted in Example 1.

| | | | | | Consumption | | | Final solution | | | |
|---|---|---|---|---|---|---|---|---|---|---|---|
| | Solids | T | | Time | Na₂CO₃ | NaOH | | ORP | CO₃ | HCO₃ | S₂O₃ |
| Test ID | % | ° C. | pH | h | kg/t | kg/t | pH | mV | M | M | g/L |
| T 1 | 38 | 60 | 9.5 | 24 | 37 | 104 | 9.1 | −8.0 | 0.00 | 0.00 | 7.0 |
| T 2 | 40 | 75 | 9.5 | 24 | 29 | 144 | 10.1 | −55 | 0.14 | 0.07 | 45.7 |
| T 3-1 | 40 | 75 | 9.5 | 8 | 26 | 41 | 9.5 | −32 | 0.07 | 0.16 | 15.9 |
| T 3-2 | 40 | 75 | 0.0 | 8 | 5 | 21 | 9.5 | −67 | 0.16 | 0.21 | 27.4 |
| T3 (comb) | — | — | — | — | — | — | — | — | — | — | — |
| T-4 | 33 | 75 | 9.3 | 9 | 12 | 181 | 9.3 | −26 | 0.04 | 0.06 | 16.7 |
| T-5 | 40 | 75 | 8.8 | 8 | 191 | 0 | 8.6 | 11 | 0.03 | 0.23 | 4.47 |
| T-6 | 40 | 75 | 9.3 | 12 | 11 | 213 | 9.3 | −40 | 0.10 | 0.02 | 29.1 |
| T-7 | 40 | 25 | 9.3 | 12 | 10 | 110 | 10.1 | 24 | 0.11 | 0.02 | 11.0 |
| T-8 | 40 | 75 | 9.3 | 12 | 9 | 78 | 9.1 | −49 | 0.08 | 0.06 | 24.6 |
| T-9 | 40 | 75 | 9.3 | 8 | 11 | 71 | >12 | — | — | — | 26.9 |
| T-10 | 33 | 75 | 9.3 | 8 | 8 | 171 | 9.3 | −40 | 0.05 | 0.04 | 15.1 |
| T-11 | 34 | 75 | 9.3 | 8 | 8 | 110 | 9.3 | −20 | 0.09 | 0.09 | 14.7 |
| T-(10&11) | — | — | — | — | — | — | — | — | — | — | — |

| | | | | Head | Head | | | Head | Head | | |
|---|---|---|---|---|---|---|---|---|---|---|---|
| | | Ext. | Res. | (calc) | (direct) | Ext. | Res. | (calc) | (direct) | Res | Head |
| | Au | Au | Au | Au | Au | Ag | Ag | Ag | Ag | S⁼ | S⁼ |
| Test ID | mg/L | % | g/t | g/t | g/t | % | g/t | g/t | g/t | % | % |
| T 1 | 0.32 | 51.5 | 0.57 | 1.18 | 1.34 | 27.3 | 4.00 | 5.50 | 5.50 | 18.2 | 23.4 |
| T 2 | 0.23 | 37.0 | 0.73 | 1.16 | 1.34 | 34.5 | 3.60 | 5.50 | 5.50 | 15.7 | 23.4 |
| T 3-1 | 0.48 | 59.6 | — | — | — | — | — | — | — | — | — |
| T 3-2 | 0.04 | 12.5 | — | — | — | — | — | — | — | 17.7 | 23.4 |
| T3 (comb) | — | 64.6 | 0.35 | | 1.34 | 53.3 | 2.20 | 5.13 | 5.50 | | |
| T-4 | 0.40 | 72.1 | 0.37 | 1.33 | 1.34 | 62.4 | 2.60 | 6.91 | 5.50 | 15.4 | 23.4 |
| T-5 | 0.31 | 57.7 | 0.47 | 1.11 | 1.34 | 64.2 | 2.80 | 7.81 | 5.50 | 16.9 | 23.4 |
| T-6 | 0.13 | 27.8 | 0.97 | 1.34 | 1.34 | 16.3 | 4.90 | 5.85 | 5.50 | 12.7 | 23.4 |
| T-7 | 0.10 | 17.1 | 1.05 | 1.27 | 1.34 | 20.0 | 4.40 | 5.50 | 5.50 | 16.5 | 23.4 |
| T-8 | 0.34 | 50.5 | 0.60 | 1.21 | 1.34 | 38.2 | 3.40 | 5.50 | 5.50 | 18.6 | 23.4 |
| T-9 | 0.01 | 7.0 | 1.25 | 1.34 | 1.34 | — | — | — | — | | |
| T-10 | 0.31 | 59.2 | 0.55 | 1.35 | 1.34 | 28.1 | 4.30 | 5.98 | 5.50 | 14.7 | 23.4 |
| T-11 | 0.08 | 15.1 | 0.47 | 0.55 | 0.55 | — | — | — | — | 8.7 | 14.7 |
| T-(10&11) | — | 64.9 | 0.47 | — | — | — | — | — | — | | |

### Example T1

200 g of dry sample was mixed with 250 ml of deionized water yielding a pH of 2.98. The mixture was heated to 60° C. and a pH of 1.8. Carbonate solution (0.94M) was added at temperature until pH 9.5 was achieved; 81.41 g of 0.94 M Na₂CO₃ was consumed, which is 37.3 g of Na₂CO₃ per kg of sample. 2.5 M NaOH solution (caustic) was set to be pumped into the reaction mixture to maintain pH in the range of about 9.3-9.5. The NaOH (2.5 M) consumption at 1 hour was 16 mL, and a 2 hours was 14 mL. At 2.5 hours, extra volume of NaOH was added unintentionally, and pH increased to 11.5. At 6 hours, the pH decreased to 9.2 and a sample was taken at that time. S₂O₃ concentration was 4-5 g/L at 1 and 2 hours (pH˜9.3), and increased to 12.5 g/L when the pH increased above 9.5 Overnight, the pH dropped to 6.8 because of a shortage of NaOH due to the reagent having been completely consumed and therefore not pumping into the leach. The low pH decomposed most of the thiosulphate, converting it to trithionate. After adding NaOH at 20 hours, thiosulphate started to build but slowly.

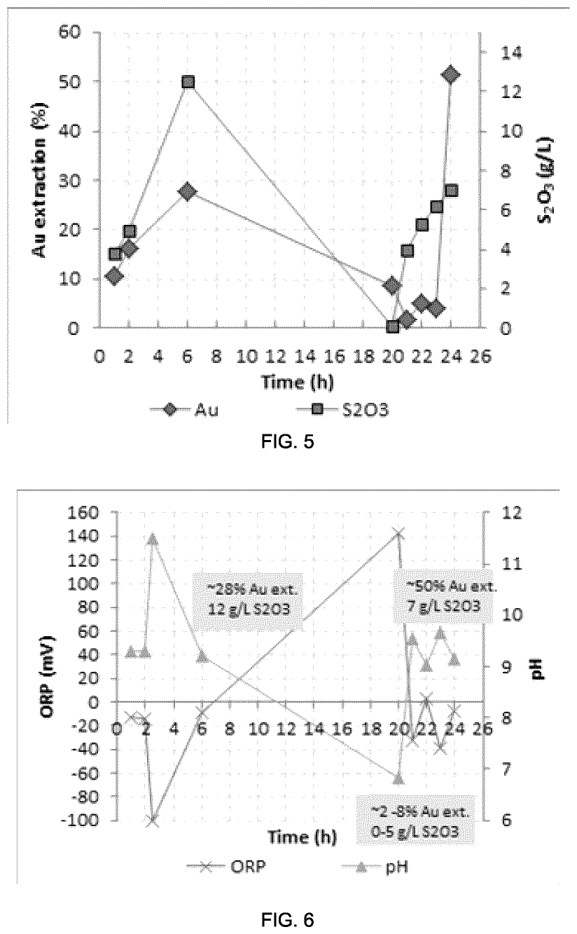

The T1 experiment was run at 60° C. with the initial 0.29 M total carbonate. The caustic (2.5M) was added during 24 h as required to try to maintain a target pH 9.3 and it was synchronized with the pumping system. The carbonate concentration dropped from initially 0.29 M to 0.10 M (0.19 M) during 2 h and later the carbonate was completely consumed. At 2 hours, an excess of caustic was unintentionally added resulting in a pH>11.5. Without any modification, the pH naturally decreased to 9.2 (reacting with sulphides) after 6 hours and further to pH 6.8 at 20 hours. The addition of NaOH was resumed at 20 hours targeting pH˜9.3 and this pH was maintained between 20-24 hours. The gold extraction and thiosulphate profiles are presented in FIG. 5. FIG. 6 shows the pH/ORP change with time.

From FIG. 5, the highest thiosulphate concentration was detected at 6 hours (pH 9.2, ORP=−9.3 mV Ag/AgCl) and the gold extraction at that time was around 27%. It has to be noted that at 2.5 h the pH was >11.5 (FIG. 6) which could have impacted the thiosulphate generation. At that time, there is no exact ORP value recorded but based on other tests it is estimated to have been around −100 mV Ag/AgCl. Overnight, the pH dropped to ˜7 and the ORP was positive over 100 mV Ag/AgCl. These changes negatively affected the thiosulphate concentration and the dissolved gold. The thiosulphate decomposed at high ORP and the gold precipitated out of solution. When pH was modified to ˜9, the thiosulphate started to build up and in final solution it was 7 g/L S₂O₃. In final solution, the ORP was around −8 mV Ag/AgCl and the gold re-dissolved fast achieving ˜51.5% extraction. Hence, it is possible to dissolve the gold with 7 g/L S₂O₃ under suitable conditions (pH˜9.1-9.3 and ORP˜−8 mV Ag/AgCl). Furthermore, this test showed that the gold precipitated at pH˜7 and ORP>100 mV Ag/AgCl.

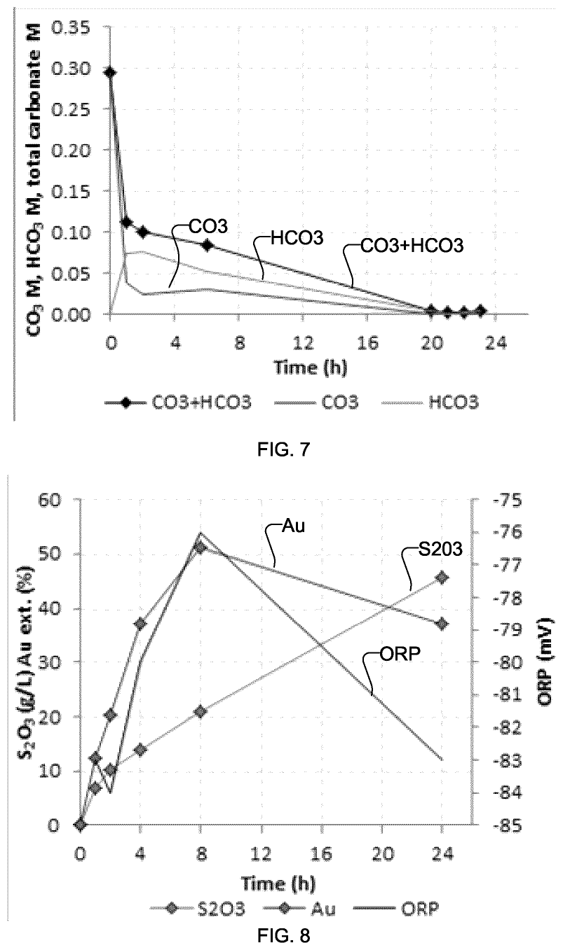

After 1 hour of treatment, from initial 0.29 M carbonate approximately 0.18 M (60% of added carbonate) was consumed and afterward, the concentration of both carbonate and bicarbonate was decreasing with time and at the end the all carbonates were consumed. The profiles are presented in FIG. 7.

### Example T2

The carbonate dosage was doubled (˜0.4M) in the T2 experiment. Similar to T1 test, ˜0.14 M was consumed within the first hour and the total carbonate was 0.26 M at that time. In the final 24 hour solution, the total carbonate concentration was 0.22 M. Hence, very little carbonate was consumed after initial drop in concentration. The test was run at 75° C. The pH was set at 9.5 and maintained with NaOH addition. FIG. 8 shows the kinetics.

The thiosulphate concentration increased with time reaching ˜46 g/L in 24 hours. The pH was around 9.5 at 75° C. The calculated pH (based on K=4.69E-11 and the following relationship: pH=pKa+log ([CO₃]/[HCO₃]) was in the range of 10.3-10.6. The ORP was between −84 and −76 mV Ag/AgCl. The extracted gold˜51% peaked and then decreased to 37% when ORP dropped to ˜−83 mV value (Ag/AgCl).

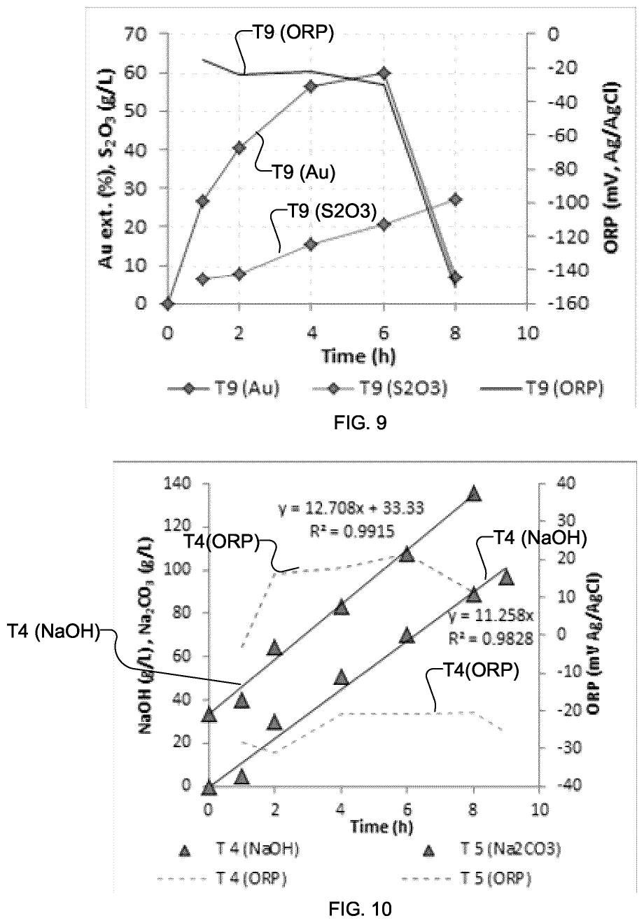

A similar pattern was detected in the T9 experiment. The gold extraction reached a maximum (˜60%) at 6 h and then precipitated almost completely when the ORP dropped from −30 to −150 mV Ag/AgCl. The final gold extraction was 7%. FIG. 9 shows kinetics. It seems the gold precipitated when ORP sharply decreased (pH>12 owing to large amounts of added NaOH).

The profiles in FIG. 8 and FIG. 9 are similar. Despite high levels of thiosulphate in the T2 test, some gold disappeared from solution when the ORP decreased. Similarly, strong influence of ORP on the gold profile is evident in T9 test results. Without being bound by theory, this indicates that the ORP is an important factor related to the stability of the leached gold. The ORP is a function of pH dependent speciation and therefore, the experiments were controlled by the change in pH and this impacted the ORP.

### Example T4

In the T4 experiment, the pH was maintained at 9.3 almost perfectly using 5M NaOH. The ORP was between −30 and −20 mV Ag/AgCl. The T4 test generated 16.7 g/L S₂O₃ and leached 72.2% gold in the 8 hours of leaching time (FIG. 34).

### Example T5

Next, the T5 experiment maintained alkaline pH 8.5 using carbonate alone. The ORP remained positive throughout the test duration and between 12 to 16 mV Ag/AgCl. The test generated 4.5 g/L S₂O₃ and extracted 57.7% gold during 8 h. The kinetics for both tests T4 and T5 is shown in FIG. 34. FIG. 10 shows the NaOH or Na₂CO₃ dosages and the ORP profiles for both tests T4 and T5.

From FIG. 34, the gold extraction profiles are similar but higher in T4 with NaOH used as a pH modifier. The slow buildup of thiosulphate is also evident at pH 9.3 whereas with pH 8.5 maintained with carbonate the thiosulphate does not accumulate but is stable around 4-5 g/L. From FIG. 10, the rate of caustic and carbonate dosages both are linear. In both tests, the ORP values did not go below −30 mV Ag/AgCl and the leached gold did not precipitate.

### Example T6

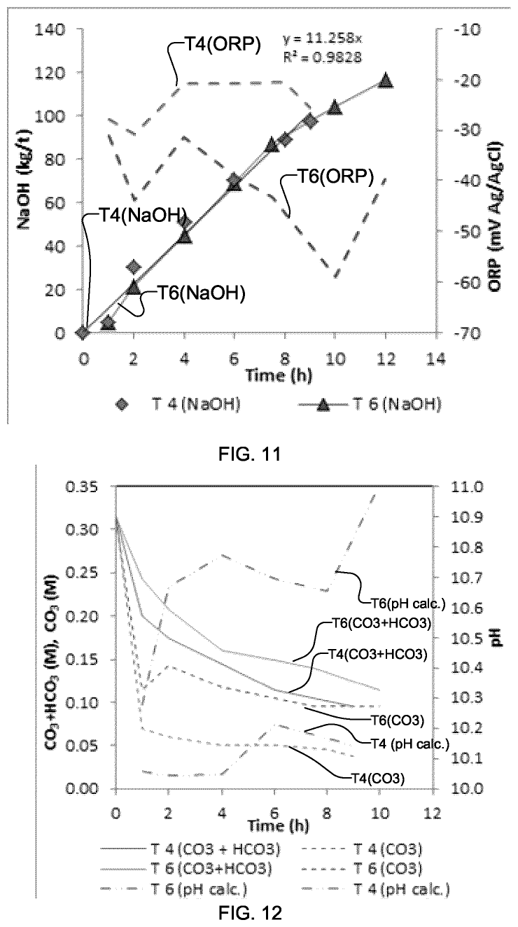

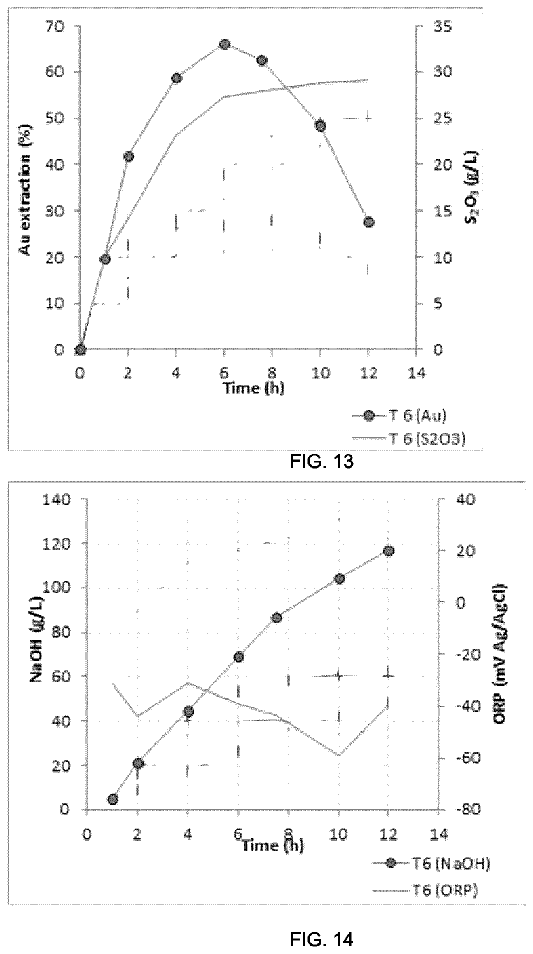

The T6 test was meant to repeat the T4 conditions on a different setup (reactor). The gold extraction profiles shown in FIG. 34 match until 6 hours but afterwards the extraction curves diverge. The gold started to precipitate in the T6 test. The thiosulphate generated in the T6 test was 29 g/L compared to 17 g/L S₂O₃ formed in T4 (FIG. 34). It is interesting that the NaOH addition rate in these two tests was similar (FIG. 11) but the ORP values were different. Higher thiosulphate and lower ORP in T6 points to higher actual pH. Without being bound, this could possibly be linked to a malfunction of the pH probe. FIG. 12 presents the calculated pH. Based on carbonate/bicarbonate ratio, the pH was calculated and after 2 hours, the actual pH range for the T6 test was 10.6 to 11.0 while for T4 the pH did not exceed 10.2. The difference in pH (between pH 10.2 and pH 11) is not significant when judging based on similar NaOH dosage but it seems significant for thiosulphate and gold extraction. FIG. 13 presents the gold extraction and thiosulphate concentration, and FIG. 14 presents the NaOH addition and ORP.

### Example T3

The T3 experiment was divided in two sections; a test run with the smaller (˜0.5 L) reactor and a steel agitator. In T3-1, the fresh sample was treated with 0.4 M carbonate and caustic added as required to maintain an alkaline pH. The test generated over 30 g/L S₂O₃ within the first 3 hours at pH>10.5 and ORP>−100 mV Ag/AgCl but gold extraction was poor ˜23%. After 3.5 h, the pH was maintained at 9.5, the ORP was ˜−34 mV Ag/AgCl, the thiosulphate concentration decreased to 16 g/L and the gold extraction increased to ˜60%.

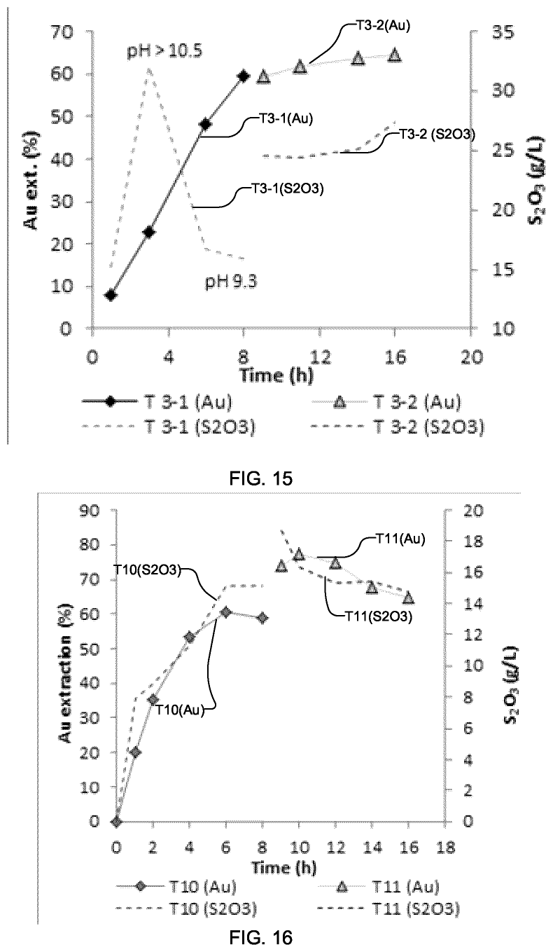

In the second part T3-2, the leached/washed residue was re-leached with 0.4M carbonate and 20 g/L sodium thiosulphate. FIG. 15 shows the gold concentration in solution and the ORP variations. FIG. 15 shows that ˜60% gold was extracted with in-situ thiosulphate and was only slightly improved to ˜65% with added thiosulphate in the second-round leach.

### Example T10

The T10 test was similar to previous tests except the pulp density was 33% which is lower compared to other tests (˜40% pulp density). The gold leaching was complete at 6 hours and no additional gold was leached in following two hours. The T10 test products were filtered, residue washed and dried. The filtrate was treated with NaSH. The NaSH treated solution was used to re-leach the T10 residue. The T11 leached more gold but the solubilised gold was not stable. The leach kinetics are shown in FIG. 16. The NaSH results are given in Table 2. The residue assays for all batch tests are given in Table 3. The NaSH precipitation of gold was not complete with 0.055 mg/L of Au left in solution, even at a low ORP (−400 mV Ag/AgCl). Similarly, Cu and Ag were not completely removed from solution. The reason for this behavior is not clear. Under such a reduced condition, the three metals should all be removed effectively from solution.

TABLE 2
NaSH test on T 10 filtrate.

| | | 20% | | | | | | | | |
|---|---|---|---|---|---|---|---|---|---|---|
| | Volume | NaHS | ORP | | Au | Ag | Cu | S₂O₃ | S₃O₆ | S₄O₆ |
| Test | ml | G | mV | pH | mg/L | mg/L | mg/L | mg/L | mg/L | mg/L |
| Start | 275 | 3.18 | −188 | 9.7 | 0.31 | 0.69 | 3.12 | 15.1 | 11.1 | 0.01 |
| 20 min | — | — | −471 | 8.5 | — | — | — | — | — | — |
| 40 min | — | — | −428 | 7.9 | — | — | — | — | — | — |
| 60 min | — | — | −406 | 8.1 | — | — | — | — | — | — |
| Final | 291 | 3.18 | −406 | 8.1 | 0.055 | 0.19 | 0.80 | 27.5 | 0.08 | 0.01 |

TABLE 3
T1-T11 residue assays.

| | Elements for Assay - Percent or g/tonne | | | | |
|---|---|---|---|---|---|
| | Cu | Au | Ag | S | S(s) |
| Solids | % | g/t | g/t | % | % |
| T1 Residue | 0.17 | 0.57 | 4.0 | 18.4 | 18.2 |
| T2 Residue | 0.17 | 0.73 | 3.6 | 15.9 | 15.7 |
| T3 Residue | 0.13 | 0.35 | 2.2 | 17.9 | 17.7 |
| T4 Residue | 0.17 | 0.37 | 2.6 | 15.6 | 15.4 |
| T5 Residue | 0.16 | 0.47 | 2.8 | 17.1 | 16.9 |
| T6 Residue | 0.18 | 0.97 | 4.9 | 12.8 | 12.7 |
| T7 Residue | 0.17 | 1.05 | 4.4 | 16.6 | 16.5 |
| T8 Residue | 0.16 | 0.60 | 3.4 | 18.7 | 18.6 |
| T10 Residue | 0.18 | 0.55 | 4.30 | 14.7 | — |
| T11 Residue | 0.18 | 0.47 | 6.80 | 8.73 | — |

### Example 1.2—Continuous Leaching With a 4-Reactor Setup

Four reactors equipped with epoxy coated overhead agitators were connected in series using an inter-stage pumping system. At the start, all four reactors were filled with the leached residues from batch tests. Fresh feed slurry was mixed in a large reactor (˜2 L) and periodically (every 15 minutes) pumped into the first reactor. From the first reactor the slurry was pumped (every 15 minutes) into the second, third, fourth reactors and finally into a collector. The slurry flow rate was set (using a measuring cylinder) to ensure 2 hour residence time in each reactor (8 hours total). The collector was placed on a scale and weight monitored to calculate the actual transfer rate. Every 8 hours, the slurry transferred into the collector was filtered and replaced with the empty collector. A target temperature (75° C.) was applied using two water baths, each connected to two jacketed reactors. An additional pump was used to pump the carbonate solution into the first reactor to make 0.3 M total carbonate concentration. The caustic addition was synchronized with the pH control system. Each reactor was equipped with the pH and ORP meters. The oxygen was added in each reactor at 0.1 L/min. The solution samples were taken every 2 h during first 8 hours and then every 4 hours. The total residence time was 24 hours. At the end, the slurry in each reactor, in collector and feed were filtered, washed and shipped for analysis. The solution analysis was done at the lab housing the reactors. Table 4 provides the ORP values in each reactor. As it appears, the ORP values remain in between −40 and 12 mV (Ag/AgCl).

TABLE 4
The ORP with time in each reactor.

| | |
|---|---|
| Time | ORP (mV, Ag/AgCl) |

| h | R1 | R2 | R3 | R4 |
|---|---|---|---|---|
| 2 | −17 | −32 | −19 | −32 |
| 4 | −20 | −40 | −22 | −25 |
| 6 | −21 | −11 | −24 | −19 |
| 8 | −18 | −23 | −47 | −3 |
| 12 | −31 | 0.9 | 5.6 | 7.7 |
| 16 | −25 | −2.8 | 0.6 | 12 |
| 20 | −4.0 | −0.8 | 1.6 | 1.3 |
| 24 | — | — | — | — |

Table 5 shows the pH measured at elevated temperature and room temperature. The pH at room temperature shown as 25° C. was measured several weeks after the test was finished and some changes in solution speciation is possible reflecting on pH change.

TABLE 5
The pH with time at 75° C. and 25° C.

| | pH | | | | | | | |
|---|---|---|---|---|---|---|---|---|
| Time | 75° C. | 25° C. | 75° C. | 25° C. | 75° C. | 25° C. | 75° C. | 25° C. |
| h | R1 | | R2 | | R3 | | R4 | |
| 2 | 9.24 | 8.95 | 9.10 | — | 9.10 | 8.90 | 9.11 | 8.04 |
| 4 | 9.26 | — | 9.10 | — | 9.11 | — | 8.80 | — |
| 6 | 9.12 | 9.01 | 9.11 | 9.2 | 9.14 | 8.25 | 9.15 | 8.27 |
| 8 | 9.21 | 9.02 | 9.10 | 8.93 | 9.12 | 8.66 | 9.13 | 8.06 |
| 12 | 9.22 | — | 9.12 | 9.18 | 9.14 | 7.55 | 9.14 | 7.38 |
| 16 | 9.22 | 9.38 | 9.11 | 8.51 | 9.11 | 7.86 | 9.10 | 8.26 |
| 20 | 9.14 | 8.99 | 9.12 | 8.02 | 9.11 | 7.90 | 9.10 | — |
| 24 | — | 8.82 | — | 8.01 | — | 7.77 | — | 8.14 |

Table 6 and Table 7 present the thiosulphate, trithionate, gold and bicarbonate concentrations with time in each reactor. The carbonate concentrations were not available for most of solutions and therefore, it is not included in tables.

TABLE 6
Thiosulphate and trithionate concentrations with time in reactors.

| Time | S₂O₃ (g/L) | | | | S₃O₆ (g/L) | | | |
|---|---|---|---|---|---|---|---|---|
| h | R1 | R2 | R3 | R4 | R1 | R2 | R3 | R4 |
| 2 | 4.4 | 8.0 | 9.3 | 6.8 | 4.9 | 6.4 | 9.2 | 5.2 |
| 4 | 5.2 | 12.9 | 12.5 | 10.5 | 7.3 | 10.7 | 12.9 | 9.2 |
| 6 | 5.6 | 11.6 | 14.5 | 11.5 | 8.4 | 11.8 | 13.1 | 14.0 |
| 8 | 6.6 | 12.6 | 16.8 | 14.2 | 11.0 | 11.7 | 12.6 | 14.1 |
| 12 | 6.8 | 15.8 | 16.2 | 13.0 | 9.8 | 17.8 | 15.3 | 19.3 |
| 16 | 9.0 | 11.0 | 11.8 | 14.6 | 8.9 | 13.7 | 15.5 | 15.5 |
| 20 | 8.7 | 11.7 | 11.5 | 14.8 | 8.6 | 16.1 | 16.2 | 14.1 |
| 24 | 10.3 | 13.1 | 12.3 | 15.8 | 12.7 | 16.4 | 17.1 | 13.1 |

TABLE 7
The gold and bicarbonate concentrations in reactors.

| Time | Au (mg/L) | | | | HCO₃ (M) | | | |
|---|---|---|---|---|---|---|---|---|
| h | R1 | R2 | R3 | R4 | R1 | R2 | R3 | R4 |
| 2 | 0.12 | 0.09 | 0.04 | 0.08 | 0.23 | — | 0.03 | 0.03 |
| 4 | 0.16 | 0.14 | 0.08 | 0.10 | — | — | — | — |
| 6 | 0.17 | 0.24 | 0.17 | 0.11 | 0.18 | 0.20 | 0.11 | 0.03 |
| 8 | 0.20 | 0.27 | 0.21 | 0.19 | 0.19 | 0.16 | 0.13 | 0.07 |
| 12 | 0.19 | 0.27 | 0.33 | 0.26 | — | 0.19 | 0.05 | 0.06 |
| 16 | 0.22 | 0.28 | 0.34 | 0.27 | 0.23 | 0.21 | 0.13 | 0.10 |
| 20 | 0.22 | 0.30 | 0.33 | 0.30 | 0.16 | 0.15 | 0.13 | — |
| 24 | 0.26 | 0.29 | 0.34 | 0.29 | 0.25 | 0.13 | 0.10 | 0.15 |

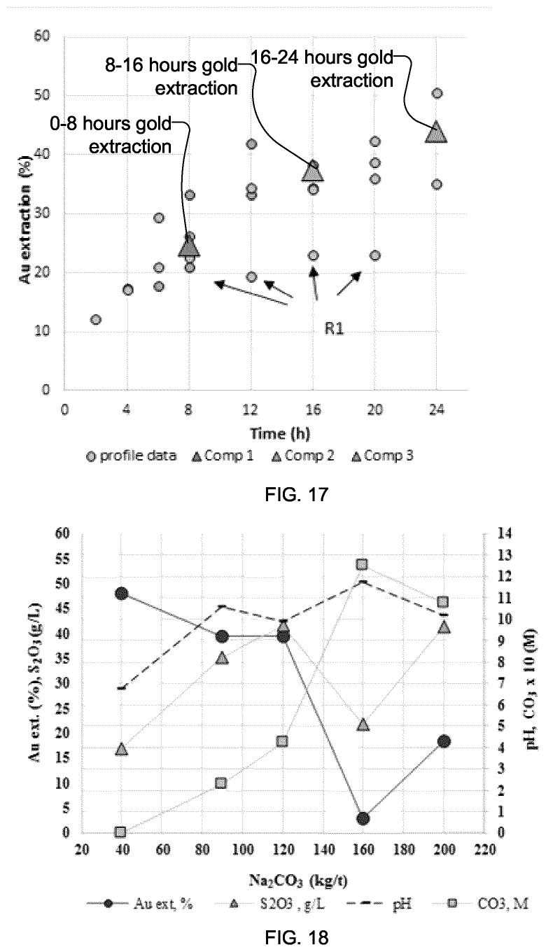

FIG. 17 shows the gold extraction profile including the composites (in collectors) from 0-8 hours, from 8-16 hours and from 16-24 hours. During the first 8 hours, the extractions are the lowest and this is because the points represent re-leach of the residues placed in reactors at the beginning of the test. The gold extraction calculated for 0-8 hours composite (labelled triangle) was 24.5%. Ideally, the extractions for other two composites should have been equal, but it was not the case here. From 8 to 16 hours (labelled triangle), the gold extraction was 37.3% and from 16-24 hours (labelled triangle) it was 43.8%.

TABLE 8
reactors-in-series head and residue assays.

| | Elements for Assay - Percent or g/tonne | | | | |
|---|---|---|---|---|---|
| | Cu | Au | Ag | S | S(s) |
| Solids | % | g/t | g/t | % | % |
| Feed 1 (comp. leached residue) | 0.17 | 0.89 | 4.1 | 16.1 | 16.0 |
| Feed 2 (fresh flotation tailing) | 0.15 | 1.34 | 5.5 | 23.6 | 23.4 |
| CON 1 Comp 1 (0-8 h) | 0.16 | 0.66 | 3.5 | 13.9 | 13.6 |
| CON 1 Comp 2 (8-16 h) | 0.16 | 0.79 | 4.6 | 14.2 | 14.0 |
| CON 1 Comp 3 (16-24 h) | 0.13 | 0.76 | 4.1 | 15.7 | 15.5 |
| Reactor 1 (24 h) | 0.17 | 0.98 | 5.3 | 20.1 | 19.9 |
| Reactor 2 (24 h) | 0.16 | 0.78 | 5.1 | 18.3 | 18.0 |
| Reactor 3 (24 h) | 0.18 | 0.58 | 4.4 | 17.5 | 17.2 |
| Reactor 4 (24 h) | 0.17 | 0.95 | 5.4 | 16.1 | 15.8 |

From Table 8, it is obvious some gold has been leached but the extraction was not as expected. Without being bound by theory, the reason might have been poor agitation using epoxy coated impellers and consequently some of the solids were not suspended properly in the reactor. The trend of lower extraction with the same setup used in reactors-in-series indicated to the same trend. Overall, the test using four reactors in series generated the thiosulphate on a continuous basis with 8 hour retention time and leached ˜45% gold with the in-situ generated thiosulphate.

### Example 1.4—Conclusions to be Drawn From Examples 1.1-1.3

Based on T1 test results, a neutral pH of 7 and corresponding high ORP>100 mV (Ag/AgCl) causes the decomposition of thiosulphate and gold precipitation. High pH>10.5 and low ORP<−80 mV (Ag/AgCl) stabilizes thiosulphate but precipitates gold as seen in T2 and T9 tests. Good control of pH around 9.3 and ORP around −20 to −30 mV (Ag/AgCl) provides a steadily increasing gold leaching and over 70% gold extraction in 9 h (T4). The thiosulphate produced from sulphides at pH 9.3 with added NaOH was between 10-16 g/L. Maintaining the pH at 8.5 (T5) with carbonates (without NaOH) generated about 4 to 5 g/L S₂O₃ and the gold leaching with time reached 58% extraction in 8 h. Gradual decrease of ORP (while accumulating large amounts of thiosulphate) in T6 resulted in gold precipitation when the ORP dropped below −40 mV. High thiosulphate concentration and the carbonate speciation in this test points to the erroneous pH monitoring in this test. The actual pH must have been above 10.5 based on carbonate speciation. Therefore, this test did not repeat the conditions used in T4. Without being bound, the loss of gold at low ORP might be attributed to the sulphides in the solids or iron component in the impeller (as a reducing metal). The stainless-steel agitator was replaced with isoprene in T7 test. Without being bound by theory, the isoprene may have promoted the thiosulphate oxidation to trithionate. The test was run at room temperature and the final gold extraction was only 17%. In the T8 test, the stainless-steel agitator was covered with epoxy. The gold extraction was lower ˜51% in comparison with 72% gold extraction in T4. It is possible that the agitation was not adequate using the epoxy covered impeller. Two stage leaching (T3 and T10-11) indicated that an additional 5% of gold can be extracted from leached residues using either fresh sodium thiosulphate or NaSH treated solution—regenerated from leach solution thiosulphate. Both tests showed ˜60% gold extraction in stage one leaching with in-situ thiosulphate and additional 5% gold extraction in the second stage leaching. The continuous 4-reactor setup using epoxy coated impellers showed the potential of extracting ˜44% gold in 8 hours and generating ˜14-16 g/L S₂O₃. The pH and ORP and thiosulphate concentration profiles were well controlled in the continuous test.

### Example 2.0—Tested Flotation Products and Methods

A flotation product (Reground P₈₀=15 μm) was used. The key elements contained in this sample were: 1.75 g/t Au, 8 g/t Ag, 0.14% Cu and 32% S²⁻. The objective of the research program was to study the gold leaching by the in-situ generated thiosulphate in carbonate buffered solutions. The direct cyanidation of this material (at 33% pulp density) achieved (in 24 hours) approximately 68% gold extraction (or ˜0.5 mg/L Au), ˜74% Ag extraction (or ˜2-3 mg/L Ag). The cyanide consumptions reported was on average 3 kg/t of concentrate. The lime consumption in cyanidation was ˜6.3 kg/t of concentrate. The copper measured in leach solution was in the range of approximately 240-440 mg/L. Relatively higher concentrations of copper in leach solution impact the cyanide consumption, and potentially the process water treatment cost.

The testing in this Example was focused on the cyanide-free gold leaching process using thiosulphate. The treatment of the same concentrate at 50% pulp density, 93° C., 0.1 L/min oxygen flowrate, 40 kg/t Na₂CO₃ and 5-30 kg/t NaOH for 10 h produced ˜20-30 g/L S₂O₃ and extracted ˜52-56% Au (˜0.8-1.1 mg/L Au) and 31-34% Ag (1.5-3.3 mg/L Ag). The extracted gold, silver and copper were precipitated with NaSH. The washed (with DI water) residues were leached with cyanide and calcium thiosulphate. The overall gold extractions were ˜61-67% when cyanide was used to re-leach the carbonated residues and ˜59% with calcium thiosulphate.

The program was designed to investigate the effect of carbonate concentration on thiosulphate generation and gold leaching. In addition, the role of caustic and the calcium hydroxide as a replacement for caustic was briefly examined. All experiments were conducted in an overhead agitated vessel. The leaching temperature was maintained using a temperature controlled mantle. During leaching, kinetic samples were taken at time intervals and analysed for gold by a solvent extraction method followed by atomic absorption (AA). The thiosalts were measured by ion chromatography (IC). The cyanide was measured by titration with silver nitrate. The carbonates were measured by acid titration method. The solids were filtered, washed, dried and shipped to external labs for assay.

### Example 2.1—The Effect of Carbonate Dosage

The first series of experiments was designed to investigate the effect of carbonate concentration on thiosulphate generation and gold leaching kinetics. For each test, the feed sample was mixed with carbonate solution at 900 rpm. The pulp was heated and the reaction time was set at zero when temperature reached 93° C. The reaction time was 8 hours. Table 9 summarizes the tests conditions and results. FIG. 18 displays the final (8 hour) solution composition and gold extractions.

TABLE 9
The effect of sodium carbonate.

| | | | | | | | | | | | | | | | Res. leach by NaCN | | | Final |
|---|---|---|---|---|---|---|---|---|---|---|---|---|---|---|---|---|---|---|
| | | Conditions | | Consumption | | | Final solution | | | | | Ext. | Res. | Head | | Au | Au | Au |
| | Solids | Na₂CO₃ | | Na₂CO₃ | | NaOH | | CO₃ | HCO₃ | S₂O₃ | Au | Au | Au | Au | Au | Ext. | Res. | Ext. |
| Test ID | % | kg/t | M | kg/t | % | kg/t | pH | M | M | g/L | mg/L | % | g/t | g/t | mg/L | % | g/t | % |
| NaTS 1 | 50 | 40 | 0.38 | 31 | 76 | 22 | 6.7 | 0.00 | 0.01 | 16.7 | 0.97 | 47.9 | 0.83 | 1.67 | 0.16 | 27.8 | 0.59 | 61.3 |
| NaTS 2 | 44 | 90 | 0.68 | 40 | 44 | 18 | 10.6 | 0.23 | 0.04 | 35.3 | 0.57 | 39.3 | 1.07 | 1.62 | 0.29 | 42.0 | 0.58 | 65.2 |
| NaTS 3 | 44 | 120 | 0.91 | 19 | 16 | 49 | 9.9 | 0.42 | 0.29 | 41.6 | 0.47 | 39.4 | 1.00 | 1.51 | 0.25 | 39.3 | 0.58 | 64.3 |
| NaTS 4 | 44 | 160 | 1.10 | 0 | 0 | 0 | 11.7 | 1.25 | 0.00 | 21.7 | 0.05 | 2.94 | 1.6 | 1.57 | 0.58 | 53.4 | 0.75 | 57.6 |
| NaTS 5 | 44 | 200 | 1.51 | 22 | 11 | 37 | 10.2 | 0.95 | 0.37 | 41.4 | 0.25 | 18.2 | 1.42 | 1.59 | 0.51 | 55.7 | 0.59 | 64.8 |

From FIG. 18, the highest gold extraction ˜48% was achieved at the lowest carbonate dosage 40 g/kg and the lowest gold extraction ˜3% at one of the highest 160 kg/t Na₂CO₃ dosage. When the total 200 kg /t carbonate dosage (NaTS 5) was added (five equal increments) over initial five hours, the gold extraction improved from 3% (at 160 kg/t CO₃) to ˜18%. Two other tests with medium carbonate dosages (90 and 120 kg/t Na₂CO₃) achieved gold extractions ˜39%.

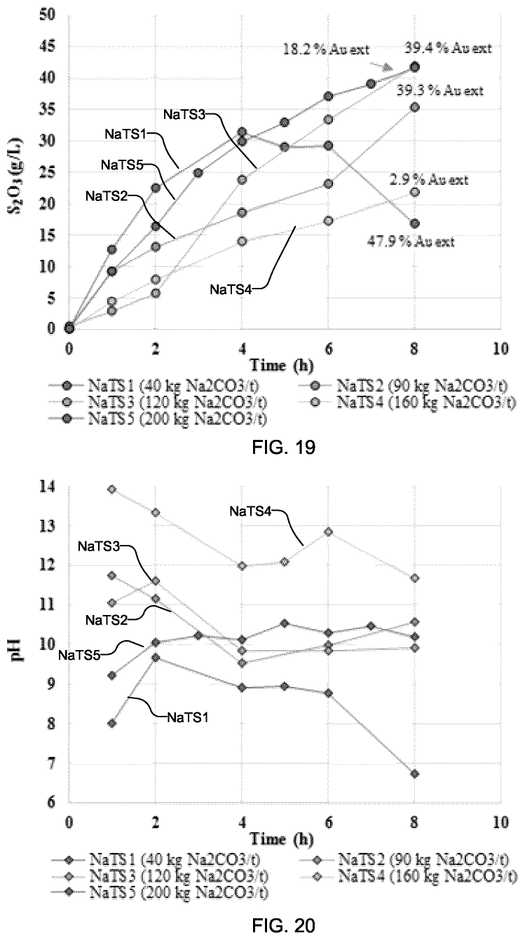

In all five tests, the build-up of thiosulphate with time continued to the end of residence time except of NaTS 1 test (FIG. 19). In NaTS 1 test, the thiosulphate concentration achieved its maximum ˜30 g/L S₂O₃ after 4 hours and at pH˜9. Approximately half of the S₂O₃ decomposed when pH dropped to 7 after 8 hours. This test used the lowest carbonate dosage˜40 kg/t which was consumed almost entirely because at the end of test the carbonates concentrations were below detection<0.01 M.

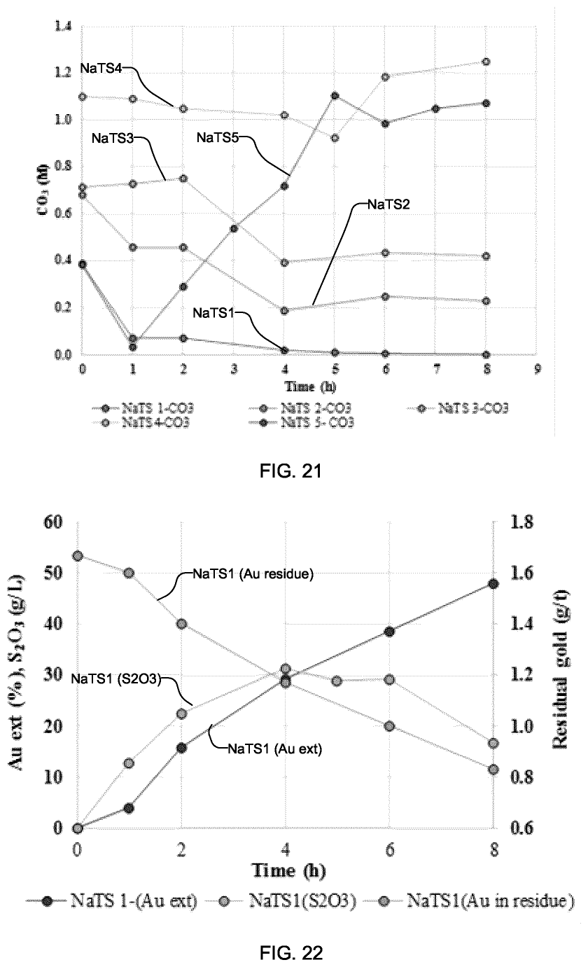

FIG. 20 shows the changes in pH with time. The least amount of thiosulphate was generated at the highest pH (strong solution of carbonate>1M CO₃) in NaTS 4. Hence, high dosage of carbonates impedes the thiosulphate generation and the gold extraction. In NaTS 1, about 80% of the added 40 kg/t carbonates was consumed (FIG. 21) within two hours and almost none remained towards the end of the test which caused the drop in pH and decomposition of thiosulphate but the gold extraction (˜48%) was the highest among other four tests. In NaTS 5, the carbonate dosage of 40 kg/t was added incrementally within 5 hours providing relatively stable pH˜10, carbonate concentration˜1M at 5 hours and the constant accumulation of thiosulphate but the extracted gold was low ˜18%.

The kinetic solids were assayed for gold for NaTS 1 test plotted in FIG. 22 along with calculated gold extractions and the thiosulphate profile. The gold grade from initial 1.67 g/t Au decreased almost linearly to 0.83 g/t Au within 8 hours. The generation of in-situ thiosulphate stopped at 4 h and started to disappear but it was still sufficient to sustain the gold leaching reaction. In fact, the leached gold was stable in this solution (assayed on May 28 was 0.97 mg/L and re-assayed value on July 12 was 0.99 mg/L Au) over 45 days standing in a fridge (8° C.).

The residues of all five NaTS tests were re-leached with cyanide. The results are shown in Table 10. The remaining free gold was recovered by cyanide and the overall gold extraction was increased to 58-65%. The hot carbonate treatment produced thiosulphate from sulphides corresponding to ˜3-7% (Table 11) oxidation of these sulphides. Table 11 shows the solution composition in terms of carbonates, thiosalts and the gold.

TABLE 10
The residue assays NaTS 1-5 tests.

| | Cu | Au | Ag | S²⁻ | S(total) |
|---|---|---|---|---|---|
| Test ID | % | g/t | g/t | % | % |
| Feed | 0.140 | 1.75 | 8 | 32.0 | |
| NaTS1-Residue | 0.130 | 0.83 | 5.6 | 24.8 | 28.8 |
| CN1-Residue | 0.043 | 0.59 | 2.9 | | |
| NaTS2-Residue | 0.118 | 1.07 | 4.4 | 26.2 | 27.4 |
| CN2-Residue | 0.049 | 0.58 | 2.9 | | |
| NaTS3-Residue | 0.117 | 1.00 | 4.4 | 25.6 | 26.1 |
| CN3-Residue | 0.043 | 0.58 | 2.1 | | |
| NaTS4-Residue | 0.132 | 1.66 | 6.2 | 28.5 | 28.9 |
| CN4-Residue | 0.043 | 0.75 | 2.4 | | |
| NaTS5-Residue | 0.126 | 1.42 | 5.5 | 26.6 | 27.0 |
| CN5-Residue | 0.043 | 0.59 | 3.1 | | |

TABLE 11
The final solutions composition for NaTS 1-5 tests.

| | Final solution | | | | | | |
|---|---|---|---|---|---|---|---|
| | | CO₃ | HCO₃ | S₂O₃ | S₃O₆ | S₄O₆ | Au |
| Test ID | pH | M | M | g/L | g/L | g/L | mg/L |
| NaTS 1 | 6.7 | 0.00 | 0.01 | 16.7 | 12.7 | 4.54 | 0.97 |
| NaTS 2 | 10.6 | 0.23 | 0.04 | 35.3 | 1.64 | 0.00 | 0.57 |
| NaTS 3 | 9.9 | 0.42 | 0.29 | 41.6 | 3.71 | 0.00 | 0.47 |
| NaTS 4 | 11.7 | 1.25 | 0.00 | 21.7 | 0.31 | 0.87 | 0.05 |
| NaTS 5 | 10.2 | 0.95 | 0.37 | 41.4 | 1.39 | 0.02 | 0.25 |

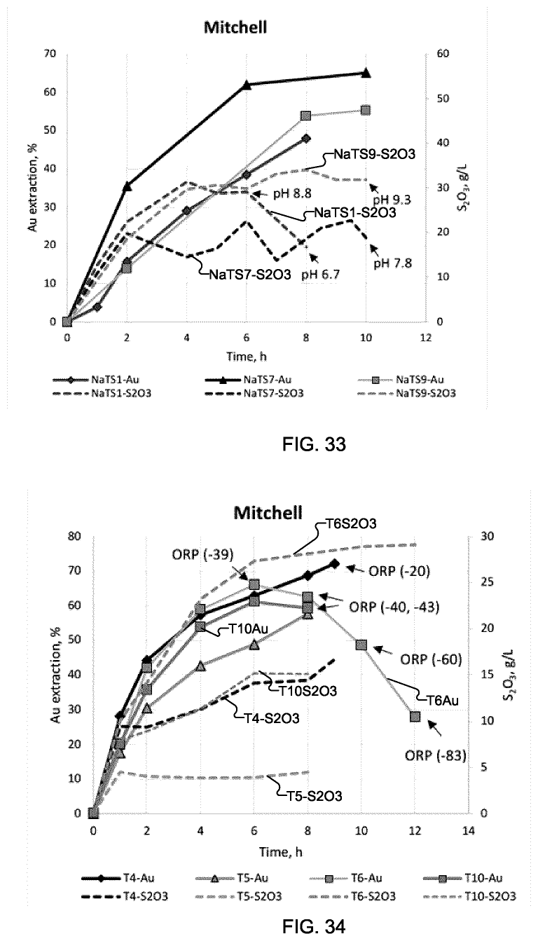

Table 12 combines results of three tests run at 40 kg/t carbonate dosage. The carbonate consumptions were similar 29-31 kg/t in NaTS 1 and NaTS 7 tests but in NaTS 9, it was much lower ˜5 kg/t because the pH was better controlled by the addition of NaOH. The consumption of NaOH was in the range of 22-44 kg/t. The gold extractions and thiosulphate profiles are shown in FIG. 33.

TABLE 12
the gold leaching at 40 kg/t carbonate dosage.

| | Pulp | | | | Conditions | | Consumption | | | Final solution | |
|---|---|---|---|---|---|---|---|---|---|---|---|
| | density | T | | Time | Na₂CO₃ | | Na₂CO₃ | | NaOH | | CO₃ |
| Test ID | % | ° C. | pH | h | kg/t | M | kg/t | % | kg/t | pH | M |
| NaTS 1 | 50 | 93 | 11.0 | 8 | 40 | 0.38 | 31 | 76 | 22 | 6.7 | 0.00 |
| NaTS 7 | 50 | | | 10 | 40 | 0.38 | 29 | 71 | 43 | 7.9 | 0.00 |
| NaTS 9 | 50 | | | 10 | 40 | 0.37 | 5 | 12 | 44 | 9.3 | 0.01* |

| | | | | | | | Res. leach by NaCN or TS | | | Final |
|---|---|---|---|---|---|---|---|---|---|---|
| | Final solution | | | Ext. | Res. | Head | | Au | Au | Au |
| | HCO₃ | S₂O₃ | Au | Au | Au | Au | Au | Ext | Res | Ext |
| Test ID | M | g/L | mg/L | % | g/t | g/t | mg/L | % | g/t | % |
| NaTS 1 | 0.01 | 16.7 | 0.97 | 47.9 | 0.83 | 1.67 | 0.16 | 27.8 | 0.59 | 61.3 |
| NaTS 7 | 0.01 | 18.8 | 1.07 | 56.0 | 0.65 | 1.48 | 0.12 | 24.9 | 0.52 | 67.3 |
| NaTS 9 | 0.32* | 31.8 | 0.82 | 51.7 | 0.74 | 1.53 | 0.13 | 25.1 | 0.50 | 62.6 |
| | | | | | | | <0.05 | 17.5 | 0.53 | 59.1 |

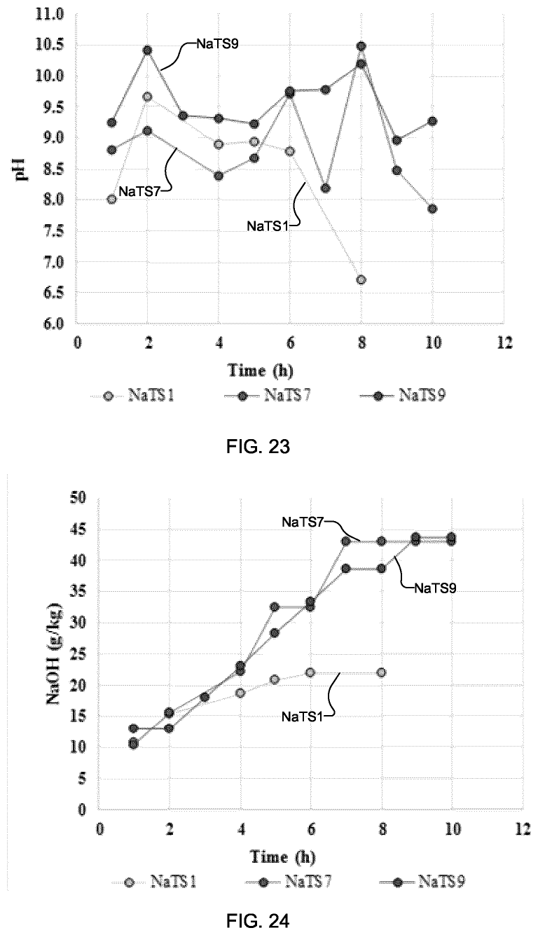

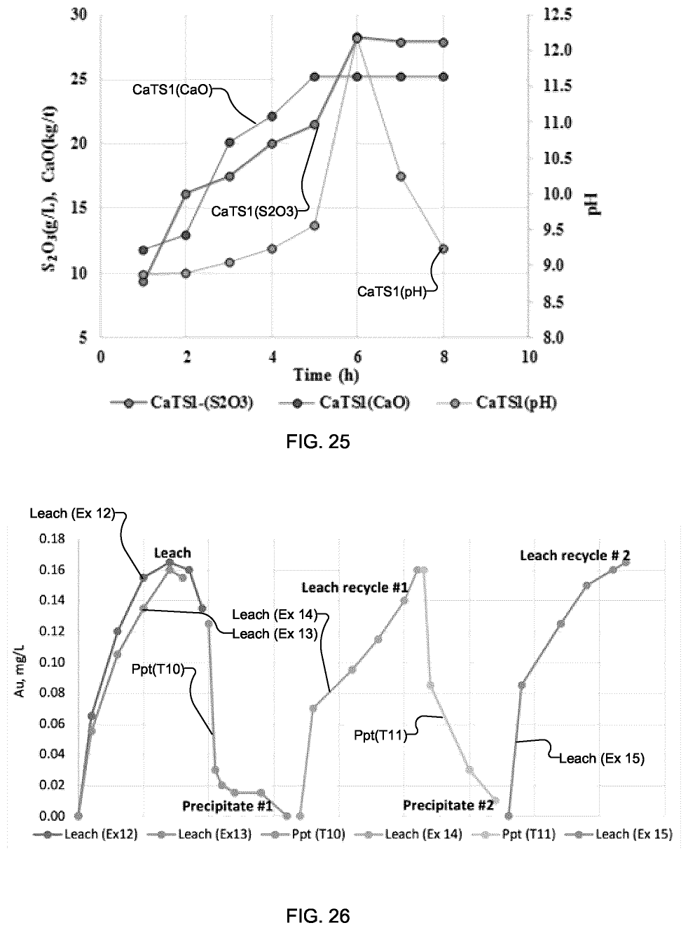

In NaTS 1 test, the gold extraction is almost linear during 8 hours despite the variation in thiosulphate concentrations (FIG. 33) and the pHs (FIG. 23). The thiosulphate concentration was strongly influenced by the pH. Initially, the thiosulphate was accumulating at pH>8 but started to decompose slowly from 4 hours to 6 hours and sharply towards the end of the test after pH dropped below 7. The NaOH addition was matched with the bicarbonate formation (at 1:1 molar ratio) to regenerate the carbonate consumed by the acidity but it did not help because the bicarbonates were impacted as well; without being bound by theory this was possibly due to the elevated temperature.

NaTS 7 test conditions were similar except the caustic addition was matched with the bicarbonate initially up to 2 hours but afterwards it was added randomly and at higher dosages compared to NaTS 1 to keep alkaline medium. The thiosulphate concentration did not increase, and after 2 hours varied between 15-22 g/L S₂O₃. The gold extraction was fast; ˜40% at 2 hours and increased to 56% at 10 hours.

NaTS 9 test used the same initial dosage of NaOH (1 hour) and afterwards it was added at rate˜4 g NaOH per kg of feed per hour (FIG. 24). The pH in this test did not drop below 9 and the thiosulphate concentration reached ˜30 g/L at 4 hours remained relatively stable. Similarly, the gold extraction reached maximum at 4 hours and remained almost the same for the rest of test.

The re-leach of residues with cyanide improved gold extraction and is given in Table 13. The total leached gold was varied between 61-67%. In addition, a portion of NaTS 9 residue was leached with calcium thiosulphate (given in the same table) with overall gold extraction equal to 59.1%.

TABLE 13
The final solutions composition for NaTS 1, 7, 9 tests.

| | Final solution | | | | | | |
|---|---|---|---|---|---|---|---|
| | | CO₃ | HCO₃ | S₂O₃ | S₃O₆ | S₄O₆ | Au |
| Test ID | pH | M | M | g/L | g/L | g/L | mg/L |
| NaTS 1 | 6.7 | 0.00 | 0.01 | 16.7 | 12.7 | 4.54 | 0.97 |
| NaTS 7 | 7.9 | 0.00 | 0.01 | 18.8 | 4.78 | 0.84 | 1.07 |
| NaTS 9 | 9.3 | 0.01 | 0.32 | 31.8 | 1.48 | 0.11 | 0.82 |

### Example 2.2—Lime as a Replacement for Caustic

A single test was run with lime and carbonates. This test (CaTS1) results are compared with the NaTS 1 in Table 14.

TABLE 14
The lime versus caustic comparison.

| | Pulp | | Conditions | | Consumption | | | Final solution | |
|---|---|---|---|---|---|---|---|---|---|
| Test | density | Time | Na₂CO₃ | | Na₂CO₃ | NaOH | CaO | | CO₃ |
| ID | % | h | k g/t | M | k g/t | k g/t | k g/t | pH | M |
| NaTS 1 | 50 | 8 | 40 | 0.38 | 31 | 22 | — | 6.7 | 0.00 |
| CaTS1 | 50 | 8 | 40 | 0.38 | 61 | — | 25 | 10.2 | 0.00 |

| | | | | | | | es. leach by NaCN or T | | | Final |
|---|---|---|---|---|---|---|---|---|---|---|
| | Final solution | | | Ext. | Res. | Head | | Au | Au | Au |
| Test | HCO₃ | S₂O₃ | Au | Au | Au | Au | Au | Ext | Res | Ext |
| ID | M | g/L | mg/L | % | g/t | g/t | mg/L | % | g/t | % |
| NaTS 1 | 0.01 | 16.7 | 0.97 | 47.9 | 0.83 | 1.67 | 0.16 | 27.8 | 0.59 | 61.3 |
| CaTS1 | 0.01 | 27.9 | 1.20 | 40.3 | 0.82 | 1.41 | — | — | — | — |

The CaTS1 test shows that the lime can be used to keep the pH alkaline but over 90% of the volume of solution was retained by the pulp (possibly by gypsum) and the weight of solids (dried for 48 hours at 60° C.) increased by 2.5% compared to the initial weight. Otherwise, the CaTS 1 test results in terms of gold extraction are close to NaTS.

### Example 2.3—Gold Recovery by NaSH

Various NaTS leach solution samples were kept in fridge at 8° C. The solution samples were re-assayed and results are presented in Table 15. Table 16 shows the calculated (based on volumes and corresponding assays) and assay values for this composite sample. The good match between calculated and measured also confirms the stable nature of gold thiosulphate in this leach solution.

TABLE 15
Leached gold stability.

| Original Assays | | | | | Aged solution | |
|---|---|---|---|---|---|---|
| Test ID | | Date | Volume(mL) | Au (mg/L) | Date | Au (mg/L) |
| NaTS | 1 | 28-May | 47.17 | 0.97 | 12 Jul. 2018 | 0.99 |
| NaTS | 2 | 17-May | 217.0 | 0.57 | 12 Jul. 2018 | 0.57 |
| NaTS | 3 | 13-May | 304.1 | 0.47 | | |
| NaTS | 5 | 30-May | 142.0 | 0.25 | | |
| NaTS | 7 | 20-Jun | 79.42 | 1.07 | 12 Jul. 2018 | 1.13 |

TABLE 16
The total calculated and assayed values - the composite sample.

Composite

| | | |
|---|---|---|
| Test ID | Volume(mL) | Au (mg/L) |

| | NaTS | 1 | | |
|---|---|---|---|---|
| | NaTS | 2 | 186.99 | 0.57 |
| | NaTS | 3 | 304.06 | 0.47 |
| | NaTS | 5 | 141.98 | 0.25 |
| | NaTS | 7 | 49.42 | 1.07 |
| Total (calculated) | | | 682.5 | 0.49 |
| | Assayed | 12 Jul. 2018 | 682.5 | 0.47 |

The precipitation tests were conducted on two different samples: the composite sample and the NaTS 9 leach solution. The summary is given in Table 17.

TABLE 17
The NaSH precipitation tests summary.

| | Conditions | | | Assays | | | | | |
|---|---|---|---|---|---|---|---|---|---|
| | Volume | | NaSH | Au | Ag | Cu | S₂O₃ | S₃O₆ | S₄O₆ |
| Test ID | L | pH | g/L | mg/L | mg/L | mg/L | mg/L | mg/L | mg/L |

NaTS comp

| | | | | | | | | | |
|---|---|---|---|---|---|---|---|---|---|
| Initial | 500 | 8.88 | 0.72 | 0.47 | — | — | 37452 | 1652 | 48 |
| Initial (adjusted) | 653 | | | 0.36 | | | 28696 | 1266 | 37 |
| Final | 653 | 8.61 | | 0.00 | — | — | 31696 | 768 | 8 |

NaSH9

| | | | | | | | | | |
|---|---|---|---|---|---|---|---|---|---|
| Initial | 176 | 9.34 | 0.62 | 0.82 | 1.47 | 146 | 31772 | 1480 | 112 |
| Final | 180 | 8.3 | | <0.05 | <0.025 | 0.25 | 32936 | 1108 | 112 |

From Table 17, the gold and silver were completely precipitated by sulphides. The copper removal was over 99%. The NaSH dosage was based on initial trithionate and tetrathionate concentrations (moles NaSH added=moles of S₃O₆+moles of S₄O₆). The anticipation was that the NaSH will react with those two species converting to thiosulphate. Although there seems to be a trend of higher thiosulphate in NaSH in treated solutions for both tests (NaTS composite initial adjusted considers the changes in concentrations due to a dilution caused by the acid addition not shown in the table) but the effect was insignificant.

### Example 2.4—Thiosalts Stability, Oxygen Consumption, Total Alkalinity

Some stored solutions were re-assayed for thiosulphate, trithionate, tetrathionate, sulphates and data presented in Table 18. The composition of these solutions were similar.

TABLE 18
The aged solution re-assayed for thiosalts and sulphate.

| | Original assays | | | | Re- assay values (Oct 17) | | | |
|---|---|---|---|---|---|---|---|---|
| | S₂O₃ | S₃O₆ | S₄O₆ | SO₄ | S₂O₃ | S₃O₆ | S₄O₆ | SO₄ |
| Test ID | g/L | g/L | g/L | g/L | g/L | g/L | g/L | g/L |
| NaTS 4 (May 25) | 21.7 | 0.31 | 0.87 | — | 21.1 | 0.81 | 0.07 | 19.8 |
| NaTS 6 (June 14) | 35.9 | 1.93 | 0.06 | — | 35.1 | 0.82 | 0.06 | 13.6 |
| NaTS 9 (Aug 2) | 31.8 | 1.48 | 0.11 | — | — | — | — | — |
| NaSH 9 (Aug 2) | 32.9 | 1.11 | 0.11 | — | 32.6 | 0.48 | 0.16 | 115 |

Assuming the oxidation reactions of pyrite are:

4FeS₂+9O₂+10OH⁻→4FeOOH+3S₂O₃²⁻+2SO₄²⁻+3H₂O (6)

FeS₂+3.5O₂+H₂O→Fe²⁺+2H⁺+2SO₄²⁻ (7)

According to the stoichiometry from these reactions, the oxygen consumption and % S²⁻ were calculated from thiosulphate and sulphate. The oxidation values were also calculated from the feed and residue sulphide assays and compared with the values based on solution Sulphur species and shown in Table 19.

TABLE 19
Sulphide oxidation estimated based on solution Sulphur
species and solids assays and oxygen consumption.

| | Reagents | | | Solution composition | | | | | | |
|---|---|---|---|---|---|---|---|---|---|---|
| | CO₃ | NaOH | OH(total) | CO₃ | HCO₃ | Vol | S₂O₃ | S₃O₆ | S₄O₆ | SO₄ |
| Test ID | mol | mol | mol | mol | mol | L | mol | mol | mol | mol |
| NaTS 4 | 1.10 | 0.00 | 1.10 | 0.66 | 0.00 | 529 | 0.10 | 0.00 | 0.00 | 0.11 |
| NaTS 6 | 0.40 | 0.63 | 1.04 | 0.17 | 0.09 | 783 | 0.25 | 0.00 | 0.00 | 0.11 |
| NaTS 1 | 0.38 | 0.20 | 0.59 | 0.00 | 0.01 | 381 | 0.06 | 0.01 | 0.00 | 0.07 |
| NaTS 7 | 0.38 | 0.42 | 0.80 | 0.00 | 0.01 | 420 | 0.07 | 0.01 | 0.00 | 0.05 |
| NaTS 9 | 0.37 | 0.42 | 0.80 | 0.00 | 0.13 | 409 | 0.12 | 0.00 | 0.00 | 0.49 |

| | O₂ | mol S²⁻ | | Feed | | | Residues | | |
|---|---|---|---|---|---|---|---|---|---|
| | cons. | oxid. | % S²⁻ | | S²⁻ | | S²⁻ | | % S²⁻ |
| Test ID | mol | calc. | oxidation | g | % | mol | % | mol | oxidation |
| NaTS 4 | 0.30 | 0.31 | 7.7 | 400 | 32 | 4.0 | 28.5 | 3.6 | 11 |
| NaTS 6 | 0.74 | 0.65 | 16 | | | | — | — | — |
| NaTS 1 | 0.22 | 0.18 | 4.5 | | | | 24.8 | 3.1 | 23 |
| NaTS 7 | 0.21 | 0.19 | 4.7 | | | | 27.5 | 3.4 | 14 |
| NaTS 9 | 1.07 | 0.73 | 18 | | | | 27.7 | 3.5 | 13 |

Based on S₂O₃ conversion
Based on NaSH solution assays
Oxygen consumption by R1&2 stoich.

In carbonate medium, reactions produce insoluble iron carbonate and if precipitated on a surface of particle, it could impede the sulphide oxidation reaction and subsequently the generation of thiosulphate.

Fe²⁺+HCO₃^{-→}FeCO₃+H⁺ (8)

2FeS₂+5O₂+H₂O+2HCO₃⁻→2FeCO₃+S₂O₃²⁻+2SO₄²⁻+4H⁺ (9)

2FeS₂+5O₂+H₂O+4CO₃²⁻→2FeCO₃+S₂O₃²⁻+2SO₄²⁻+2HCO₃⁻ (10)

### Example 2.5—Conclusions to be Drawn From Examples 2.1-2.5

The following conclusion can be drawn from this work:
The thiosulphate generation and the gold leaching were sensitive to the carbonate dosage.
The leached gold and thiosulphate showed superior stability in carbonate solution kept at 8° C. for several months.
Lime can be used to maintain the alkaline pH during hot carbonate treatment but the leach solution volume was lost into the pulp when comparing the volumes with caustic tests.
The leached gold, silver and copper were successfully precipitated using NaSH at natural leach pH.

### Example 3.0 Further Analysis of Thiosulphate Leach Conditions and Recovery of Metal Values

Mixture of Mitchell and Kerr deposits. The sample contained—1 g/t Au and 20% S. According to a third party lab report, the sample contained—63% of cyanide soluble gold. The calcium and ammonium thiosulphate leaching tests extracted—72-76% of the gold in 8 h. However, the thiosulphate (0.2M) that was added in leaching was almost completely consumed (95%) in ammonium thiosulphate and more than half (60%) in calcium thiosulphate test. Some of the leached gold was observed to reprecipitate when thiosulphate concentration decreased below<1 g/L S₂O₃. The precipitated gold was re-leached with addition of fresh thiosulphate. These tests used elevated temperature (50° C.), oxygen bubbling and pH—9-10. To test the feasibility of thiosulphate production from sulphides contained in the feed flotation product sample, a test was run at 30 psig oxygen overpressure, 80° C. and pH maintained with dropwise addition of NaOH. Unfortunately, the NaOH addition rate was higher than the acid production from sulphides resulting the pH>11. Owing to such high pH, the gold leaching was poor, approx. 23.5% despite high levels of thiosulphate (approx. 0.23M S₂O₃ generated during 10 h). This test demonstrated that thiosulphate can be produced at the rate of approx. 3 g/L/h from this sample under the applied testing conditions.

Flotation by-product representing Mitchell deposit. This sample was relatively high grade, 1.6 g/t Au and 32% S. The cyanide soluble gold was 50.7% (from external lab reports). The 0.2M calcium thiosulphate (CaTS6) test achieved a better result of 52.7% gold extraction at 20% pulp density with extended (3.5 h) lime pre-conditioning prior to leaching. There is no data about thiosulphate decomposition during leaching for this test, but it was seen that lime pre-conditioning with added oxygen produced 1.5 g/L S₂O₃. Higher pulp density of 33% and short pre-conditioning (1 h) extracted less gold—approx. 42-43% (CaTS1 and NaTS1).

The in-situ thiosulphate tests (Cond 5 and Cond 6) were done at atmospheric pressure with added oxygen at 0.1 L/min and 95° C. A dry sample of 400 g was mixed with 20 g of sodium carbonate and a slurry prepared with addition of 500 ml water. This corresponded to 44.4% solids and 50 g Na₂CO₃ per kg of feed. The pH was adjusted to 11 with 2 g of NaOH (4.7 g/kg feed). After 1 h, pH dropped to 8-9 and further addition of carbonate was necessary to keep the pH in this range. The test duration was 5-6 h and total dosage of sodium carbonate used was 82.5-87.5 g/kg of feed. Due to difference of carbonate addition rate, two tests produced different thiosulphate concentration profiles but despite this difference, the gold extractions were similar ˜47.4 and 49.5%. These tests produced 7 to 13 g/L S₂O₃ which at the end of the test decreased to 1.3 g/L in one test and 5 g/L in another test without affecting the leached gold stability. From these tests, it was demonstrated that thiosulphate can be produced in-situ at atmospheric conditions and leach gold to similar levels as seen with cyanide (third party report).

More in-situ thiosulphate leaching tests were performed on a different flotation by-product also representing Mitchell deposit. This sample contained 1.75 g/t Au and 32% S and 68.1% cyanide soluble gold (ALS report). A series of tests were conducted at initial carbonate dosages of 40 (NaTS1), 90, 120, 160 and 200 kg/t. The best gold extraction of 47.9% was seen with the lowest carbonate dosage. However, it has to be noted that only this test (NaTS1) was run at ˜pH 9. Other higher carbonate tests were run at higher pH>9. Overall, these tests proved that the thiosulphate as high as 30 g/L S₂O₃ can be generated at pH 9 but maintaining this pH during leach was the problem.

The 40 kg/t carbonate test (NaTS1) was repeated twice, employing slightly different NaOH addition regime, and extended reaction time from 8 h to 10 h. The (NaTS9) test showed 55.3% gold extraction (residual gold in solids 0.74 g/t) and another test the NaTS7 resulted ˜65% gold extraction (0.65 g/t Au in residue). The results were not replicated closely, hence, the reproducibility remains challenging in these tests and it was determined that careful control of reaction parameters is important to achieve reproducibility.

A different flotation by-product still based on Mitchell deposit contained 1.34 g/t Au and 23.4% S. The cyanide soluble gold from this sample was 71.5% (third party report). From a number of in-situ thiosulphate tests, only one test (T4) achieved the gold extraction 72.1% compatible with cyanide. Three tests (T4-Au, T6-Au, T10-Au) run under similar conditions showed close initial gold leaching kinetics but resulted different final outcomes. ˜0.5 unit difference in pH, stabilised and accumulated thiosulphate resulting progressively negative ORP (T6-Au) and consequently the loss of leached gold. Again, the reproducibility was poor due to apparent deviations in test conditions.

Flotation by-product representing Iron Cap deposit. This sample was a low-grade flotation by-product containing gold (0.82 g/t Au) and sulphide (11.2% S). The gold leached by cyanide from this sample was 36.3% (third party report). The gold leaching with added thiosulphate (IC-Ex 4 and IC-Ex 6) at 50° C. achieved 19-22% gold extraction during 12 h of leaching. The in-situ thiosulphate leaching tests run at various temperatures indicated that the highest 91° C. produced more thiosulphate and leached more gold compared to lower temperature tests. At 91° C., with in-situ thiosulphate 36-37% gold was leached in 6 hours and this result was comparable with the cyanide leach.

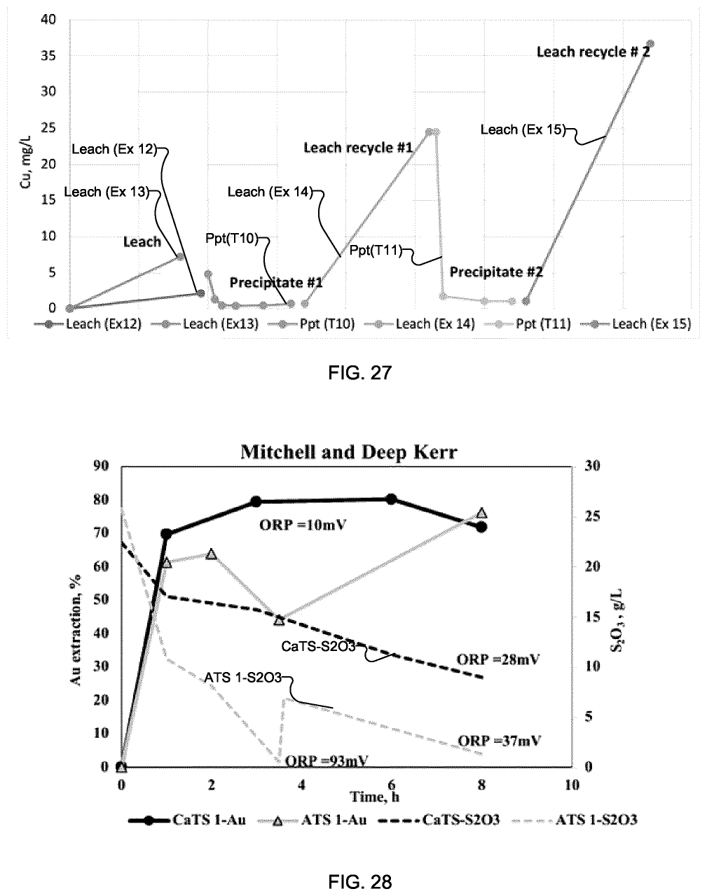

The reproducibility of leach performance was much better for this low sulphide flotation by-product. Data for four tests (IC-Ex7, 8 12, 13) and shows that the kinetics of gold leaching are close. Also, in this Example the use of a copper-gold flotation concentrate (produced from the same Iron Cap deposit) was used to precipitate the gold and copper from leach solution. Mixing this concentrate (10 g of concentrate/L) with thiosulphate leach solution with argon sparging to limit air ingress, removed both gold and copper. The concentration of thiosulphate increased slightly during the precipitation. Some increase in pH was also noted. Initially, precipitation tests were run on synthetic thiosulphate solutions with and without gold thiosulphate. The experiment with free thiosulphate solution (T3, no data shown in tables) resulted in zero gold dissolution from concentrate at argon sparging (removing oxygen). The experiment with gold thiosulphate (T7) showed that the gold slowly disappeared from solution. Several tests (T8, 9, 10, 11) run on leach solution confirmed the same effect of concentrate on leached metals stability. FIG. 26 shows the changed in gold concentration during precipitation and recycling in another leach. FIG. 27 shows the copper leach and precipitation during recycling.

### Example 3.1—Gold Leaching With Added Thiosulphate

Three different flotation by-products were leached with thiosulphate. The mixture of Mitchell & Deep Kerr sample and the Iron Cap sample were relatively lower grade gold<1 g/t and silver˜3-4 g/t. However, Mitchell & Kerr contained more copper (0.22% Cu) and sulphides (20% S) compared to the Iron Cap. The sample representing Mitchell deposit was higher grade with respect to gold, silver and sulphides (˜1.6 g/t Au, 18 g/t Au and 32% S) but contained less copper compared to the Mixture of Mitchell & Deep Kerr sample.

For Mitchell and Deep Kerr, the ammonium thiosulphate (ATS 1) and calcium (CaTS1) leach conditions were: 0.2M initial S₂O₃, 50° C., 50 mg/L Cu (added as CuSO₄), oxygen bubbling. In addition, ammonia (0.2M NH₃) was added in ATS1 test. The gold leaching kinetics and thiosulphate degradation profiles are presented in FIG. 28. Both tests show rapid leaching, over 60% of gold was dissolved in 2 h. The gold extraction in CaTS 1 peaked at 80% after 3 hours of leaching and was holding for another three hours but subsequently decreased to 72% by the end of the test. The thiosulphate was gradually decomposing. Much faster decomposition of thiosulphate was evident in ATS 1. The thiosulphate concentration decreased from initial 22.4 g/L to <1 g/L at 3.5 h and at the same time almost 20% of dissolved gold was lost from solution as shown in FIG. 28. The addition of fresh thiosulphate (0.03M) at ˜4 h, redissolved the precipitated gold achieving 67% final gold extraction.

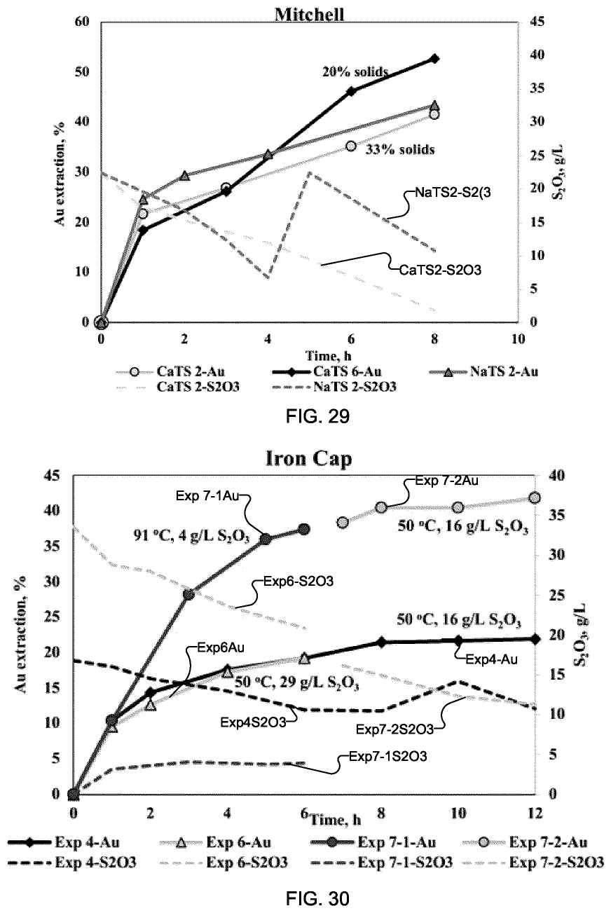

For the Mitchell deposit, kinetics of gold leaching in CaTS 2, CaTS6 and NaTS2 tests are presented in FIG. 29. Standard leaching conditions similar to the ATS1 and CaTS1 tests mentioned above were used. The final gold extraction was in the range of ˜40-50%. The thiosulphate decomposed during leaching. The initial 22.4 g/L thiosulphate decomposed to ˜2 g/L S₂O₃ after 8 h (CaTS 2 in FIG. 29). The thiosulphate decomposition was faster in ammonium thiosulphate and it was necessary to add more thiosulphate at 4 h to keep gold in solution. The best ˜52% gold extraction in CaTS6 with lower pulp density˜20% and extended conditioning (3.5 h) while other two tests (CaTS2, NaTS2) showed ˜42-43% gold extraction at 33% pulp density and 1 h pre-conditioning.

For the Iron Cap deposit, leaching of gold from Iron Cap sample at 50° C. with two different initial sodium thiosulphate concentrations (0.15M in Exp 4 and 0.30M in Exp 6) were almost identical, ˜20% gold extractions achieved in both tests. Much lower rate of thiosulphate decomposition was evident in these tests. FIG. 30 shows the gold leaching with added thiosulphate (Exp 4, Exp 6, Exp 7-2) and the kinetics of gold leaching with in-situ thiosulphate (Ex 7-1). The in-situ generated ˜4 g/L thiosulphate at 91° C. during 8 h extracted ˜37% gold. Longer leaching (additional 6 h) with added 0.15M thiosulphate improved the gold extraction by ˜4.4%. This test show that the hot leaching at 91° C. with low thiosulphate extracted twice the amount of gold compared to other tests at 50° C. and higher thiosulphate concentrations. The conditions and results for thiosulphate leach tests are summarised in Table 20.

TABLE 20
Summary of gold leaching with added thiosulphate.

| | Conditions | | | | | | | | | Extraction by S₂O₃ | | |
|---|---|---|---|---|---|---|---|---|---|---|---|---|
| Test | Solids | Time | T | | O₂ | CaO | Na₂CO₃ | NaOH | S₂O₃ cons. | Au | Ag | Cu |
| ID | % | h | ° C. | pH | L/min | kg/t | kg/t | kg/t | kg/t | % | % | % |

Mitchell and Deep Kerr - 0.96 g/t Au, 3.4 g/t Ag, 0.22% Cu, 20% S²⁻ (NaCN soluble 62.8% Au)

| | | | | | | | | | | | | |
|---|---|---|---|---|---|---|---|---|---|---|---|---|
| ATS 1 | 30 | 8 | 50 | ~9-10 | <0.01 | 7.76 | — | — | 60 | 76.2 | 67.4 | 34.1 |
| CATS 1 | 30 | 8 | 50 | ~9-10 | <0.01 | 12.5 | — | — | 32 | 71.8 | 68.6 | 13.0 |

Mitchell - 1.59 g/t Au, 18 g/t Ag, 0.15% Cu, 31.8% S²⁻ (NaCN soluble 50.7% Au)

| | | | | | | | | | | | | |
|---|---|---|---|---|---|---|---|---|---|---|---|---|
| CaTS 2 | 33 | 8 | 50 | 9.2 | <0.01 | 10.7 | — | — | 41 | 41.5 | 77.8 | — |
| CaTS 6 | 20 | 8 | 50 | 10.0 | <0.01 | 46.8 | — | — | 90 | 52.7 | 83.3 | — |
| NaTS 2 | 26 | 8 | 50 | 9.0 | <0.01 | — | 7.7 | 15.9 | 97 | 43.4 | 72.2 | — |

Iron Cap - 0.82 g/t Au, 4.0 g/t Ag, 0.07% Cu, 11.2% S²⁻ (NaCN soluble 36.3% Au)

| | | | | | | | | | | | | |
|---|---|---|---|---|---|---|---|---|---|---|---|---|
| IC-Ex 4 | 34 | 12 | 50 | 9.5 | 0.05 | — | 10 | 112 | 29 | 22.0 | — | 12.3 |
| IC-Ex 6 | 34 | 6 | 50 | 9.5 | 0.05 | — | 10 | — | 28 | 19.3 | — | 17.3 |
| IC-Ex 7-1 | 34 | 6 | 91 | 9.0 | 1.00 | — | 41 | 41 | — | 37.4 | — | 1.6 |
| IC-Ex 7-2 | 34 | 6 | 50 | 9.2 | 0.05 | — | — | — | 4.5 | 41.8 | 50.0 | 15.6 |

| | Residue Grade | | | Head Grade calc. | | |
|---|---|---|---|---|---|---|
| Test | Au | Ag | Cu | Au | Ag | Cu |
| ID | g/t | g/t | % | g/t | g/t | % |
| Mitchell and Deep Kerr - 0.96 g/t Au, 3.4 g/t Ag, 0.22% Cu, 20% S²⁻ (NaCN soluble 62.8% Au) | | | | | | |
| ATS 1 | 0.2 | 1.0 | 0.13 | 0.97 | 3.1 | 0.22 |
| CATS 1 | 0.24 | 1.0 | 0.17 | 0.85 | 2.0 | 0.19 |
| Mitchell - 1.59 g/t Au, 18 g/t Ag, 0.15% Cu, 31.8% S²⁻ (NaCN soluble 50.7% Au) | | | | | | |
| CaTS 2 | 0.94 | 4.0 | 0.13 | 1.59 | 18 | 0.13 |
| CaTS 6 | 0.77 | 3.0 | 0.14 | 1.59 | 18 | 0.13 |
| NaTS 2 | 0.90 | 5.0 | 0.12 | 1.59 | 18 | 0.13 |
| Iron Cap - 0.82 g/t Au, 4.0 g/t Ag, 0.07% Cu, 11.2% S²⁻ (NaCN soluble 36.3% Au) | | | | | | |
| IC-Ex 4 | — | — | — | — | — | — |
| IC-Ex 6 | — | — | — | — | — | — |
| IC-Ex 7-1 | — | — | — | — | — | |
| IC-Ex 7-2 | 0.51 | 2.0 | 0.07 | 0.88 | 4.0 | 0.08 |

### Example 3.2—Study of Thiosulphate Generation Rates

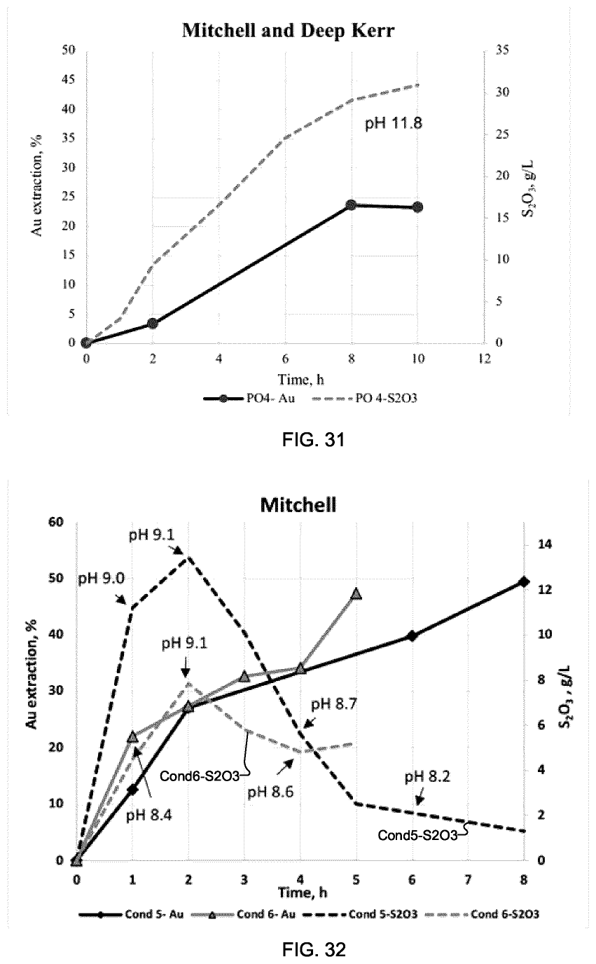

For Mitchell and Deep Kerr flotation products, a dropwise addition of sodium hydroxide at 30 psi oxygen overpressure and 80° C. temperature produced 0.28M of thiosulphate in 10 h from Mitchell & Deep Kerr sample. The generated thiosulphate did not decompose overnight after removing oxygen and caustic from the system. The feed and residue analysis confirmed that ˜30% of sulphides were oxidized. However, the gold extraction was poor ˜23%. The pH of the solution remained over 11 throughout the experiment and subsequently, gold leaching was poor. Results are shown in FIG. 31.

For Mitchell flotation products, the conditions for Cond 5 and Cond 6 tests were ˜44.4% solids, 93° C., 0.1 L/min oxygen. The pH was modified with 40 g/L Na₂CO₃ and ˜4 g/L NaOH at the beginning and afterwards the pH was maintained with addition of small amount of sodium carbonate. In Con5, the second dosage of carbonate was introduced at 1 h while in Cond 6 it was added at 2 h. This resulted different thiosulphate concentrations in these two leach solutions. FIG. 32 shows the effect of pH on thiosulphate concentration with time. Despite difference in thiosulphate concentrations, the gold extractions in both tests were close ˜47-49%.

Another Mitchell sample and leaching conditions (NaTS 1, NaTS7 and NaTS9) were: 50% solids, 93° C., 0.1 L/min oxygen. The initial dosage of sodium carbonate was 32 g/L and afterwards, the pH˜9-9.5 was maintained with NaOH. From FIG. 33, the best gold extraction˜55.3% in NaTS7 was achieved with less thiosulphate˜20 g/L compared to other two tests˜30 g/L S₂O₃. The sensitivity of thiosulphate consumption to the pH is evident. The loss of thiosulphate did not affect gold extraction during these tests.

A third Mitchell sample (T4, T5, T6 and T10) was tested under conditions: 40% solids, 75° C., 0.1 L/min oxygen. The initial dosage of sodium carbonate was 33 g/L and afterwards, the pH was maintained with NaOH except for T5. In this test, the pH was maintained with Na₂CO₃ alone and ˜4-5 g/L S₂O₃ was accumulated. The gold leaching was slower compared to other tests. The profiles of gold extractions and thiosulphate concentrations with time is shown in FIG. 34. Three other tests (T4, T5 and T10) showed similar rate of gold extraction up to 6 h but afterwards, the gold extraction continued in T4 test while in the other two tests, the gold started to reprecipitate. In T4 test, the pH was maintained almost perfectly and the ORP was also relatively stable around −20 mV (Ag/AgCl). The ORP in T10 was decreasing with time and at 8 h when the ORP was −43 mV, the gold started to precipitate. Based on carbonate/bicarbonate concentrations, the calculated pH was above 10 in this test that could explain high ORP and high thiosulphate.

For a sample from Iron Cap, gold leaching with in-situ generated thiosulphate was studied at different temperatures. It was found that the highest temperature (91° C.) generated more thiosulphate and consequently leached more gold compared to other tests at lower temperatures. FIG. 44 presents the gold extractions with time and the generated thiosulphate. The in-situ thiosulphate gold leaching tests conditions and results are summarised in Table 21.

TABLE 21
Summary of gold leaching with in-situ generated thiosulphate.

| | | | Conditions | | | | | | | Extraction by S₂O₃ | | |
|---|---|---|---|---|---|---|---|---|---|---|---|---|
| Test | solids | Time | T | | O₂ | NaOH | Na₂CO₃ | S₂O₃ in-situ | S₂O₃ in-situ | Au | Ag | Cu |
| ID | % | h | ° C. | pH | L/min | kg/t | cons. kg/t | (initial) kg/t | (final) kg/t | % | % | % |

Mitchell and Deep Kerr - 0.96 g/t Au, 3.4 g/t Ag, 0.22% Cu, 20% S²⁻ (NaCN soluble 62.8% Au)

| | | | | | | | | | | | | |
|---|---|---|---|---|---|---|---|---|---|---|---|---|
| PO 4 | 33 | 23 | 80 | 11.8 | 30* | 469 | — | 0.0 | 79.1 | 23.5 | 8.1 | 0.3 |

Mitchell - 1.59 g/t Au, 18 g/t Ag, 0.15% Cu, 31.8% S²⁻ (NaCN soluble 50.7% Au)

| | | | | | | | | | | | | |
|---|---|---|---|---|---|---|---|---|---|---|---|---|
| Cond5 | 44 | 6 | 95 | 8.5-9.0 | 0.1 | 4.7 | 82.5 | 0.0 | 1.5 | 49.5 | 64.5 | — |
| Cond6 | 44 | 5 | 95 | 8.5-9.0 | 0.1 | 4.6 | 87.5 | 0.0 | 6.0 | 47.4 | 84.2 | — |

Mitchell - 1.75 g/t Au, 8.0 g/t Ag, 0.14% Cu, 32% S²⁻ (NaCN soluble 68.1% Au)

| | | | | | | | | | | | | |
|---|---|---|---|---|---|---|---|---|---|---|---|---|
| NaTS1 | 50 | 8 | 93 | ~9 | 0.1 | 22 | 24 | 0.0 | 15.9 | 47.9 | 36.8 | — |
| NaTS7 | 50 | 10 | 93 | ~9 | 0.1 | 43 | 33 | 0.0 | 19.7 | 65.0 | 40.4 | — |
| NaTS9 | 50 | 10 | 93 | ~9 | 0.1 | 44 | 5.4 | 0.0 | 32.5 | 55.3 | 37.2 | — |

Mitchell - 1.34 g/t Au, 5.5 g/t Ag, 0.15% Cu, 23.4% S²⁻ (NaCN soluble 71.5% Au)

| | | | | | | | | | | | | |
|---|---|---|---|---|---|---|---|---|---|---|---|---|
| T-4 | 33 | 9 | 75 | 9.3 | 0.1 | 181 | 47 | 0.0 | 33.4 | 72.1 | 62.4 | 1.57 |
| T-5 | 40 | 8 | 75 | 8.8 | 0.1 | 0.0 | 191 | 0.0 | 8.2 | 57.7 | 64.2 | 5.31 |
| T-6 | 40 | 12 | 75 | 9.3 | 0.1 | 243 | 11 | 0.0 | 60.3 | 27.8 | 16.3 | 0.45 |
| T-10 | 33 | 8 | 75 | 9.3 | 0.1 | 171 | 8 | 0.0 | 33.6 | 59.2 | 28.1 | 0.43 |

Iron Cap - 0.82 g/t Au, 4.0 g/t Ag, 0.07% Cu, 11.2% S²⁻ (NaCN soluble 36.3% Au)

| | | | | | | | | | | | | |
|---|---|---|---|---|---|---|---|---|---|---|---|---|
| IC-Ex 1 | 34 | 6 | 50 | 8.8 | 0.1 | — | 42** | 0.0 | 2.7 | 8.84 | — | 1.35 |
| IC-Ex 2 | 33 | 6 | 50 | 9.0 | 0.1 | 3.0 | 11 | 0.0 | 1.2 | 4.96 | — | 0.38 |
| IC-Ex 10 | 33 | 8 | 70 | 8.9 | 0.1 | 57 | 11 | 0.0 | 3.7 | 20.4 | 50 | 0.47 |
| IC-Ex 9 | 33 | 8 | 80 | 8.5 | 0.1 | 45 | 29 | 0.0 | 2.7 | 23.1 | 50 | 0.66 |
| IC-Ex 8-1 | 36 | 6 | 91 | 9.8 | 0.1 | 42 | 14 | 0.0 | 8.3 | 35.7 | — | 1.08 |
| IC-Ex 8-2 | 36 | 6 | 91 | 9.3 | 0.1 | 27 | 11 | 0.0 | 2.5 | 35.1 | — | 1.15 |

| | Residue Grade | | | Head Grade calc. | | |
|---|---|---|---|---|---|---|
| Test | Au | Ag | Cu | Au | Ag | Cu |
| ID | g/t | g/t | % | g/t | g/t | % |
| Mitchell and Deep Kerr - 0.96 g/t Au, 3.4 g/t Ag, 0.22% Cu, 20% S²⁻ (NaCN soluble 62.8% Au) | | | | | | |
| PO 4 | 0.63 | 4.0 | 0.19 | 0.82 | 4.3 | 0.19 |
| Mitchell - 1.59 g/t Au, 18 g/t Ag, 0.15% Cu, 31.8% S²⁻ (NaCN soluble 50.7% Au) | | | | | | |
| Cond5 | 0.88 | 7.0 | 0.14 | 1.59 | 18.0 | 0.13 |
| Cond6 | 0.88 | 3.0 | 0.13 | 1.59 | 18.0 | 0.13 |
| Mitchell - 1.75 g/t Au, 8.0 g/t Ag, 0.14% Cu, 32% S²⁻ (NaCN soluble 68.1% Au) | | | | | | |
| NaTS1 | 0.83 | 5.6 | 0.13 | 1.67 | 8.1 | 0.14 |
| NaTS7 | 0.65 | 5.2 | 0.14 | 1.86 | 8.7 | 0.14 |
| NaTS9 | 0.74 | 2.6 | 0.12 | 1.66 | 4.1 | 0.14 |
| Mitchell - 1.34 g/t Au, 5.5 g/t Ag, 0.15% Cu, 23.4% S²⁻ (NaCN soluble 71.5% Au) | | | | | | |
| T-4 | 0.37 | 2.6 | 0.17 | 1.33 | 6.9 | 0.17 |
| T-5 | 0.47 | 2.8 | 0.16 | 1.11 | 7.8 | 0.17 |
| T-6 | 0.97 | 4.9 | 0.18 | 1.34 | 5.9 | 0.18 |
| T-10 | 0.55 | 4.30 | 0.18 | 1.35 | 6.0 | 0.18 |
| Iron Cap - 0.82 g/t Au, 4.0 g/t Ag, 0.07% Cu, 11.2% S²⁻ (NaCN soluble 36.3% Au) | | | | | | |
| IC-Ex 1 | — | — | — | — | — | — |
| IC-Ex 2 | — | — | — | — | — | — |
| IC-Ex 10 | 0.61 | 2.00 | 0.08 | 0.77 | 4.00 | 0.08 |
| IC-Ex 9 | 0.63 | 2.00 | 0.08 | 0.82 | 4.00 | 0.08 |
| IC-Ex 8-1 | — | — | — | — | — | — |
| IC-Ex 8-2 | 0.59 | 4.00 | 0.09 | 0.91 | 4.00 | 0.09 |

*Oxygen overpressure gpsi
**Na₂CO₃ dosage

### Example 3.3—Reproducibility of Test Results in Replicated Tests

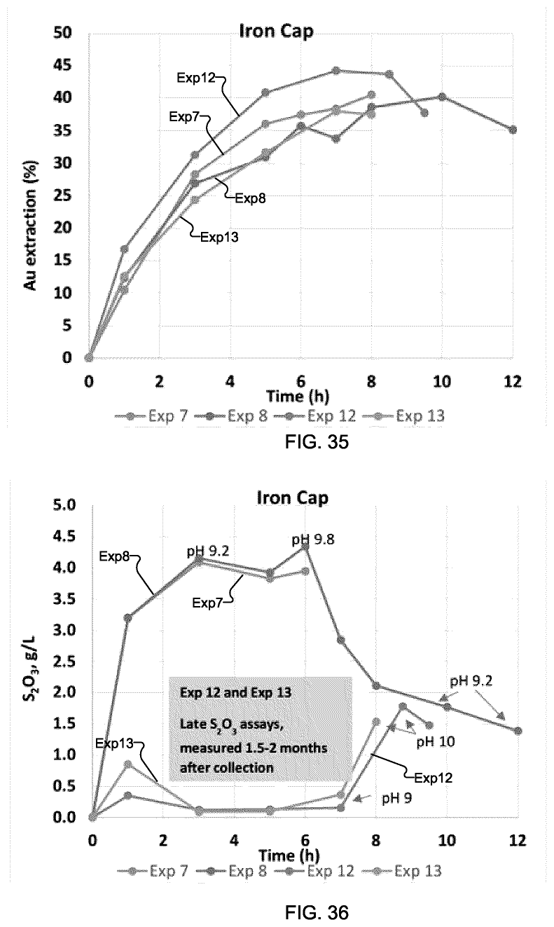

FIG. 35 and FIG. 36 depicts the gold extractions seen in four tests run under similar conditions. These tests were run at ˜33-35% pulp density, 91° C., 0.1 L/min oxygen flow, pH˜9. The Exp 7 and 8 leach solutions were measured for thiosulphate and polythionates as soon as solution samples were taken during and after leaching was complete. The thiosulphate concentrations in Exp 7 and 8 were identical for the first 6 h. When leaching extended for another 6 h (Exp 8), the accumulated thiosulphate started to decompose. This indicates that this test exhausted the thiosulphate generation potential at the testing conditions.

The thiosulphate in Exp 12 & 13 leach solutions were measured after 1.5-2 months of collection. These solutions were stored in the fridge but very low levels of thiosulphate in leach solution clearly indicates to the loss of thiosulphate especially for solutions with pH 9.

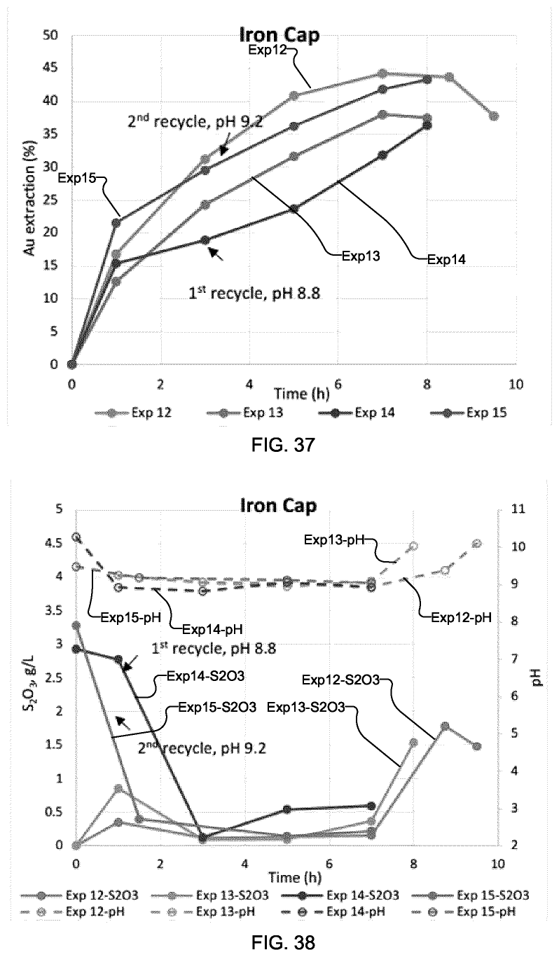

FIG. 37 compares Exp 12 and 13 tests with Exp 14 and 15. The Exp 12 and 13 used fresh carbonate solution while Exp 14 and 15 used recycled thiosulphate solutions after precipitating the leach gold. The first recycle solution was a filtrate, produced after removing the gold from combined Exp 12 and 13 leach solutions. This recycle was used as a starting solution in Exp 14. In this leach, the required carbonate was calculated based on total carbonate (CO₃+HCO₃) in starting solution. The carbonate dosage did not provide the target pH˜9 and extra NaOH was added in this test. The gold leaching in this test (Exp 14) was slower compared to other tests. The second recycle was a filtrate after removing the gold from Exp 14 leach solution. This second recycle was a starting solution in Exp 15 leaching test. The carbonate make-up for this test was calculated based on bicarbonate alone. The gold extraction profile for this test lies between Exp 12 and 13 in FIG. 37.

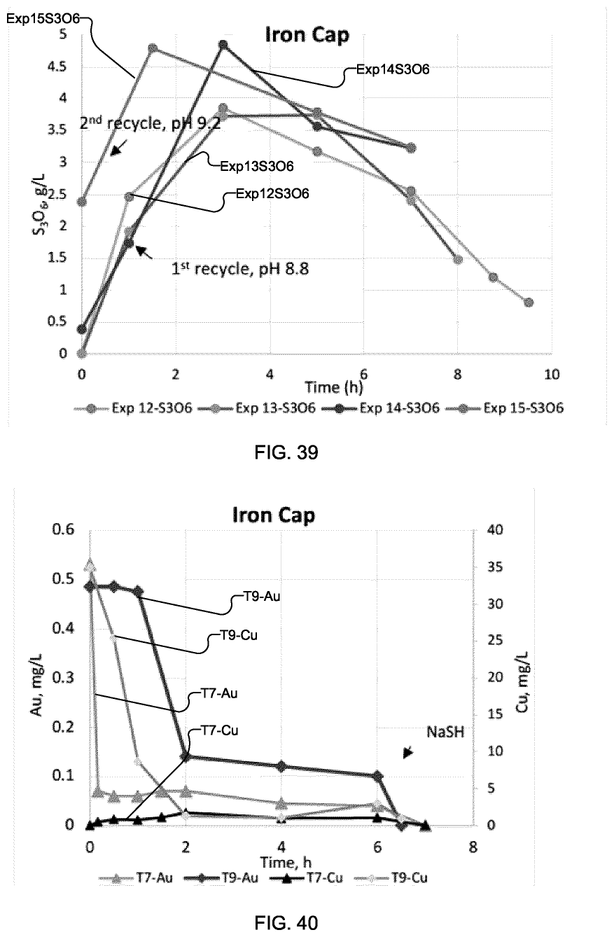

FIG. 38 presents thiosulphate profiles and pH change with time. Assuming same rate of thiosulphate decomposition during aging, the recycled thiosulphate sharply decomposed in leach. Higher pH at the end of leach matches with higher thiosulphate. The trithionate initially accumulates but with time decomposes as depicted in FIG. 39. The in-situ thiosulphate gold leaching tests conditions and results are summarised in Table 22. Table 23 presents the sulphide content in the feed sample, residual sulphide and required alkaline reagent based on pyrite oxidation reaction below (10 mol OH⁻ per 8 mol S), according to equation (5) as written above:

4FeS₂+9O₂+10OH⁻→4FeOOH+3S₂O3²⁻+2SO₄²⁻+3H₂O (6)

TABLE 22
Summary of gold leaching tests with in-situ thiosulphate at 91° C. on Iron Cap.

| | |
|---|---|
| Conditions | Extraction by 5₂O₃ |

| | | | | | | | | | | | | |
|---|---|---|---|---|---|---|---|---|---|---|---|---|
| Test | Solids | Time | T | | O₂ | NaOH | Na₂CO₃ | S₂O₃ | S₂O₃ | Au | Ag | Cu |
| ID | % | h | ° C. | pH | L/min | kg/t | cons. kg/t | (initial) kg/t | (final) kg/t | % | % | % |

Iron Cap - 0.82 g/t Au, 4.0 g/t Ag, 0.07% Cu, 11.2% S²⁻ (NaCN soluble 36.3% Au)

| | | | | | | | | | | | | |
|---|---|---|---|---|---|---|---|---|---|---|---|---|
| IC-Ex 7-1 | 34 | 6 | 91 | 9.9 | 0.1 | 41 | 18 | 0.0 | 7.5 | 37.4 | — | 1.6 |
| IC-Ex 7-2\hat{ } | | 6 | 50 | 9.1 | 0.05 | | | 24.6 | 20.1 | 41.8 | — | 15.6 |
| IC-Ex 8-1 | 36 | 6 | 91 | 9.8 | 0.1 | 42 | 17 | 0.0 | 8.3 | 35.7 | — | 1.1 |
| IC-Ex 8-2 | | 6 | 91 | 9.3 | 0.1 | 27 | 18 | 5.5 | 2.5 | 35.1 | — | 1.2 |
| IC Ex 12 | 34 | 7 | 91 | 8.9 | 0.1 | 68 | 21 | 0.0 | 0.3 | 44.2 | — | — |
| | | 10 | 91 | 10.1 | 0.1 | | | 0.3 | 3.0 | 37.7 | 50 | 0.6 |
| IC Ex 13 | 34 | 7 | 91 | 9.1 | 0.1 | 56 | 16 | 0.0 | 0.7 | 37.9 | — | — |
| | | 8 | 91 | 10.0 | 0.1 | | | 0.7 | 3.1 | 37.4 | 50 | 2.0 |
| IC Ex 14* | 34 | 8 | 91 | 8.9 | 0.1 | 46 | 15 | 5.7 | 1.2 | 36.3 | 75 | 6.6 |
| IC Ex 15** | 33 | 8 | 91 | 9.0 | 0.1 | 38 | 27 | 6.6 | 0.4 | 43.2 | 75 | 9.7 |

| | Residue Grade | | | Head Grade calc. | | |
|---|---|---|---|---|---|---|
| Test | Au | Ag | Cu | Au | Ag | Cu |
| ID | g/t | g/t | % | g/t | g/t | % |

Iron Cap - 0.82 g/t Au, 4.0 g/t Ag, 0.07% Cu,
11.2% S²⁻ (NaCN soluble 36.3% Au)

| | | | | | | |
|---|---|---|---|---|---|---|
| IC-Ex 7-1 | | | | | | |
| IC-Ex 7-2\hat{ } | 0.51 | 2.0 | 0.07 | 0.88 | 2.00 | 0.08 |
| IC-Ex 8-1 | | | | | | |
| IC-Ex 8-2 | 0.59 | 4.0 | 0.09 | 0.91 | 4.00 | 0.09 |
| IC Ex 12 | | | | | | |
| | 0.48 | 2.0 | 0.07 | 0.77 | 4.00 | 0.07 |
| IC Ex 13 | | | | | | |
| | 0.54 | 2.0 | 0.07 | 0.86 | 4.00 | 0.07 |
| IC Ex 14* | 0.57 | 1.0 | 0.07 | 0.90 | 4.00 | 0.07 |
| IC Ex 15** | 0.45 | 1.0 | 0.07 | 0.79 | 4.00 | 0.08 |

*1^{st} recycle after metals recovery by concentrate
**2^{nd} recycle after metals recovery by concentrate
\hat{ }sodium thiosulphate added in the leach
measured in 1.5-2 months aged solution

TABLE 23
Alkali reagents and consumption.
Table 4: The alkali reagents and consumption

| | FEED | | | Residue | | Oxidized | | OH− | Na2CO3 | NaOH | Total OH | Total OH | Total OH | Total OH |
|---|---|---|---|---|---|---|---|---|---|---|---|---|---|---|
| Test | Solids | S²⁻ | | S²⁻ | | 5²⁻ | | Requred | Added | Added | Recycled | Added | Remained | Consumed |
| ID | g | % | mol | % | mol | % | mol | mol | mol | mol | mol | mol | mol | mol |

Iron Cap - 0.82 g/t Au, 4.0 g/t Ag, 0.07% Cu, 11.2% 5²⁻ (NaCN soluble 36.3% Au)

| | | | | | | | | | | | | | | |
|---|---|---|---|---|---|---|---|---|---|---|---|---|---|---|
| IC-Ex 8 | 507 | 11.2 | 1.8 | 7.08 | 1.1 | 37 | 0.7 | 0.82 | 0.20 | 0.87 | 0.00 | 1.07 | 0.14 | 0.93 |
| IC Ex 12 | 504 | 11.2 | 1.8 | 7.23 | 1.1 | 35 | 0.6 | 0.78 | 0.20 | 0.86 | 0.00 | 1.06 | 0.17 | 0.89 |
| IC Ex 13 | 506 | 11.2 | 1.8 | 7.60 | 1.2 | 32 | 0.6 | 0.71 | 0.20 | 0.71 | 0.00 | 0.91 | 0.26 | 0.65 |
| IC Ex 14* | 511 | 11.2 | 1.8 | 8.14 | 1.3 | 27 | 0.5 | 0.61 | 0.09 | 0.58 | 0.10 | 0.77 | 0.15 | 0.52 |
| IC Ex 15** | 498 | 11.2 | 1.7 | 8.42 | 1.3 | 25 | 0.4 | 0.54 | 0.145 | 0.48 | 0.10 | 0.73 | 0.13 | 0.50 |

*1^{st} recycle after metals recovery by concentrate
**2^{nd} recycle after metals recovery by concentrate

### Example 3.4—Recovery of Gold (and Copper) by NaSH and the Concentrate

The leached metals from Mitchel deposit were recovered as a mixed metals sulphide precipitate using aqueous sulphide (NaSH) as a reagent. The NaSH dosage was matched with the trithionate and tetrathionate concentrations (moles NaSH added=moles of S₃O₆+moles of S₄O₆). The anticipation was that the NaSH reacting with polythionates converts them to thiosulphate while precipitating metals according to following reactions:

S₄O₆²⁻+HS⁻+OH⁻→2S₂O₃²⁻+H₂O+S₀ (11)

S₃O₆²⁻+HS⁻+OH⁻→2S₂O₃²⁻+H₂O (12)

Cu(S₂O₃)₃⁵⁻+HS⁻+OH⁻→CuS+H₂O+3S₂O₃²⁻ (13)

2Ag(S₂O₃)₂³⁻+HS⁻+OH⁻→Ag₂S+H₂O+4S₂O₃²⁻ (14)

2Au(S₂O₃)₂³⁻+HS⁻+OH⁻→Au+H₂O+4S₂O₃²⁻ (15)

In NaTS comp and NaTS9 tests, the tetrathionate and trithionate conversion to thiosulphate was incomplete (Table 24). This could be due to relatively low pH˜9, these reactions are most efficient at high pH. In addition, these tests were complete within 20 min perhaps allowing insufficient time for reactions to go to completion. But most importantly, the gold and silver were fully recovered, and this was based on solution assays. The amount of precipitate collected (<0.03 g) was insufficient for compositional analysis. It has to be noted that the NaSH comp test was done on leach solution composed from several in-situ thiosulphate leach tests including NaTS 7 from Table 21 and the NaSH9 was done on NaTS9 leach solution from the same table.

The third test (NaSH3) from Table 24 was done on another flotation product also produced from Mitchell deposit. The leach solution of T10 (Table 21) were treated with NaSH targeting polythionates. The initial pH of NaSH3 was higher˜10 and the test was run for 1 h. Almost complete conversion of polythionates to thiosulphate was evidenced in this test. However, the metals recovery was partial ˜70-80%.

An alternative approach was attempted in which a Cu—Au flotation concentrate (28 g/t Au, 117 g/t Ag, 22.6% Cu, 33% Fe and 27% S), was used as a reductant to precipitate gold thiosulphate from leach solution. The concentrate was mixed with leach solution with argon purging to exclude air at 50-60° C. The gold and copper were successfully precipitated while thiosulphate concentration was slightly increased possibly through the reaction between trithionate and sulphide (S₃O₆²⁻+S²⁻→2S₂O₃²⁻). Despite the presence of thiosulphate, gold in the concentrate did not dissolve under conditions of nitrogen purging (no oxidant added). In one of the tests not shown in Table 24, the concentrate was mixed with synthetic thiosulphate solution showing no evidence of gold dissolution after overnight mixing. The copper was not measured in this test but in other tests including T7 shown in Table 24, some copper was detected in synthetic thiosulphate solutions. This copper was apparently extracted from the Cu—Au concentrate.

The T8 and T9 tests were done on leach solution (combined Exp 7&8) containing ˜0.2 mg/L Au and ˜35 mg/L Cu. The gold concentration was spiked to ˜0.5 mg/L in T9. In both tests, the gold concentration decreased to ˜0.1 mg/L during 6 h and at that time, a small amount of NaSH was added to complete the precipitation. The T10 was run on leach solution (combined Exp 12 & 13). The T11 was run on Exp 14 leach solution. The T9 and T10 tests precipitated the gold (<0.02 mg/L Au, below detection limit by AA) and there was no need to add any NaSH. The tests conditions and results are shown in Table 24.

TABLE 24
Summary of gold precipitation with NaSH and on copper concentrate.

| | | | | | | | | | | | | | | | | | | Cu |
|---|---|---|---|---|---|---|---|---|---|---|---|---|---|---|---|---|---|---|
| | Flot. | Flot. | Solu- | Test Conditions | | | Reagent | Solution | | | | | | | | Au | Au | in |
| Test | Conc | Conc | tion | T | Argon | Time | NaSH | | ORP | Au | Cu | Ag | S₂O₃ | S₃O₆ | S₄O₆ | calc | Assay | conc. |
| No | g | g/L | L | ° C. | L/min | hours | g/L | pH | mV | mg/L | mg/L | mg/L | g/L | g/L | g/L | g/t | g/t | % |

Mitchell - 1.75 g/t Au, 8.0 g/t Ag, 0.14% Cu, 32% 5²⁻ (NaCN soluble 68.1% Au)

| | | | | | | | | | | | | | | | | | | |
|---|---|---|---|---|---|---|---|---|---|---|---|---|---|---|---|---|---|---|
| NaTS | — | — | 0.7 | 25 | — | 0.0 | 0.72 | 8.9 | — | 0.36 | — | — | 28.7 | 1.3 | 0.04 | — | — | — |
| comp | — | — | 0.7 | 25 | — | 0.3 | — | 8.6 | — | <0.02 | — | — | 31.7 | 0.8 | 0.01 | — | — | — |
| NaSH9 | — | — | 0.2 | 25 | — | 0.0 | 0.62 | 9.3 | — | 0.82 | 146 | 1.47 | 31.8 | 1.5 | 0.11 | — | — | — |
| | — | — | 0.2 | 25 | — | 0.3 | — | 8.3 | — | <0.05 | 0.25 | <0.03 | 32.9 | 1.1 | 0.11 | — | — | — |

Mitchell - 1.34 g/t Au, 5.5 g/t Ag, 0.15% Cu, 23.4% 5²⁻ (NaCN soluble 71.5% Au)

| | | | | | | | | | | | | | | | | | | |
|---|---|---|---|---|---|---|---|---|---|---|---|---|---|---|---|---|---|---|
| NaSH3 | — | — | 0.3 | 25 | — | 0 | 2.31 | 9.7 | −188 | 0.31 | 3.12 | 0.69 | 15.1 | 11.1 | 0.01 | — | — | — |
| | — | — | 0.3 | 25 | — | 1 | — | 8.1 | −406 | 0.06 | 0.8 | 0.19 | 27.6 | 0.1 | 0.01 | — | — | — |

Iron Cap - 0.82 g/t Au, 4.0 g/t Ag, 0.07% Cu, 11.2% 5²⁻ (NaCN soluble 36.3% Au)

| | | | | | | | | | | | | | | | | | | |
|---|---|---|---|---|---|---|---|---|---|---|---|---|---|---|---|---|---|---|
| T7 Au | 10 | 10 | 1.0 | 49 | 1 | 0 | — | 10.0 | −84.2 | 0.53 | 0.00 | — | 2.0 | — | — | 28 | 28 | 22.6 |
| | | | | | | 6 | 0.02 | 10.0 | −217 | 0.04 | 1.05 | — | 2.0 | — | — | 76 | — | — |
| | | | | | | 7 | | 10.1 | −396 | <0.02 | <0.02 | — | 2.1 | — | — | 80 | 74 | — |
| T8 Au | 5 | 10 | 0.5 | 48 | 1 | 0 | — | 9.0 | −60 | 0.19 | 34.9 | — | 7.3 | 1.9 | 0.24 | 28 | 28 | 22.6 |
| | | | | | | 6 | 0.7 | 9.6 | −198 | 0.09 | 4.09 | — | 8.5 | 2.4 | 0.02 | 38 | — | 22.9 |
| | | | | | | 28 | | 9.5 | −429 | <0.02 | 0.93 | — | 12.5 | 0.0 | 0.0 | 47 | 35 | 22.9 |
| T9 Au | 4.4 | 10 | 0.44 | 50 | 1 | 0 | — | 9.0 | −80 | 0.49 | 34.9 | — | 7.3 | 2.9 | 0.2 | 28 | 28 | 22.6 |
| | | | | | | 6 | 0.3 | 9.0 | −140 | 0.10 | 3.01 | — | 7.8 | 7 1 | 0.1 | 70 | — | 23.0 |
| | | | | | | 6.5 | | 8.9 | −296 | <0.02 | 0.90 | — | 10.1 | 1.0 | 0.0 | 80 | 69 | 23.0 |
| T10 Au | 13.3 | 10 | 1.33 | 60 | 1 | 0 | — | 10.1 | 30 | 0.13 | 4.79 | — | 2.0 | 0.9 | 0.0 | 28 | 28 | 22.6 |
| | | | | | | 1 | — | 10.0 | −85 | 0.03 | 1.29 | — | 2.6 | 0.6 | 0.0 | 38 | — | 22.6 |
| | | | | | | 5.0 | — | 10.0 | −248 | <0.02 | 0.69 | — | 2.8 | 0.5 | 0.0 | 39 | 36 | 22.6 |
| T11 Au | 6.57 | 10 | 0.65 | 60 | 1 | 0 | — | 9.1 | −58 | 0.16 | 24.4 | — | 0.1 | 4.1 | 0.7 | 28 | 28 | 22.6 |
| | | | | | | 1 | — | 9.2 | −94 | 0.03 | 1.04 | — | — | — | — | 41 | — | 22.8 |
| | | | | | | 5.0 | — | 9.5 | −188 | <0.02 | 1.01 | — | 6.0 | 0.5 | 0.2 | 43 | 41 | 22.8 |

measured after 1.5 months

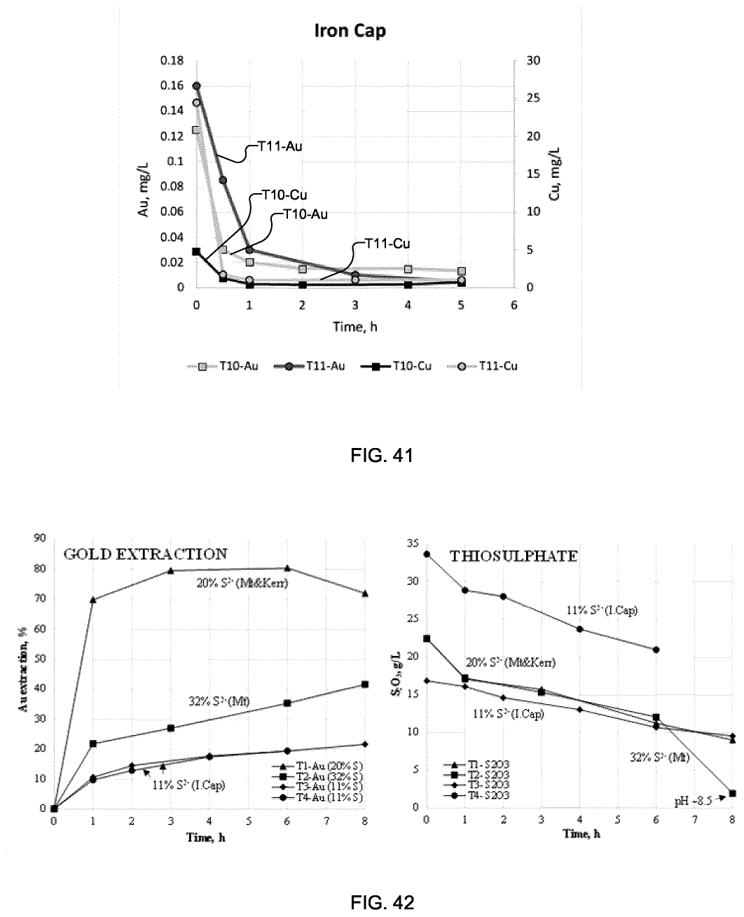

Kinetics of gold and copper disappearance from solution is presented in FIG. 40 and FIG. 41. In T7 Au experiment, the concentrate was mixed with synthetic gold thiosulphate solution containing zero copper and 2 g/L free thiosulphate. The gold concentration decreased sharply from initial 0.53 mg/L to 0.07 mg/L Au within 10 minutes of mixing with g/L concentrate. Some copper, ˜1 mg/L Cu was found to dissolve from the concentrate. At 6 h, the NaSH was added to precipitate remaining gold and copper. The T9 Au experiment was conducted on leach solution containing approx. 35 mg/L Cu and 0.5 mg/L Au. The test showed that the copper concentration 35 mg/L Cu was gradually decreasing with time to approx. 1 mg/L Cu at 2 h and did not change significantly even after the addition of NaSH at 6 h. In this test, the gold concentration dropped significantly at 2 h when most of copper was removed from solution on the concentrate.

More evidence of copper and gold uptake by the concentrate is shown in FIG. 41. The tests were done on leach solutions without adding the NaSH reagent. Both tests were successful. The metals concentrations in final solution were <0.02 mg/L Au and ˜1 mg/L Cu.

### Example 3.5—Conclusions to be Drawn From Examples 3.1-3.4

Five different flotation by-products containing approx. 11-32% sulphides and 0.8-1.8 g/t gold were leached with thiosulphate. In most cases, the gold extraction with added or in-situ generated thiosulphate was comparable with results obtained by a third party lab using conventional cyanide leaching.

Thiosulphate leaching requires oxygen, temperature and thiosulphate. In tests with added thiosulphate, oxygen was gently bubbled, and temperature was relatively low, approximately 50° C. Despite low temperature and oxygen, the decomposition of thiosulphate was detected in all tests. The rate of thiosulphate decomposition was higher with more sulphides in feed sample and longer leaching. In some cases, the leached gold was lost (precipitated) when decomposition of thiosulphate was matched with high ORP>100 mV (Ag/AgCl).

To continuously generate thiosulphate from sulphides contained in the feed sample, more oxygen was added at 0.1 L/min and temperature increased to 75 to 95° C. In these tests, a challenge was to maintain target pH 9. Higher pH>10 promoted higher rate of thiosulphate accumulation resulting in negative ORP and the loss of leached gold at ORP<(−50-80) mV (Ag/AgCl). This finding led to the controlled precipitation tests using high-grade flotation concentrate. These tests show that the gold and copper can be precipitated out of thiosulphate solution at pH 9 as well as pH 10 when oxygen is removed from solution by inert gas purging resulting low ORP<(−200) mV. During precipitation reaction, the thiosulphate is not lost but instead re-regenerated from trithionate present in feed leach solutions.

Following on these tests, a simple circuit of gold leaching and recovery from thiosulphate solution was abstracted. This conceptual circuit includes leaching of gold from a low-grade flotation by-product in hot (−91° C.) carbonate solution with in-situ generated thiosulphate from sulphides. This stage requires oxygen addition and caustic to maintain pH˜9. When leaching is complete and the leached residue separated from solution, the leached gold is fed to the precipitation stage. The precipitation stage includes contacting leach solution (50-60° C.) with high-grade flotation concentrate at inert gas (argon or nitrogen) sparging to remove oxygen from the system.

The performance of the circuit was verified by conducting three cycles of batch leaching of gold from sulphide by-product representing Iron Cap deposit and precipitating the leach gold on flotation concentrate representing the same Iron Cap deposit. The results demonstrated reproducibility of gold extraction with recycling.

Overall, the performance of closed loop leaching with recycling of filtrate after gold removal by precipitation was very good with similar gold extraction in each cycle solution.

### Example 4.0—Summary and Analysis of Experimental Results

The flotation product used in the study was produced from the KSM deposit located in BC, Canada. Four different flotation by-products (of a grind size of 80% passing 15-30 microns) representing Mitchell, Kerr and Iron Cap deposits were investigated for thiosulphate leaching of gold. The composition is given in Table 25.

TABLE 25
Feed samples composition.

| Feed samples | | Au(g/t) | Cu(%) | S (%) |
|---|---|---|---|---|
| 1 | Flotation Concentrate | 28.0 | 22.6 | 37 |
| 2 | Flotation by- | 0.85 | 0.19 | 20 |
| | product (Mt&Kerr) | | | |
| 3 | Flotation by- | 1.59 | 0.13 | 32 |
| | product (Mt) | | | |
| 4 | Flotation by- | 1.33 | 0.17 | 23 |
| | product (Mt-2) | | | |
| 5 | Flotation by- | 0.82 | 0.07 | 11 |
| | product (I.Cap) | | | |

The leaching tests were conducted in a glass reactor equipped with baffles (4× 1/10) and a single Rushton turbine with a diameter of 0.3 times the inside diameter of the tank and positioned 0.3 times the diameter (0.3 D) off the bottom. Oxygen sparger (fritted) was positioned under the impeller. The reactor was placed in temperature-controlled water bath. The reactor was equipped with pH and ORP Orion type electrodes to measure and record data continuously. The pH was regulated with calcium hydroxide (Reagent grade>98% Ca(OH)₂), sodium hydroxide (Reagent grade 97% NaOH) and sodium carbonate anhydrous (Reagent grade>99.5%). In thiosulphate leaching, sodium thiosulphate anhydrous (Reagent grade 99% Na₂S₂O₃), and calcium thiosulphate (Industrial grade sample) containing 23.8% thiosulphate were used. For metals precipitation, the NaSH (>70% purity) was used and flotation copper concentrate produced from Iron Cap deposit. During leaching, kinetic samples were taken at time intervals and analysed for gold by AA and thiosalts by DIONEX, ion chromatography. The solids were filtered, washed, dried and shipped to an external lab.

FIG. 42 presents the gold extraction profiles for four leaching tests and the rate of thiosulphate decomposition during leaching. Similar leaching conditions were applied in T1 (feed grade of 20% S and 0.9 g/t Au) and T2 (feed grade of 32% S and 1.6 g/t Au) experiments. Prior to leaching, both samples were finely ground 80% passing 15-20 microns and the calcium thiosulphate was used as a source of thiosulphate. Almost 80% of the gold was leached from T1 sample after 3 hours and was holding for another three hours but subsequently decreased to 72% by the end of the test while in T2 tests, only 42% gold was extracted. These two samples represent different flotation circuits and deposits; therefore, it was not unexpected that the results might be different. For both tests, after initial drop of thiosulphate concentration, the rate of thiosulphate decomposition estimated as ˜1.0-1.2 g S₂O₃/L/h (FIG. 42).

The third sample (I.Cap) produced from Iron Cap deposit was also finely ground 80% passing 20 microns. This sample was leached with sodium thiosulphate at two different concentrations. The T3 experiment used 0.15 M sodium thiosulphate and the T4 used 0.30 M sodium thiosulphate. In these two experiments, the samples were conditioned in 0.2M sodium carbonate and alkalinity during leaching was maintained with sodium hydroxide. The gold extraction profiles in both tests were similar and did not exceed 22% despite the abundance of thiosulphate in T4 tests. From FIG. 42, the thiosulphate decomposition rate estimated as ˜1.0 g S₂O₃/L/h for lower thiosulphate T3 test and ˜1.7 g S₂O₃/L/h for higher thiosulphate T4 test.

Table 25 above lists the mass of feed solid samples, compositions, reagents used and final leach solution composition. It is interesting to note that the alkaline reagents needed to maintain the leach pH was ˜10-13 kg/t regardless of the reagent type (CaO or Na₂CO₃, NaOH). The total alkalinity OHT is presented in molality. Similarly, the sulphur in feed is presented in molality to give some information how much sulphides were (1.3-2.0 mol) in feed samples. There is no information about residual sulphides after leaching for these tests. The thiosulphate, trithionate and tetrathionates were also measured in leach solutions and presented in Table 26.

TABLE 26
Thiosulphate leaching conditions and results.

| | | | Feed | | | | | | Reagents | | | | | | Leach solution product | | | | |
|---|---|---|---|---|---|---|---|---|---|---|---|---|---|---|---|---|---|---|---|
| | Time | Temp. | S²⁻ | | | Au | Cu | CaO | Na₂CO₃ | NaOH | OH⁻_{T} | S₂O₃ | | Cu | S₂O₃ | S₃O₆ | S₄O₆ | Au | Cu |
| Test | h | C. ° | g | % | mol | g/t | % | kg/t | kg/t | kg/t | mol | g/L | kg/t | mg/L | g/L | g/L | g/L | mg/L | mg/L |
| T1_{(Mt&Kerr)} | 8 | 50 | 200 | 20.0 | 1.3 | 0.9 | 0.2 | 13 | 0.0 | 0.0 | 0.09 | 22.4 | 53.2 | 50 | 9.0 | — | — | 0.23 | 112 |
| T2_{(Mt)} | 8 | 50 | 200 | 31.8 | 2.0 | 1.6 | 0.2 | 11 | 0.0 | 0.0 | 0.06 | 22.4 | 44.8 | 50 | 1.9 | — | — | 0.35 | — |
| T3_{(Mt)} | 8 | 50 | 506 | 11.2 | 1.8 | 0.8 | 0.1 | 0.0 | 10 | 2.3 | 0.08 | 16.8 | 33.2 | 0.0 | 9.5 | 6.49 | 0.4 | 0.09 | 46.7 |
| T4_{(I. Cap)} | 6 | 50 | 509 | 11.2 | 1.8 | 0.8 | 0.1 | 0.0 | 10 | 0.0 | 0.05 | 33.6 | 66.1 | 0.0 | 21 | 9.65 | 0.6 | 0.08 | 62.9 |

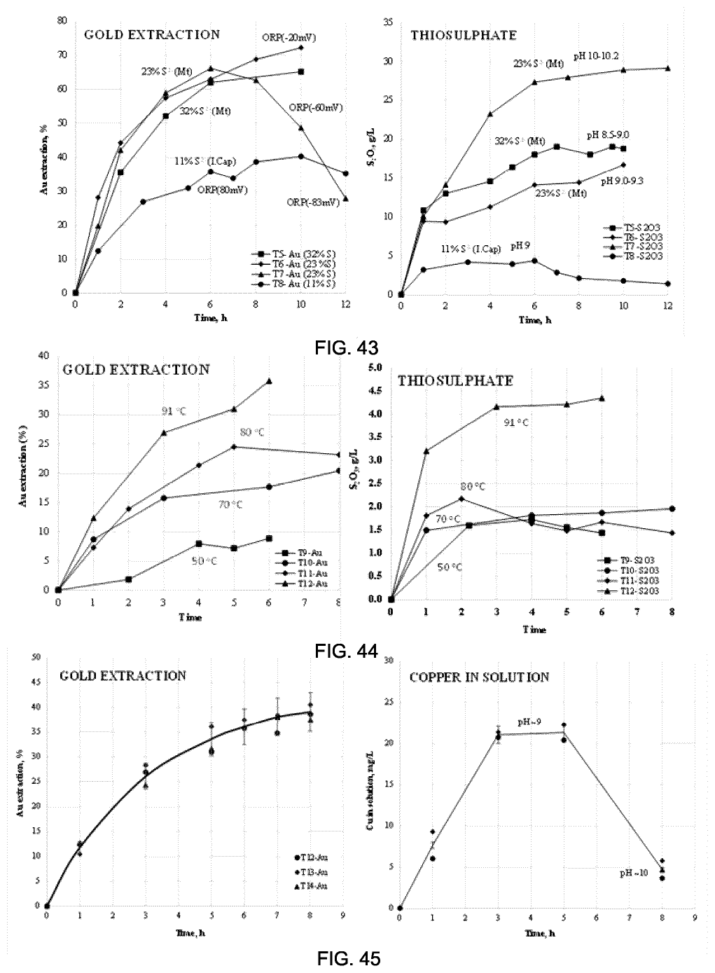

The thiosulphate leaching tests indicated that ˜1-2 g S₂O₃/L/h was decomposing during leaching and next series of tests was aimed to test whether the thiosulphate can be produced in-situ from sulphide to compensate the loss. In these tests, the thiosulphate was not added but produced in-situ by adding more oxygen at 1 L/min, increasing temperature from 50° C. to 75-90° C. and maintaining the pH˜9-10. The conditions for the four experiments run on three different flotation by-products are present in Table 27. FIG. 43 shows the gold extraction profiles and the rate of in-situ thiosulphate generation.

With more oxygen in the system and higher temperature the control of pH was challenging. The pH 10 in T7 test produced almost twice the thiosulphate (˜29 g/L S₂O₃) in comparison with the pH 9 in T6 (˜17 g/L S₂O₃). Both tests used the same flotation by-product (Mt containing 23% S²⁻). Subsequently, maintaining higher pH consumed more alkaline reagent (OH_{T}˜1.31 mol). In these two tests, the initial rate of gold extraction was similar but after 6 h, when ORP dropped below −40 mV (Ag/AgCl) in T7 test, the gold started to precipitate out of solution. Keeping a desirable ORP˜−20 mV (Ag/AgCl) throughout 10 h of leaching in T6 provided a continuous gold extraction reaching ˜72% extraction to the end of leach test.

The results of other two in-situ thiosulphate leach tests at pH˜9 (T5 and T8) can be directly compared with the added thiosulphate tests (T2 and T4) from Table 26 since these tests used the matching flotation by-products as feed samples to leaching. The T5 (Mt Kerr containing 32% S²⁻) in-situ thiosulphate leach extracted ˜65% gold while the added thiosulphate in T2 (Mt 32% S²⁻) only extracted 41.5% gold. Similarly, in-situ thiosulphate in T8 (I.Cap) extracted 35.7% gold while the added thiosulphate in T4 (I.Cap) extracted less ˜22% gold. Better gold extraction can be explained by oxidizing some sulphides as a consequence of more oxygen in the system and releasing the gold to the thiosulphate. The in-situ thiosulphate gold leaching conditions and results are given in Table 27.

TABLE 27
In-situ thiosulphate leaching conditions and results.

| | | | Feed | | | | | | Reagents | |
|---|---|---|---|---|---|---|---|---|---|---|
| | Time | Temp. | S²⁻ | | | Au | Cu | CaO | Na₂CO_{3(cons.)} | NaOH |
| Test | h | C. ° | g | % | mol | g/t | % | kg/t | kg/t | kg/t |
| T5_{(Mt)} | 10 | 91 | 400 | 31.8 | 4.0 | 1.6 | 0.2 | 0.0 | 33.4 | 42.9 |
| T6_{(Mt)} | 10 | 75 | 200 | 23.4 | 1.5 | 1.3 | 0.2 | 0.0 | 46.6 | 181 |
| T7_{(Mt)} | 12 | 75 | 512 | 23.4 | 1.5 | 1.3 | 0.2 | 0.0 | 10.6 | 243 |
| T8_{(I. Cap)} | 12 | 93 | 507 | 11.2 | 1.8 | 0.8 | 0.1 | 0.0 | 25.1 | 68.6 |

| | Reagents | | | | Leach solution product | | | | |
|---|---|---|---|---|---|---|---|---|---|
| | OH⁻_{T} | S₂O₃ | | Cu | S₂O₃ | S₃O₆ | S₄O₆ | Au | Cu |
| Test | mol | g/L | kg/t | mg/L | g/L | g/L | g/L | mg/L | mg/L |
| T5_{(Mt)} | 0.57 | 0.0 | 0.0 | 0.0 | 18.8 | 4.8 | 0.8 | 0.65 | — |
| T6_{(Mt)} | 1.00 | 0.0 | 0.0 | 0.0 | 16.7 | 10.1 | 0.0 | 0.40 | 12 |
| T7_{(Mt)} | 1.31 | 0.0 | 0.0 | 0.0 | 29.1 | 9.7 | 0.0 | 0.13 | 3.9 |
| T8_{(I. Cap)} | 1.07 | 0.0 | 0.0 | 0.0 | 1.38 | 1.0 | 0.0 | 0.15 | 3.6 |

In situ thiosulphate tests consumed much more alkaline reagents (0.6-1.3 mol OH⁻) from Table 27 compared to the tests (0.05-0.09 mol OH⁻) with added thiosulphate Table 26. However, in-situ thiosulphate tests did not require any addition of thiosulphate which can be as high as 33.2-66.1 kg/t (from Table 26) and copper (50 mg Cu/L as copper sulphate˜0.3 kg/t).

FIG. 44 shows the effect of temperature on gold leaching and the thiosulphate production rate. For these tests, a low-grade flotation by-product (I.Cap) was used. The highest 91° C. temperature (T9) produced more thiosulphate and leached more gold compared to the lower temperature tests (T10, 11, 12). FIG. 45 combines data for three tests run at 91° C. to show the reproducibility of the result.

FIG. 45 also presents the copper dissolution during gold leaching with in-situ thiosulphate. The copper concentration increased over 20 mg/L within 3 h and did not change for another 2 h but as pH increased to 10 at the end of leach, the solubilised copper precipitated while gold remained in solution. The final leach solution compositions as well as the conditions are presented in Table 28.

TABLE 28
Summary of in-situ thiosulphate leaching at different temperatures.

| | | | Feed | | | | | Reagents | | | | Extraction | | Leach solution product | | | | | |
|---|---|---|---|---|---|---|---|---|---|---|---|---|---|---|---|---|---|---|---|
| | Time | Temp. | S²⁻ | | | Au | Cu | Na₂CO₃ | NaOH | OH⁻_{T} | OH⁻_{cons.} | Au | Cu | S₂O₃ | S₃O₆ | S₄O₆ | Au | Cu | OH⁻ᵣ |
| Test | h | C. ° | g | % | mol | g/t | % | kg/t | kg/t | mol | mol | % | % | g/L | g/L | g/L | mg/L | mg/L | mol |
| T9 | 6 | 50 | 506 | 11 | 1.8 | 0.8 | 0.1 | 42 | 0.0 | 0.20 | — | 8.8 | 1.4 | 1.4 | 3.6 | 3.6 | 0.04 | 5.05 | — |
| T10 | 8 | 70 | 503 | 11 | 1.8 | 0.8 | 0.1 | 42 | 57 | 0.92 | — | 20.4 | 0.5 | 2.0 | 6.1 | 0.0 | 0.08 | 1.82 | — |
| T11 | 8 | 80 | 503 | 11 | 1.8 | 0.8 | 0.1 | 53 | 45 | 0.76 | — | 23.1 | 0.7 | 1.4 | 3.3 | 0.0 | 0.09 | 2.47 | — |
| T12 | 6 | 91 | 507 | 11 | 1.8 | 0.8 | 0.1 | 42 | 42 | 0.73 | — | 35.7 | 1.1 | 4.3 | 1.8 | 0.0 | 0.16 | 3.62 | |
| T13 | 6 | 91 | 512 | 11 | 1.8 | 0.8 | 0.1 | 41 | 41 | 0.73 | — | 37.4 | 1.6 | 3.9 | 1.8 | 0.0 | 0.16 | 5.73 | |
| T14 | 6 | 91 | 506 | 11 | 1.8 | 0.8 | 0.1 | 42 | 56 | 0.91 | 0.65 | 37.4 | 2.0 | 4.1 | — | — | 0.16 | — | 0.3 |

OH⁻_{cons.}(consumed) = OH⁻_{T} − OH⁻ᵣ (remaining in leach solution)

Table 28 shows the carbonate and caustic additions (0.73-0.91 mol OH⁻) in leaching tests. The T14 leach solution was titrated against acid to estimate the remaining OH⁻ which allows the calculation of consumption (0.65 mol OH⁻) versus the added amount (0.91 mol OH⁻). In addition, the leached residue was assayed for remaining sulphides (7.6% S²⁻) corresponding to the oxidation of 0.57 mol S²⁻. The pyrite oxidation reaction can be presented as equation (6) as written above:

4FeS₂+9O₂+10OH⁻=4FeOOH+3S₂O₃²⁻+2SO₄²⁻+3H₂O (6)

According to reaction (6) stoichiometry, the 0.57 mol S oxidation requires 0.71 mol OH⁻ which is close to the 0.65 mol OH⁻ consumed in T14 test.

Two tests were conducted on a synthetic gold thiosulphate solution to study the flotation concentrate as a mineral precipitant for gold from thiosulphate solution. A synthetic gold thiosulphate solution (0.54 mg/L Au and 2 g/L S₂O₃) was split between two tests. In P4 test, the pH was adjusted to 9 and in P7 the pH was adjusted to 10. The synthetic gold thiosulphate solution did not contain any copper. The third test was run on leach solution without adjusting pH or any other parameters. In all three tests, inert gas was purged at 1 L/min flowrate. The metals precipitation profiles in each test are shown in FIG. 46.

A rapid drop of gold concentration from 0.5 mg/L to <0.1 mg/L within 10 minutes of mixing with a concentrate was evidenced in solution of pH 10 (P4). The gold precipitated relatively slowly at pH 9.3 in P7 test. At the end of tests (6 h), a small amount of NaSH was added to precipitate any remaining aqueous gold, and this also resulted in regeneration of thiosulphate. Before NaSH addition, the solution contained ˜1 mg/L Cu dissolved from the concentrate and this copper precipitated along with gold with NaSH (FIG. 46).

The gold precipitation profile (P9) from leach solution was different. The gold precipitation was slow within first hour and then rapidly decreased from ˜0.48 mg/L to 0.14 mg/L at 2 h which coincided with the copper precipitation from initial ˜35 mg/L Cu to ˜9 mg/L Cu. Like other two precipitation tests, the remaining gold and copper after 6 h of mixing was recovered with NaSH addition.

FIG. 47 shows the thiosulphate and trithionate concentration profiles during gold and copper precipitation. The synthetic solution did not contain any trithionate at the beginning and remained below detection limit throughout the test. Regarding thiosulphate, the initial concentration of thiosulphate (2 g/L) remained almost unchanged. In T9 test utilizing leach solution, the thiosulphate concentration increased with time while trithionate concentration decreased. A sharp change of both thiosulphate and trithionate concentrations was seen after NaSH addition, with NaSH resulting in the regeneration of thiosulphate. The possible reaction of trithionate with sulphides producing thiosulphate can be explained by this reaction below:

Na₂S₃O₆²⁻+Na₂S=2Na₂S₂O₃ (16)

TABLE 29
Summary of gold recovery on a copper concentrate.

| | | Reagents | | Solution | | | | | | | Recovery | | Solid Product | |
|---|---|---|---|---|---|---|---|---|---|---|---|---|---|---|
| | Time | NaOH | NaSH | | ORP | Au | Cu | S₂O₃ | S₃O₆ | S₄O₆ | Au | Cu | Au | Cu |
| Test | h | mg/L Feed | mg/L Feed | pH | mV | mg/L | mg/L | g/L | M | kg/t | % | % | g/t | % |
| P4(Synt) | 0 | 4.9 | — | 9.3 | −176 | 0.53 | 0.00 | 2.0 | — | — | — | — | 28 | 22.6 |
| | 6 | — | — | 9.3 | −202 | 0.05 | 1.54 | 2.0 | — | — | 90 | — | | |
| | 6.3 | — | 0.04 | 9.7 | −440 | <0.02 | <0.02 | 2.0 | — | — | >98 | — | 80* | — |
| P7(Synt) | 0 | 5.4 | — | 10.1 | −84 | 0.53 | 0.00 | 2.0 | — | — | — | — | 28 | 22.6 |
| | 6 | — | — | 10.1 | −405 | 0.04 | 1.05 | 2.0 | — | — | 92 | — | | |
| | 6.3 | — | 0.02 | 10.1 | −396 | <0.02 | <0.02 | 2.0 | — | — | >98 | — | 74 | — |
| P9(Leach) | 0 | 0.0 | — | 9.0 | −25 | 0.49 | 7.25 | 7.3 | 2.87 | 0.24 | — | — | 28 | 22.6 |
| | 6 | — | — | — | −153 | 0.10 | 3.01 | 7.8 | 2.23 | 0.05 | 80 | 91 | | |
| | 6.3 | — | 0.29 | 8.9 | −296 | <0.02 | 0.90 | 10.1 | 1.02 | 0.02 | >98 | 97 | 69 | 22.8* |

*calculated value

Table 29 presents the conditions and results of precipitation tests. A noticeable decrease of ORP −200-400 mV during precipitation reaction was due to inert gas deoxygenation. Some copper was detected in synthetic solution (1 -1.5 mg/was Cu) dissolved from chalcopyrite possibly through reaction (17). The electrons produced during chalcopyrite leaching reduced the gold (reaction (18)) on cathodic side of mineral. The copper present in leach solution replacing the iron in chalcopyrite according to metathesis reaction (19) and transformation of chalcopyrite in covellite.

CuFeS₂→Cu²⁺+Fe²⁺+2S^{o}+4e⁻ (17)

4Au⁺+4e⁻→Au^{o} (18)

CuFeS₂+Cu²⁺→2CuS+Fe²⁺ (19)

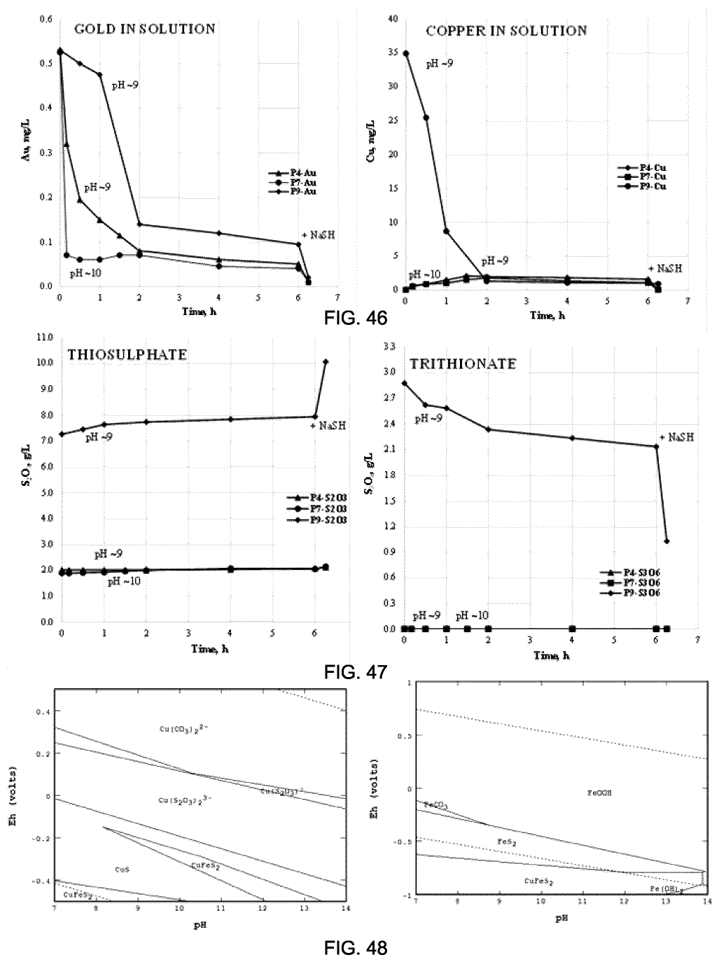

The stability diagrams on FIG. 48 support the hypothesis of covellite/chalcopyrite presence at pH 9 and below ˜−100 mV Eh (or ˜−300 mV Ag/AgCl). The carbonates present in leach solution may solubilise iron under reductive conditions supported by the narrow field of iron carbonate stability above the pyrite region.

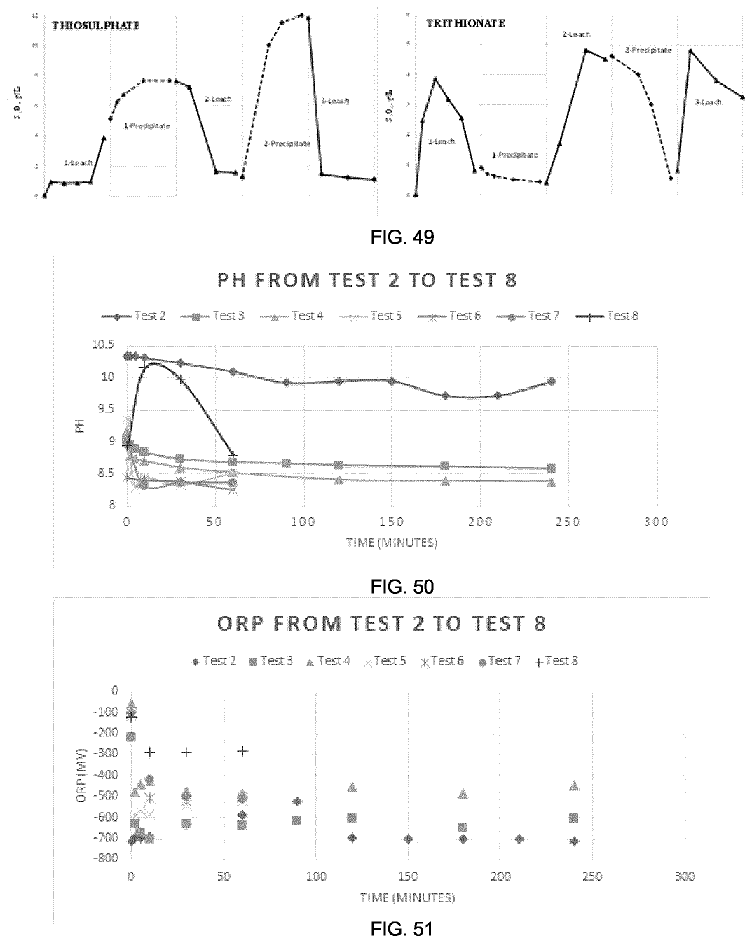

Three cycles of batch leaching with fresh sample for the initial and recycled solutions for following two leaching tests were accomplished. The conditions for leaching were the same as used in earlier batch tests. In precipitation experiments, the temperature was increased to 60° C. and more time allowed to precipitate the gold and copper without addition of NaSH or any other reagent. The change of gold and copper concentrations during leaching and precipitation tests are presented in FIGS. 26 and 27 and a summary of the various parameters is provided in Table 30. The gold concentration profiles for three leaching cycles almost overlay. The copper concentration tends to increase with more recycle. This can be explained with higher concentration of thiosulphate in recycle solution and at the beginning of leach. More trithionate accumulated during leach produced more thiosulphate during precipitation tests as shown in FIG. 49.

TABLE 30
Summary of leaching followed precipitation and the recycle of spent solution.

| | Feed | | | Reagents | | | | | Solution product | | | |
|---|---|---|---|---|---|---|---|---|---|---|---|---|
| | to Leach | to Prec. | | Na₂CO₃ | NaOH | OH⁻_{added} | OH⁻_{rec.} | OH⁻_{cons.} | | ORP | Au | Cu |
| Test | g* | g** | L^{~} | kg/t | kg/t | mol | mol | mol | pH | mV | mg/L | mg/L |
| 1-Leach | 506 | 0.0 | 0.0 | 16.4 | 56.3 | 0.91 | 0.00 | 0.65 | 10 | 21 | 0.16 | 7.19 |
| 1- Prec. | 0.0 | 13 | 1.3 | 0.0 | 0.0 | 0.0 | — | — | 10 | −248 | 0.01 | 0.69 |
| 2-Leach | 511 | 0.0 | 0.0 | 15.0 | 45.5 | 0.67 | 0.10 | 0.62 | 8.9 | 61 | 0.16 | 24.4 |
| 3-Prec. | 0.0 | 13 | 1.3 | 0.0 | 0.0 | 0.0 | — | — | 9.5 | −188 | 0.01 | 1.02 |
| 3-Leach | 498 | 0.0 | 0.0 | 27.3 | 38.2 | 0.63 | 0.10 | 0.60 | 9.0 | 51 | 0.17 | 36.7 |

| | Solution product | | | | Recovery | | Solids product | | | |
|---|---|---|---|---|---|---|---|---|---|---|
| | S₂O₃ | S₃O₆ | S₄O₆ | OH⁻ᵣₑₘ | Au | Cu | Au | Cu | S²⁻ | \grave{ }S²⁻ |
| Test | g/L | g/L | g/L | mol | % | % | g/t | % | % | mol |
| 1-Leach | 3.8 | 0.8 | — | 0.26 | 37.4 | 1.96 | 0.54 | 0.07 | 7.6 | 0.57 |
| 1- Prec. | 7.6\hat{ }\hat{ } | 0.4 | — | — | 92.0 | 95.8 | 39.5 | 22.6 | 37\hat{ } | — |
| 2-Leach | 1.5 | 4.5 | — | 0.15 | 36.3 | 6.6 | 0.57 | 0.07 | 8.1 | 0.49 |
| 3-Prec. | 12\hat{ }\hat{ } | 0.5 | — | — | 96.9 | 95.8 | 43.1 | 22.8 | 37\hat{ } | — |
| 3-Leach | 1.1 | 3.2 | — | 0.13 | 43.2 | 9.68 | 0.45 | 0.07 | 8.4 | 0.43 |

*Flotation by-product
*Flotation concentrate
\hat{ }Sulphide in concentrate, no assay on precipitation product
\hat{ }\hat{ }Assays recalculated due to late analysis
^{~}Leach solution recycle
\grave{ }Sulphides oxidised
OH⁻_{cons.}(consumed) = OH⁻_{T} + OH⁻_{rec.} − OH⁻ᵣₑₘ (remaining in leach solution)

FIG. 1 depicts the conceptual flowsheet for an example embodiment of gold recovery from flotation by-product based on these Examples. Following on these tests, a simple example circuit of gold leaching and recovery from thiosulphate solution was conceived. This conceptual circuit includes leaching of gold from a low-grade flotation by-product in hot (˜91° C.) carbonate solution with in-situ generated thiosulphate from sulphides. This stage requires oxygen addition and caustic to maintain pH˜9. When leaching is complete and the leached residue separated from solution, the leached gold is fed to the precipitation stage. The precipitation stage includes contacting leach solution (50-60° C.) with high-grade flotation concentrate under inert gas sparging to remove oxygen from the system.

In conclusion, three flotation by-products were leached at typical thiosulphate leaching conditions. These tests were run to observe the rate of gold leaching and thiosulphate decomposition. More gold was extracted with in-situ thiosulphate due to the oxidation of sulphides. Overall, the gold extractions achieved by thiosulphate procedures in this paper varied by sulphide sources. However, these gold extraction results were comparable to those measured by cyanidation procedures on these samples.

Leached gold and copper were precipitated on a chalcopyrite/pyrite flotation concentrate. It is proposed without being bound by theory that the galvanic interaction between minerals precipitated copper into the copper concentrate by displacement of iron from the chalcopyrite lattice and reduced the gold to metal. Formulation of a consistent mechanism involves identification of the controlling species through surface study in addition to comprehensive solution analysis. This current study only provides the solution and solids analysis to support the hypothesis of methathesis and reduction occurring during precipitation of metals on the flotation concentrate. Along with solution analysis for metals, it was also detected that the trithionate accumulated in leach solution converted to the thiosulphate possibly through the reaction with sulphides in solids.

The precipitation of metal values excludes oxygen from the slurries in the reaction vessels. These procedures can include inert gases to reduce oxygen solution solubility in the reactors via the use of argon or nitrogen”. Commercial vacuum deaeration systems could also be utilized on process solutions to enhance inert gas solubility and displacement of oxygen from the precipitation vessels.

The efficiency of recycling was verified by conducting three cycles of batch leaching of gold from a sulphide by-product representing Iron Cap deposit and precipitating the gold and copper on a flotation concentrate representing the same Iron Cap deposit. The results demonstrated reproducibility of gold extraction with the recycling. Overall, the performance of closed loop leaching with recycling of filtrate after gold removal by precipitation was excellent with similar gold extraction in each cycle solution.

### Example 5.0—Additional Precipitation Agents for Recovery of Metal Values After Leaching

### Example 5.1—Ferrous Sulphate

A series of experiments were performed using ferrous sulphate to precipitate gold, silver and copper in thiosulphate medium. A total of nine gold precipitation tests, two blank tests and one cyanidation test were completed. The precipitation of gold was very rapid under all conditions. The iron salt formed a precipitate that could be recovered from the final thiosulphate solution. The precipitation of silver and copper were variable, depending on the conditions of the test. Iron precipitate was recovered and subjected to cyanide leaching to recover the precipitated gold. This test confirmed that gold could be recovered from the iron precipitate.

For these examples, the test solutions were prepared by the same method. First, a required volume gold ICP standard solution was transferred to a beaker and diluted with about 300 mL deionized water. The required amount of copper sulphate and silver ICP standard solution was then added. The pH was adjusted gradually with concentrated sodium hydroxide solution to about pH 4. Then the required amount of sodium thiosulphate was added to the solution. The prepared solution was transferred to 2-L volumetric flask and diluted with deionized water to prepare the solution for the experiment. The solution was transferred to the 2 L reactor and purged with nitrogen for 30 minutes before the test start.

The reactor used is a 2 L glass reactor with a thermo-jacket for inlet and outlet of water for temperature control. The temperature was controlled by a circulating water bath pumping water through the thermo-jacket. The agitation was provided by overhead stirrer. The agitation speed was set to 800 rpm for all tests. The solution was well mixed under this condition and any solids were fine and easily suspended. The experimental conditions tested are shown in Table 31 below.

TABLE 31
Experimental conditions for ferrous sulphate precipitation.

| | | | | | Ferrous | | | Time |
|---|---|---|---|---|---|---|---|---|
| | Au (ppm) | Ag (ppm) | Cu (ppm) | Na₂S₂O₃ (M) | (ppm) | pH | T (° C.) | (h) |
| Test 1 | 10 | 0 | 20 | 0.18 | 1000 | 10 | 80 | 4 |
| Test 2 | 10 | 0 | 20 | 0.18 | 1000 | 10 | 25 | 4 |
| Test 3 | 10 | 0 | 20 | 0.18 | 100 | 9 | 25 | 4 |
| Test 4 | 10 | 0 | 20 | 0.18 | 100 | 9 | 25 | 4 |
| Test 5 | 10 | 0 | 20 | 0.18 | 1000 | 9 | 25 | 1 |
| Test 6 | 1.5 | 3 | 200 | 0.18 | 1000 | 9 | 25 | 1 |
| Test 7 | 1.5 | 3 | 200 | 0.18 | 500 | 9 | 25 | 1 |
| Test 8 | 1.5 | 3 | 200 | 0.18 | 100 | 9 | 25 | 1 |
| Test 9 | 10 | 3 | 30 | 0.1 | 500 | 9 | 25 | 0.17 |
| Blank 1 | 10 | 0 | 20 | 0.18 | 0 | 9 | 25 | 4 |
| Blank 2 | 1.5 | 3 | 200 | 0.18 | 0 | 9 | 25 | 1 |

In Test 1, the ferrous sulphate was added into the test solution as solid. The pH dropped dramatically, and the thiosulphate degraded. The addition of ferrous sulphate and iron precipitation formed acid in solution due to iron hydrolysis. The test was not considered successful as an example, but the slurry was used for testing filter paper. As the result of fine particle size, 0.45 um nylon membrane was selected and used for all subsequent tests.

Test 2 shows the impact of pH control when adding ferrous sulphate to the system. Therefore, starting from Test 2, the ferrous sulphate was added to the reactor as solution with concurrent addition of 5 M sodium hydroxide solution to control the pH. Samples were taken and filtered with a syringe filter. Thiosulphate and gold analysis was performed using the Dionex ion chromatograph and atomic absorption spectrometer respectively. Silver, copper, and iron analysis was performed by using ICP-OES in the UBC geology department.

FIGS. 50 and 51 show the pH and ORP values for Tests 2 to 8. The pH decreased throughout the precipitation except for Test 8. The pH bump in Test 8 is due to addition of extra sodium hydroxide during the pH adjustment at the beginning. However, the trend of pH is generally decreasing as well. The ORP values were low indicating that ferrous sulphate addition caused a reductive process in solution.

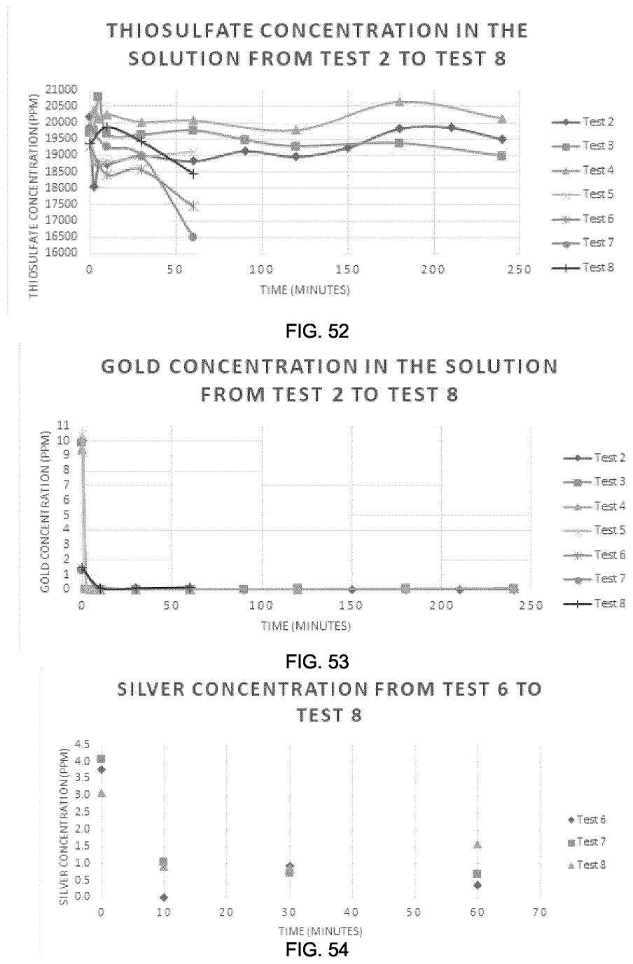

FIG. 52 shows the thiosulphate concentration with time. In general, thiosulphate decomposed during precipitation. But the change between initial and final thiosulphate concentration is not significant, except for tests 6 and 7. The reason for these larger drops is not known but high levels of copper were added to these tests. Copper catalyzes the decomposition of thiosulphate and, without being bound, may therefore have caused the drop. For all other experiments, the thiosulphate in solution was relatively stable during the precipitation process, indicating that thiosulphate can be preserved through the precipitation process, e.g. if it is desired to recycle the thiosulphate back to the leaching solution.

FIG. 53 shows the gold concentration in the solution. The results show that the precipitation finished within 10 minutes. These results confirmed that ferrous sulphate addition to sodium thiosulphate solution is an effective chemical method to precipitate gold.

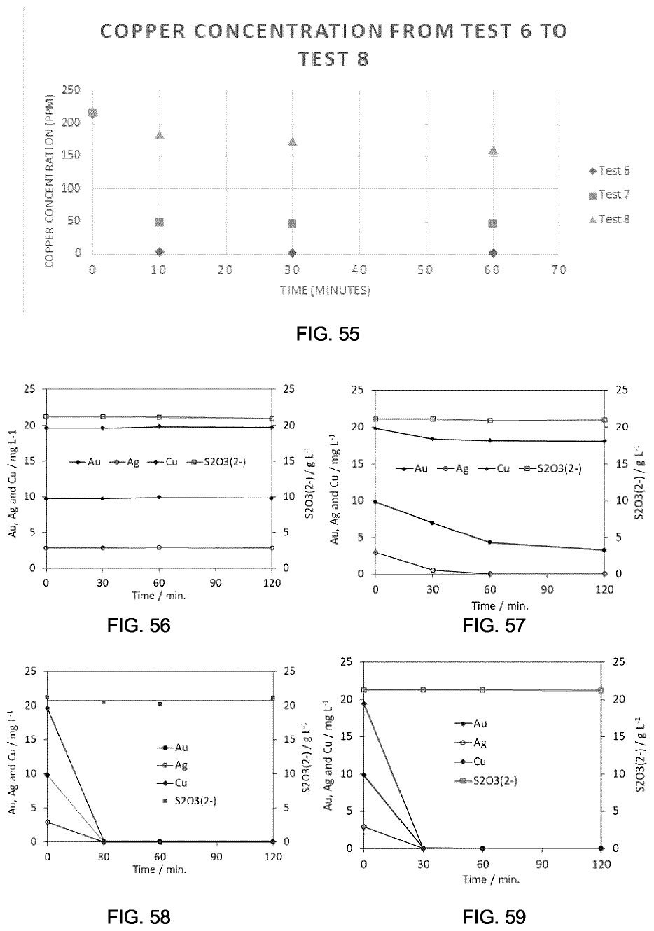

FIGS. 54 and 55 show the copper and silver concentration with time for Test 6, 7 and 8. The silver concentration decreased for all tests. The copper concentration also decreased; however, Test 8 has the least drop in copper. The copper analysis for Test 8 was done one day after the precipitation test. But for Test 6 and Test 7, the copper analysis was performed a few days after the precipitation test. As a result and without being bound, copper might have continued to precipitate after sampling.

Two blank tests were completed to verify that the prepared solutions were stable during the testing period without any ferrous sulphate solution addition. The results confirm that in the absence of ferrous sulphate addition, the solutions are stable for the time frame of the testing. The metals in solution are unchanged within the limits of analytical accuracy. Similarly, pH and thiosulphate concentration in solution are unchanged. The ORP values do trend down with time. This is often observed in leaching experiments where the addition of air or oxygen is stopped. The ORP drifts lower due to the reducing nature of the thiosulphate salts and the degradation products of thiosulphate that may be present in solution. However, the ORP did not drift low enough to result in metal precipitation. The blank results confirm that the ferrous sulphate addition is the cause of metal precipitation.

Test 9 was conducted to produce a mass of precipitate for cyanidation to demonstrate recovery of gold from the iron oxy hydroxide precipitate. A total of 10 L of synthetic solution was treated with ferrous sulphate addition in 5 individual 2 L tests. After finishing all 5 batches, the solid was collected by filtration. Then cyanidation is performed on the solid collected to extract gold. The concentration for cyanide is 1 g/L NaCN. The results for Test 9 are summarized in Table 32.

TABLE 32
Test 9 results for 5 batch precipitations.

| | Batch 1 | Batch 2 | Batch 3 | Batch 4 | Batch 5 |
|---|---|---|---|---|---|
| Initial pH | 10 | 9.49 | 9.73 | 9.13 | 9.52 |
| Final pH | 8.93 | 9.47 | 8.46 | 8.23 | 8.08 |
| Initial ORP (mV) | −2.2 | −104.8 | −71.8 | −54.6 | −113.4 |
| Final ORP (mV) | −557.8 | −525.3 | −505.8 | −455.6 | −416.6 |
| Initial thiosulphate concentration (ppm) | 11170 | 10805 | 11090 | 10778 | 10828 |
| Final thiosulphate concentration (ppm) | 10830 | 10910 | 10825 | 11040 | 10670 |
| Initial gold (ppm) | 10.48 | 10.44 | 10.29 | 10.45 | 10.30 |
| Final gold (ppm) | 0.03 | 0.05 | 0.17 | 0.20 | 0.19 |
| Initial copper (ppm) | 32 | 31 | 32 | 32 | 32 |
| Final copper (ppm) | 0.00 | 0.00 | 0.00 | 0.00 | 0.00 |
| Initial silver (ppm) | 3.38 | 2.41 | 2.75 | 3.35 | 3.70 |
| Final silver (ppm) | 0.84 | 0.22 | 0.09 | 0.68 | 0.35 |

After each precipitation test, each batch was filtered. The filtration took about 3-4 hours for each batch. Once all the solids were collected, they were transferred to a 1 L reactor. 800 mL deionized water was added to the reactor. An overhead agitator was used to provide agitation at 800 rpm. Before the cyanidation started, pH was adjusted with concentrated sodium hydroxide. The pH increased to ˜10.64 and remained stable for one hour before adding sodium cyanide. Once the pH was stable, 1 g/L of cyanide was added to the solution. The pH jumped to 11.63. After 8 hours retention time, the pH dropped to 11.57. Table 33 summarizes the pH and ORP data for the cyanidation.

TABLE 33
pH and ORP data for cyanidation.

| | | | 5M sodium |
|---|---|---|---|
| | | | hydroxide |
| Time | | | addition |
| (hour) | pH | ORP | (mL) |
| 0 | 6.01 | | 3.52 |
| 1 | 10.64 | −95 | |
| Add sodium | 11.63 | −323 | |
| cyanide | | | |
| 9 | 11.57 | −140 | |

The gold balance is summarized in Table 34. The gold difference is calculated by subtract the summation of final gold, gold in cyanidation, and gold in solids from the initial gold. The difference is 6.85 mg, which is 6.59%.

TABLE 34
Gold balance.

| | Initial | Final |
|---|---|---|
| | Gold | Gold |
| | (mg) | (mg) |
| Batch 1 | 20.96 | 0.06 |
| Batch 2 | 20.88 | 0.1 |
| Batch 3 | 20.58 | 0.34 |
| Batch 4 | 20.9 | 0.4 |
| Batch 5 | 20.6 | 0.38 |
| Sum | 103.92 | 1.28 |

| | |
|---|---|
| Gold extracted | 89.75 |
| by cyanidation (mg) | |
| Gold in final | 6.036 |
| solids (mg) | |

| | |
|---|---|
| Difference (mg) | 6.85 |

The precipitation efficiency of gold as an average over the 5 batches is calculated from the initial and final gold values as Efficiency=(103.92−1.28)/103.92×100%=98.8%. By similar calculation, silver precipitation efficiency was 86%, copper precipitation efficiency was 100% and finally all iron precipitated from the solution. The extraction of gold from the releaching of the residue was calculated as Extraction=89.75/(89.75+6.036)×100%=93.7%.

The overall gold balance showed a small lack of accountability (6.85 mg out of a total of 103.92 added). This represents about 6% mass balance error and, without being bound, may be attributed to analytical accuracy and the challenge in recovering all iron precipitate from the filter paper after the initial gold precipitation and filtration. In summation, Test 9 showed that gold could be effectively precipitated from a thiosulphate solution and then re-leached using cyanidation of the iron precipitate.

In conclusion, a series of experiments were conducted to demonstrate the use of ferrous sulphate salt as a precipitant for gold, copper and silver from thiosulphate solutions. The precipitation of gold generally approached 100% efficiency with very fast precipitation times (less than 1 hour). Silver and copper precipitated quickly but the efficiency of precipitation was lower. Two blank tests showed that the prepared thiosulphate solutions were stable for the period of the ferrous sulphate precipitation tests. Precipitation was attributed to ferrous sulphate addition, not instability of the prepared solutions.

A bulk test (5 separate test results combined) showed that gold could be recovered by cyanidation of the iron precipitate. Gold extraction was 93.7% using 1 g/L NaCN addition and 8 hours of cyanidation.

### Example 5.2—Pyrite

Cementation of gold, silver and copper was conduced in a 700-ml water-jacked glass reactor (8.2 cm ID and 15 cm deep) with three built-in baffles. The reactor was sealed with a removable lid, which had several openings for the temperature probe, pH, potential measurement, sampling, stirrer shaft, and nitrogen gas. Nitrogen was introduced to maintain an inert atmosphere. The inside pressure was maintained at 5 cm of water. Agitation was provided by double 45°-pitched impellers with a diameter of 2.54 cm. The lower impeller was suspended 0.4 cm from the bottom of the reactor. The distance between the two impellers was 5 cm. The rotational speed was controlled at 1000 rpm to maintain all solids in a suspension and the temperature was controlled at 25±0.1° C. using a circulating water bath. The pH was controlled at 9.0 with the use of a pH controller by the addition of sodium hydroxide solution.

The experimental procedures are: (1) Transfer 0.65 L of thiosulphate solution to the reactor and then introduce nitrogen to the sealed reactor, (2) Transfer a required amount of −106 μm pyrite sample and a required volume of deionized water to a mortar for 2 minutes of wet grinding using a pestle to refresh pyrite particle surfaces; (3) Flush wet pyrite powder to the reactor using thiosulphate solution to start a test at 25° C.; (4) Take samples at 0, 30, 60 and 120 minutes.

10 mL of gold standard solution (1000 mg/L Au and 2% HCl), 3 mL of silver standard solution (1000 mg/L Ag and 2% nitric acid), a required amount of copper sulphate pentahydrate and 0.8 L of water were successively added to a 1-L beaker and the pH of the resulted solution was adjusted to 4 using sodium hydroxide solution. A required amount of reagent sodium thiosulphate was added. The final pH was further adjusted to 9. The solution was transferred to a 1-L volumetric flask to make a solution.

Gold, silver and copper in solution samples were directly analyzed by ICP in thiosulphate media. Gold was also analyzed by solvent extraction of gold to the organic solution whose gold was directly analyzed by atomic adsorption. Both analysis methods gave nearly identical results. Thiosulphate was analyzed immediately after taking samples using ion chromatography.

### Cementation With Pure Pyrite

The concentrations of gold, silver, copper and thiosulphate as a function of time are shown in FIGS. 56-59 with the addition of 0, 1, 10 and 20 g/L pyrite, respectively. In all four cases, the thiosulphate concentration practically did not change or decreased very little. Without the addition of pyrite (FIG. 56), the concentrations of gold, silver and copper did not change with time as expected. With the addition of 1 g/L pyrite (FIG. 57), the concentrations of gold, silver and copper decreased from 10 to 3.3 mg/L, from 2.9 to 0.05 mg/L and from 19.8 to 18.1 mg/L, respectively in 120 minutes. With the addition of 10 and 20 g/L pyrite (FIGS. 58 and 59), the concentrations of gold, silver and copper decreased to less than 0.1 mg/L in 30 minutes. Thus, gold, silver and copper can be effectively recovered by cementation with pyrite.

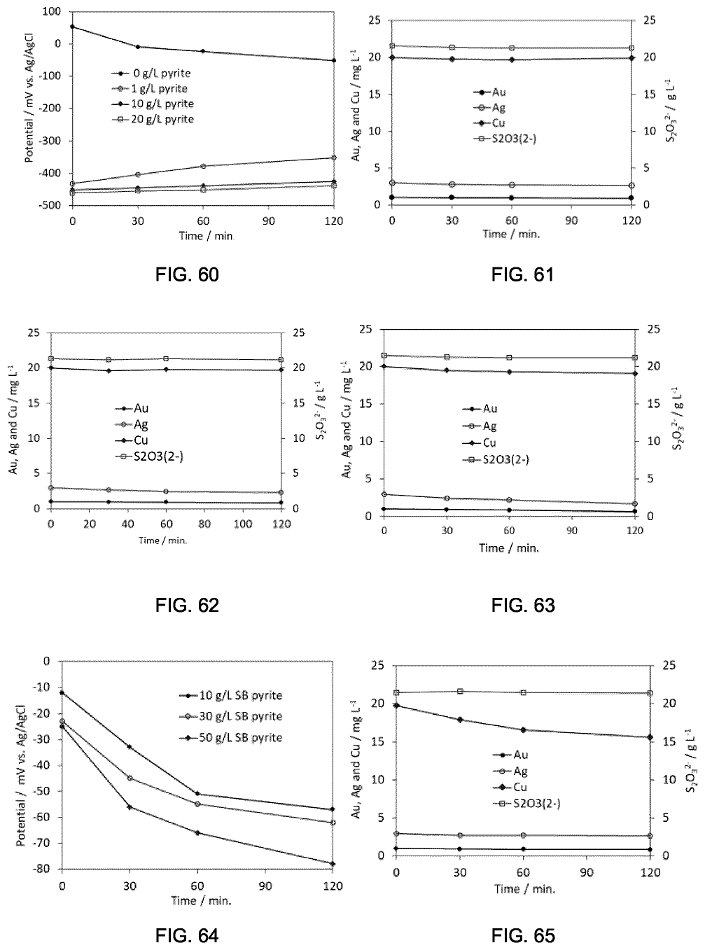

The pH immediately dropped to 6 when 10 g/L pyrite was added, and immediately dropped to 3.5 when 20 g/L pyrite was added, indicating that acid was released during cementation. The redox potential as a function of time is shown in FIG. 60. Without the addition of pyrite, the redox potential decreased from 50 mV to −50 mV vs Ag/AgCl. There was no well-defined redox couple or the redox couple concentration was too low to determine the platinum probe potential. Therefore, the change in the redox potential was probably due to the variation in the surface condition of platinum electrode. With the addition of pyrite, the redox potential dropped to less than −400 mV vs. Ag/AgCl and slightly increased with time. The addition of more pyrite resulted in a lower redox potential. This redox potential was due to the contact of pyrite powder with the platinum electrode and therefore reflected the surface potential of pyrite. The increase in the redox potential was mainly due to the precipitation of gold, silver and copper on the pyrite particles.

### Cementation With Pyrite-Containing Ore

A pyrite-containing sample of ore was examined to compare the ability of the ore to precipitate precious metal values. The tested ore is very fine powder. It was first wet ground for 2 minutes to refresh the particle surfaces and then used immediately. The concentrations of gold, silver and copper as a function of time at 25° C. are given in FIGS. 61-63. The gold concentration with the addition of 10, 30 and 50 g/L sample only decreased from 1 to 0.92, 0.85 and 0.68 mg/L, respectively while the silver concentration decreased from 2.96 to 2.64, 2.34 and 1.66 mg/L, respectively. With the addition of 10 and 20 g/L sample, the copper concentration essentially did not decrease under the limits of analysis error while with the addition of 50 g/L sample, it decreased very slightly. The thiosulphate concentration practically did not decrease or decreased very little in two hours. The solution potential (FIG. 64) was about 400 mV higher than that with pure pyrite and slightly decreased with time, indicating that there was very limited portion of pyrite in the sample. At the addition of 50 g/L pyrite-containing ore sample, another test was done to extend cementation time to 4 hours. However, only slightly more gold, silver and copper were removed.

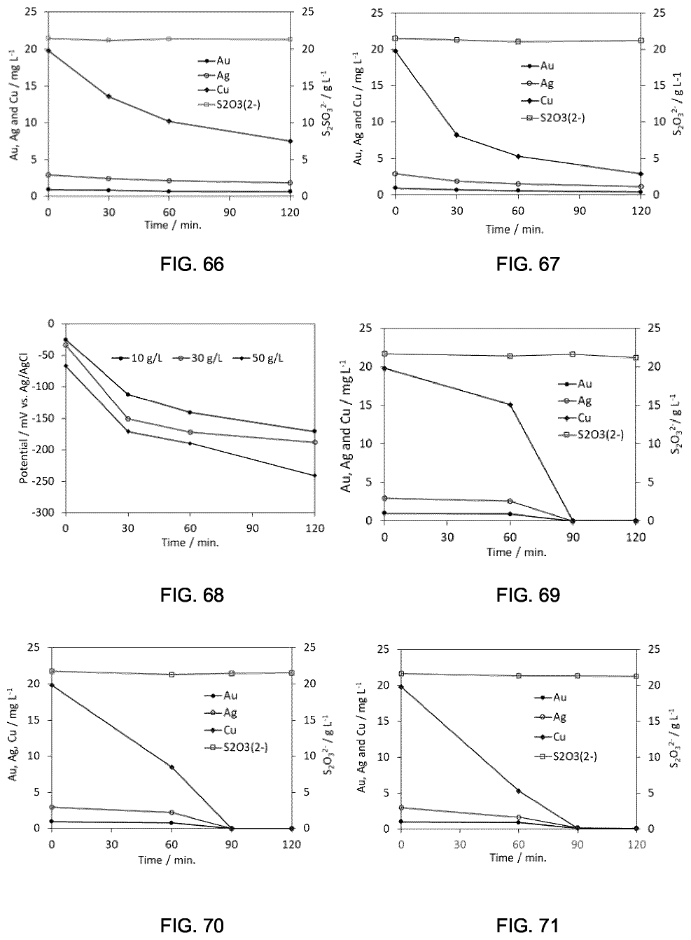

At 25° C., only very little gold, silver and copper were precipitated by cementation with the tested pyrite-containing ore sample. Cementation can be activated and then accelerated at a higher temperature. Therefore three tests were conducted at 70° C. The concentrations of gold, silver and copper as a function of time at 70° C. are given in FIGS. 65-67. The gold concentration with the addition of 10, 30 and 50 g/L sample decreased from 1 to 0.82, 0.64 and 0.39 mg/L, respectively while the silver concentration decreased from 2.95 to 2.42, 1.89 and 1.15 mg/L, respectively. The copper concentration dropped from 19.8 to 15.6, 7.50 and 2.91 mg/L for 10, 30 and 50 g/L sample additions, respectively. The thiosulphate concentration effectively did not decrease or decreased very little in two hours. The solution potential (FIG. 68) decreased with time and was about 100-200 mV lower than that at 25° C. At the addition of 50 g/L pyrite-containing ore sample, another test was done to extend cementation time to 4 hours. However, only slightly more gold, silver and copper were removed.

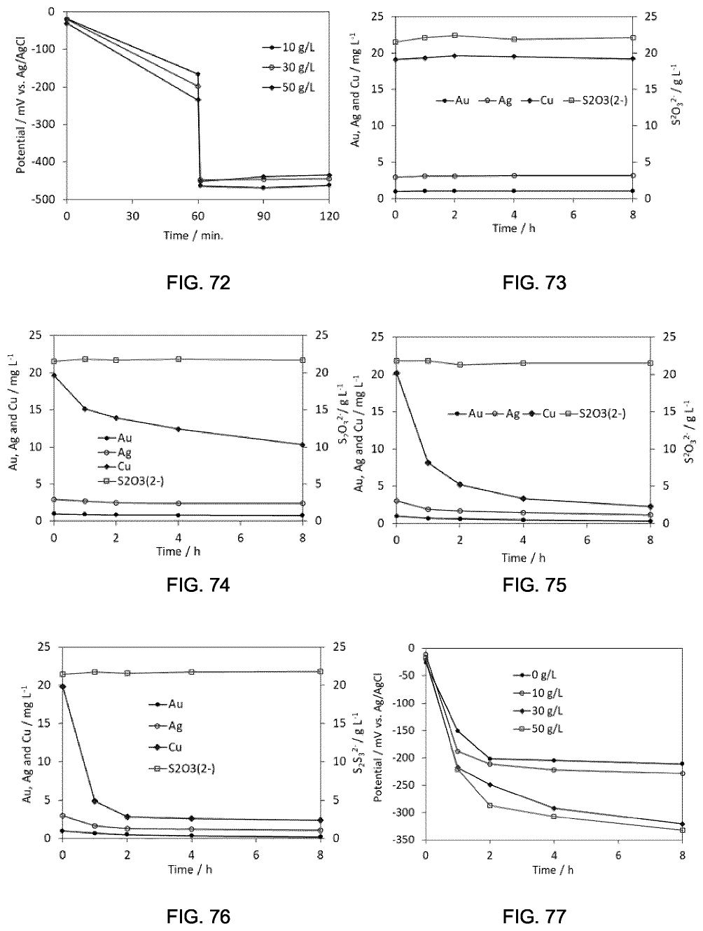

Gold, silver and copper were not completely precipitated with pyrite-containing ore sample at 70° C. Without being bound by theory, this may have been due to the fact that the slurry potential was not low enough to reduce these three metals, and it is likely that other ores containing higher levels of pyrite and/or more reactive pyrite might prove to be more effective as reductants. NaHS was used to reduce the slurry potential to around −450 mV that is close to that achieved with the use of pure pyrite. At first, only pyrite ore sample was added as a first reductant and after 1 hour NaHS solution was introduced. The results are shown in FIGS. 69-71. In the first hour, only limited amounts of gold, silver and copper were precipitated. After the addition of NaHS to reduce the slurry potential to about −450 mV vs. Ag/AgCl, gold, silver and copper were almost completely precipitated. Silver and copper could be precipitated as their sulphides while gold should be reduced to elemental gold. Gold, silver and copper were removed to lower levels at the addition of 10 or 30 g/L pyrite ore sample and 0.11-0.072 g/L NaHS than that at the addition of 50 g/L pyrite ore sample and 0.069 g/L NaHS. NaHS play a role in the precipitation of gold, silver and copper. Gold, silver and copper can be precipitated completely without the pyrite ore sample. The slurry potential as a function of time are shown in FIG. 72. The slurry potential dropped to about −450 mV vs. Ag/AgCl and did not change significantly with time.

The reaction time at 70° C. was extended to 8 hours to precipitate more gold, silver and copper. The results are summarized in FIGS. 73-76. Without the addition of pyrite ore sample, the concentrations of gold, silver and copper stayed essentially constant (FIG. 73). With the addition of 10 g/L pyrite ore sample (FIG. 74), the concentrations of gold, silver and copper decreased from 0.98 to 0.78 mg/L for gold, from 2.96 to 2.39 mg/L for silver and from 19.6 to 10.3 mg/L for copper, respectively while with the addition of 30 g/L pyrite ore sample (FIG. 75), they dropped from 1.03 to 0.33 mg/L, from 3.02 to 1.13 mg/L and 20.2 to 2.31 mg/L, respectively. At the addition of 50 g/L pyrite ore sample (FIG. 76), the concentrations of gold, silver and copper decreased from 0.98 to 0.21 mg/L, from 2.97 to 1.09 mg/L and from 19.8 to 2.37 mg/L, respectively. More gold, silver and copper were precipitated in 8 hours than those in 2 hours. However, they were not precipitated completely. The concentration of thiosulphate did not change significantly under an inert atmosphere. The slurry potential as a function of time are shown in FIG. 77. The addition of the pyrite-containing ore sample resulted in a lower slurry potential.

Without being bound by theory, it is believed that different sources of ore may yield more effective precipitation of metal values than was observed with the tested pyrite-containing ore sample. In particular, the experimental results observed using pure pyrite as a reductant showed very effective precipitation of metal values. In contrast, the tested ore sample was not 100% pyrite, and so would be expected to be less effective as a precipitant than pure pyrite. Additionally, the tested sample exhibited higher pyrite oxidation levels than other ore samples taken from other locations, possibly due to differences in mineral structure or different aspects of mineral preparation. So other ores with more stable formations of pyrite may be more effective precipitants than the tested ore.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A method for recovering precious metal values from a starting material comprising the steps of:
in a first stage:
providing a sulphide generator;
forming an aqueous slurry of the starting material and the sulphide generator;
generating thiosulphate from the sulphide generator and supplying an oxidant and a basic compound to form a reaction mixture; and
allowing the thiosulphate to complex the precious metal values to form a leached solution; and
in a second stage:
adding a first reductant to the leached solution to precipitate the precious metal values, wherein the first reductant comprises a copper concentrate, ferrous sulphate (FeSO₄), or an iron sulphide-containing mineral.

2. A method as defined in claim 1, wherein:
the sulphide generator is a component of the starting material;
the starting material is a sulphide-containing mineral;
the starting material comprises a carbonaceous ore; and/or
the sulphide generator contains thiosulphate.

3. (canceled)

4. (canceled)

5. (canceled)

6. A method for recovering precious metal values from a sulphide-containing starting material comprising the steps of:
in a first stage:
forming an aqueous slurry of the sulphide-containing starting material;
generating thiosulphate in situ from the sulphide-containing starting material by supplying an oxidant and a basic compound to form a reaction mixture; and
allowing the thiosulphate to complex the precious metal values to form a leached solution; and
in a second stage:
adding a first reductant to the leached solution to precipitate the precious metal values, wherein the first reductant comprises a copper concentrate, ferrous sulphate (FeSO₄), or an iron sulphide-containing mineral.

7. A method as defined in claim 1, wherein the starting material comprises an ore, concentrate or tailing containing a sulphidic mineral; or wherein the starting material comprises a flotation by-product, wherein the flotation by-product is optionally a tailing product; and optionally wherein the sulphidic mineral comprises one or more of pyrite, pyrrhotite, arsenopyrite, marcasite, chalcopyrite, or tetrahedrite; and/or wherein the starting material is a pyrite scavenger concentrate and/or sulphide flotation tailing product; and/or wherein the starting material is a mixed pyritic and carbonaceous flotation concentrate.

8. (canceled)

9. A method as defined in claim 1, wherein:
the starting material is a sulphidic mineral that contains copper, optionally in an amount of at least 1% by weight;
the starting material is size-reduced to an average particle size in the range of about 5 μm to about 100 μm prior to the step of forming the aqueous slurry; and/or
the precious metal values comprise gold, silver, platinum, palladium, rhodium, iridium, ruthenium, or osmium, optionally gold or silver.

10. (canceled)

11. (canceled)

12. A method as defined in claim 1, wherein copper is added to the reaction mixture, optionally as copper sulphate, and/or the basic compound is periodically supplied to the reaction mixture to maintain the reaction mixture at a pH in the range of 7.5 to 11.0, optionally between pH 9.0 and 9.5.

13. (canceled)

14. A method as defined in claim 1, wherein the basic compound comprises one or more of Na₂CO₃, NaOH, Na₂HCO₃, K₂CO₃, KOH, KHCO₃, Ca(OH)₂ and/or CaO; and/or wherein the basic compound is supplied at a rate of about 5 kg per tonne of starting material to about 200 kg per tonne of starting material.

15. (canceled)

16. A method as defined in claim 1, wherein the oxidant comprises oxygen (O₂); wherein the oxidant is supplied to the reaction mixture at a rate that maintains an oxidation-reduction-potential (ORP) in the range of about −80 mV to about 100 mV (Ag/AgCl); and/or wherein the oxidant is supplied to the reaction mixture at a rate of between about 0.35 to about 0.55 tonnes of oxidant per tonne of sulphur that is to be oxidized to thiosulphate.

17. (canceled)

18. (canceled)

19. A method as defined in claim 1, wherein the method is conducted at atmospheric pressure; and/or wherein the reaction mixture is heated to a temperature in the range of about 25° C. to about 95° C.

20. (canceled)

21. A method as defined in claim 1, wherein the method is conducted at elevated pressure, wherein the elevated pressure optionally comprises an oxygen overpressure in the range of about more than 1 atm to about 10 atm; and wherein optionally the reaction mixture is heated to a temperature in the range of about 25° C. to about 120° C.

22. A method of recovering precious metal values from a solution prepared using thiosulphate as a lixiviant comprising:
adding a first reductant to the leached solution to precipitate the precious metal values, wherein the first reductant comprises a copper concentrate, ferrous sulphate (FeSO₄), or an iron sulphide-containing mineral.

23. A method as defined in claim 1, further comprising recovering copper during the step of adding the first reductant to the leached solution.

24. A method as defined in claim 1, wherein the first reductant comprises a copper concentrate, ferrous sulphate (FeSO₄), an iron sulphide-containing mineral, or pyrite, chalcopyrite, marcasite, and/or pyrrhotite and/or a combination thereof.

25. (canceled)

26. (canceled)

27. (canceled)

28. A method as defined in claim 1, further comprising adding a scavenging precipitant after adding the first reductant to the leached solution; optionally wherein the scavenging precipitant comprises NaSH, optionally wherein the NaSH regenerates thiosulphate when added to the leached solution.

29. (canceled)

30. (canceled)

31. A method as defined in claim 1, wherein said precipitation step is conducted under a non-oxidizing atmosphere, optionally wherein the non-oxidizing atmosphere is provided by sparging the leached solution with nitrogen or argon, or by removing oxygen from the leached solution by vacuum.

32. (canceled)

33. A method as defined in claim 1, wherein:
said precipitation step is conducted at a temperature in the range of about 20° C. to about 100° C., optionally about 45° C. to about 65° C.;
said precipitation step is conducted at a oxidation-reduction potential (ORP) of about −200 to about −800 mV, optionally between about −300 to about −500 mV; and/or
said precipitation step is conducted at a pH of about 8.0 to about 10.5.

34. (canceled)

35. (canceled)

36. A method as defined in claim 1, wherein a concentration of thiosulphate during said precipitation step is maintained in a range of between about 2,000 to about 21,000 ppm.

37. A method as defined in claim 1, wherein:
said precipitation step is conducted at atmospheric pressure;
said precipitation step is conducted at a pressure of between about 5 and about 50 psig;
said precipitation step is conducted for a period of between about 30 minutes and about 8 hours; and/or
said precipitation step is conducted in a separate vessel from a vessel containing the reaction mixture.

38. (canceled)

39. (canceled)

40. (canceled)

41. A method as defined claim 1, the method further comprising recycling at least a portion of the thiosulphate remaining after said precipitation step to the vessel containing the reaction mixture.

42. A method as defined in claim 1, that is conducted without addition of ammonia (NH₄⁺); and/or wherein the first reductant does not comprise NaSH.

43. (canceled)
